(19) United States
(12) Patent Application Publication
(10) Pub. No.: US 2017/0290345 A1
(43) Pub. Date: Oct. 12, 2017

(54) ON-DEMAND ROBOTIC FOOD ASSEMBLY AND RELATED SYSTEMS, DEVICES AND METHODS

(71) Applicant: ZUME Pizza, Inc., Mountain View, CA (US)

(72) Inventors: Alexander John Garden, Tiburon, CA (US); Joshua Gouled Goldberg, Santa Cruz, CA (US); Julia Elizabeth Collins, San Francisco, CA (US); Victor Charles Darolfi, Mountain View, CA (US); Russell Kennedy Williams, Mountain View, CA (US); Andrew David Almendares, Daly City, CA (US); Ankita A. Varma, Santa Clara, CA (US)

(21) Appl. No.: 15/481,240

(22) Filed: Apr. 6, 2017

Related U.S. Application Data
(60) Provisional application No. 62/320,282, filed on Apr. 8, 2016.

(51) Int. Cl. A21C 9/04; B25J 11/00; A21C 9/08; A21B 5/00; A21B 1/48

(52) U.S. Cl. CPC A21C 9/04; A21B 5/00; A21B 1/48; A21C 9/08; B25J 11/008; A21D 13/41

(57) ABSTRACT

An on-demand robotic food assembly line can include one or more conveyors and one or more robots, operable to assemble food items in response to received orders for food items, and one or more ovens operable to, for example, partially cook assembled food items. The on-demand robotic food assembly line can optionally package the assembled and partially cooked food items in packaging, and optionally load the packaged partially cooked food items into portable cooking units (e.g., ovens) that are optionally loaded into racks that are, in turn, optionally loaded into delivery vehicles, where the food items are individually cooked under controlled conditions while en route to consumer destinations, such the cooking of each food item is completed just prior to arrival at the consumer destination location. A dynamic fulfillment queue for control of assembly is maintained based at least in part on estimated transit time for orders.

### TECHNICAL FIELD

This description generally relates to the food assembly, for instance assembly of food items for delivery to a customer.

### DESCRIPTION OF THE RELATED ART

Historically, consumers have had a choice when hot, prepared, food was desired. Some consumers would travel to a restaurant or other food establishment where such food would be prepared and consumed on the premises. Other consumers would travel to the restaurant or other food establishment, purchase hot, prepared, food and transport the food to an off-premises location, such as a home or picnic location for consumption. Yet other consumers ordered delivery of hot, prepared food, for consumption at home. Over time, the availability of delivery of hot, prepared, foods has increased and now plays a significant role in the marketplace. Delivery of such hot, prepared, foods was once considered the near exclusive purview of Chinese take-out and pizza parlors. However, today even convenience stores and “fast-food” purveyors such as franchised hamburger restaurants have taken to testing the delivery marketplace.

The delivery of prepared foods traditionally occurs in several discrete acts. First, a consumer places an order for a particular food item with a restaurant or similar food establishment. The restaurant or food establishment prepares the food item or food product per the customer order. The prepared food item is packaged and delivered to the consumer's location. The inherent challenges in such a delivery method are numerous. In addition to the inevitable cooling that occurs while the hot food item is transported to the consumer, many foods may experience a commensurate breakdown in taste, texture, or consistency with the passage of time. For example, the French fries at the burger restaurant may be hot and crispy, but the same French fries will be cold, soggy, and limp by the time they make it home. To address such issues, some food suppliers make use of “hot bags,” “thermal packaging,” or similar insulated packaging, carriers, and/or food containers to retain at least a portion of the existing heat in the prepared food while in transit to the consumer. While such measures may be at least somewhat effective in retaining heat in the food during transit, such measures do little, if anything, to address issues with changes in food taste, texture, or consistency associated with the delay between the time the food item is prepared and the time the food item is actually consumed.

Further, there are frequently mistakes in orders, with consumers receiving food they did not order, and not receiving food they did order. This can be extremely frustrating, and leaves the consumer or customer faced with the dilemma of settling for the incorrect order or awaiting a replacement order to be cooked and delivered.

### BRIEF SUMMARY

An on-demand robotic food assembly line can include one or more conveyors and one or more robots, operable to assemble food items in response to received orders for food items, and one or more ovens operable to, for example, partially cook assembled food items. The on-demand robotic food assembly line can optionally package the assembled and partially cooked food items in packaging, and optionally load the packaged partially cooked food items into portable cooking units (e.g., ovens) that are optionally loaded into racks that are, in turn, optionally loaded into delivery vehicles, where the food items are individually cooked under controlled conditions while en route to consumer destinations, such the cooking of each food item is completed just prior to arrival at the consumer destination location. A dynamic fulfillment queue for control of assembly is maintained based at least in part on estimated transit time for orders.

Systems and methods of coordinating the preparation and, optionally delivery of cooked food items or food products are disclosed. In at least some instances, one or more robots assemble a food item based on an order. In at least some instances, one or more robots may completely assemble a food item based on a consumer or customer order, and optionally package the food item for delivery or pickup. In some instances, the order may be customized or tailored to the consumer's or customer's specific preferences. In some instances, one or more robots can package and/or load assembled and/or packaged custom food items into ovens for cooking during transit to a delivery destination.

Uncooked or partially cooked food items, prepared to the consumer's or customer's specifications, can be placed in an individual cooking unit or oven which is loaded into the cargo compartment of a delivery vehicle. The self-contained cooking units or ovens may be individually placed in the delivery vehicle. In other instances, multiple cooking units may be loaded into a structure such as a rack that is loaded into the delivery vehicle. The cooking conditions within the cooking unit or oven (e.g., cooking unit temperature, cooking unit humidity, cooking time, and similar) are dynamically controlled and adjusted while en route to the consumer or customer destination such that the cooking process for food delivered to a particular consumer is completed a short time prior to the arrival of the food at the destination. Using such a system, hot prepared food that is freshly cooked can be delivered to a consumer shortly after the conclusion of the cooking process. In at least some instances, the systems and methods described herein take advantage of the estimated travel time to any number of food delivery destinations to perform or complete cooking of the food item or food product.

A processor-based system can dynamically generate, maintain, and update a dynamic order queue to sequence various orders for food items, and to control an assembly line and associated robots of the assembly line to assemble food items or food products per order. Use of a central processor-based system may advantageously permit the generation of an assemble sequence, delivery itinerary (i.e., a delivery route) and an estimated time of arrival at each of the consumer destinations for each order. Data in the form of live updates may be provided to the controller to permit generating and updating of the dynamic order queue in continuous, near-continuous, or intermittent adjustments to the assembly, packaging, and dispatching instructions or sequence. Such can also enable continuous, near-continuous, or intermittent adjustments in en route cooking conditions of the ovens. For example, real-time or near real-time crowd sourced traffic information, may be used to provide updated estimated times of arrival or to recalculate the assembly sequence or itinerary, dispatch itinerary, and/or delivery itinerary. Knowing the estimated delivery time and the desired cooking conditions, the controller varies a sequence of orders for assembly, dispatch and delivery, as well as the cooking conditions within each of the individual cooking units such that the cooking process in the respective cooking unit is completed at the approximate estimated time of arrival at the respective consumer or customer location. Thus, the system can be characterized as an on-demand cooked food item order fulfillment system.

Food items or food products can be stored in an appropriate package or transport container. Transport containers preferably include molded fiber packaging or containers, such as that illustrated and described in pending U.S. patent application Ser. No. 15/465,228, titled “CONTAINER FOR TRANSPORT AND STORAGE OF FOOD PRODUCTS,” filed on Mar. 17, 2017, and in U.S. provisional patent application Ser. No. 62/311,787, titled “CONTAINER FOR TRANSPORT AND STORAGE OF FOOD PRODUCTS,” filed on Mar. 22, 2106. Alternatively, packaging can include cardboard containers (e.g., pizza boxes); Styrofoam containers; paper containers; plastic containers; metal containers; aluminum foil containers; and the like.

Tracking and trending order information may also enable the predictive preparation and prompt delivery of hot prepared food items on certain days or on certain occasions, thereby providing a heretofore unavailable level of customer service that can serve as a key market differentiator. For example, on certain days (e.g. Friday evenings) and/or times “game day” orders for a certain food items (e.g., pepperoni pizzas) may increase. The predicted increase may be generic across delivery areas or may be concentrated or specific to certain geographic areas. With this knowledge, a processor-based system can self-generate orders (i.e., generate orders based on predicted demand based on previously fulfilled orders in the absence of actual unfulfilled orders being received from consumers or customers) to stock the particular food item(s) in respective cooking units in delivery vehicles in anticipation of receiving orders for such food items. The pre-order stocking or caching may be based on previous demand and may be specific to food item(s), day, time, geographic location or even events. For instance, each delivery vehicle may be pre-order stocked with several cheese and several pepperoni pizzas on game days for a local team, or during national events like the Super Bowl®, World Series®, or NCAA® college team bowl games or tournaments.

An on-demand robotic food preparation assembly line may be summarized as including: a first plurality of robots, each of the robots of the first plurality of robots having at least one respective appendage that is selectively moveable and a tool physically coupled to the respective appendage; at least a first conveyor that extends past the robots of the first plurality of robots, and which is operable to convey a plurality of food items being assembled past the robots; and a control system that receives a plurality of individual orders for food items, generates control signals based on the respective orders for food items, and causes the tools of the respective appendages of the robots to assemble the respective food item as the conveyor conveys the respective food item along at least a portion of the robotic food preparation assembly line, wherein at least a first one of the food items includes a first set of ingredients and a second one of the food items, immediately successively following the first one of the food items along the conveyor, includes a second set of ingredients, the second set of ingredients different from the first set of ingredients.

At least a third one of the food items, immediately successively following the second one of the food items along the conveyor, may include a third set of ingredients, the third set of ingredients different from the first set of ingredients and different from the second set of ingredients. The on-demand robotic food preparation assembly line may further include: at least a first sauce dispenser including a first reservoir to hold a first sauce and operable to dispense a first quantity of the first sauce on ones of flat pieces of dough on the conveyor, and wherein the respective tool of the first one of the first plurality of robots has a rounded portion and is operable to spread the first quantity of sauce on the ones of the flat pieces of dough. The on-demand robotic food preparation assembly line may further include: at least a second sauce dispenser including a second reservoir to hold a second sauce and operable to dispense a first quantity of the second sauce on selected ones of flat pieces of dough on the conveyor, and wherein the respective tool of the first one of the first plurality of robots is operable to spread the second quantity of sauce on the selected ones of the flat pieces of dough. The appendage of the first one of the first plurality of robots may be operable to move in a spiral while the respective tool of the first one of the first plurality of robots may be operable to rotate to spread the first quantity of sauce on the ones of the flat pieces of dough. A second one of the plurality of robots may include a dispensing container, the dispensing container having a bottom face, the dispensing container coupled to the one respective appendage, and wherein the tool may be physically coupled to the bottom face. The tool may include at least one of the following: a grater, a nozzle, a rotating blade, and a linear slicer. The dispensing container may further include a plunger, the plunger having a face that is parallel to the bottom face of the dispensing container, the plunger movable in a direction towards the lower surface. The on-demand robotic food preparation assembly line may further include: a dispenser carousel that contains multiple dispensing containers, the dispenser carousel located above the at least one conveyor so that at least one of the multiple dispensing containers is centered above the at least one conveyer, wherein the dispenser carousel is rotatable around an axis of rotation such that a first one of the multiple dispensing containers is centered above the at least one conveyer at a first time and a second one of the multiple dispensing containers is centered above the at least one conveyer at a second time. A second one of the first plurality of robots may be operable to retrieve a quantity of cheese from a first receptacle and deposit the quantity of cheese on the ones of the flat pieces of dough on the conveyor. A third one of the first plurality of robots may be operable to retrieve a quantity of a first topping from a second receptacle and deposit the quantity of the first topping on selected ones of the flat pieces of dough on the conveyor. A fourth one of the first plurality of robots may be operable to retrieve a quantity of a second topping from a third receptacle and deposit the quantity of the second topping on selected ones of the flat pieces of dough on the conveyor. A third one of the first plurality of robots may be operable to retrieve a quantity of a first topping from a second receptacle and deposit the quantity of the first topping on selected ones of the flat pieces of dough on the conveyor and may be further operable to retrieve a quantity of a second topping from a third receptacle and deposit the quantity of the second topping on selected ones of the flat pieces of dough on the conveyor. The on-demand robotic food preparation assembly line may further include: an oven downstream of the first plurality of robots, the oven operable to at least partially cook the food items. The on-demand robotic food preparation assembly line may further include: at least one robot positioned downstream of the oven, and operable to retrieve a fresh topping from a fresh topping receptacle and dispense the fresh topping on selected ones of the at least partially cooked food items. The at least one conveyor may include: a food grade conveyor belt that operates at a first speed; at least one oven conveyor rack that transits the food items through the oven at a second speed, the second speed slower than the first speed; and a first transfer conveyor that transfers food items from the food grade conveyor belt that moves at the first speed to the at least one oven conveyor rack that moves at the second speed. The at least one conveyor may include: a second transfer conveyor that transfers at least partially cooked food items to respective ones of a plurality of bottom portions of packaging. The first and the second transfer conveyors each may include a respective robot, each of the robots having a respective appendage selectively moveable with at least 3 degrees of freedom. The control system may receive orders for food items electronically generated directly by customers. The control system may include a server computer front end to communicatively coupled to receive orders for food items electronically generated directly by customers, and a back end computer that assembles the received orders for food items in an order fulfillment queue, where at least some of the received orders for food items are arranged in the order fulfillment queue out of sequence with respect to an order in which the orders for food items were received. The back end computer may assemble the received orders for food items in the order fulfillment queue based at least in part on an estimated time to a respective delivery destination for each of the received orders for food items.

A method of operation of an on-demand robotic food preparation assembly line may be summarized as including: receiving, by a control system, a plurality of individual orders for food items; generating, by the control system, control signals based on the respective orders for food items, and conveying, by a conveyor, a plurality of instances of the food items along at least a portion of the robotic food preparation assembly line; and causing, by the control system, a respective tool of a respective appendage of each of a plurality of robots to assemble the instances of the food items based at least in part on the control signals, where at least a first instance the food items includes a first set of ingredients and a second instance of the food items, immediately successively following the first instance of the food items along the conveyor, includes a second set of ingredients, the second set of ingredients different from the first set of ingredients.

At least a third instance of the food items, immediately successively following the second instance of the food items along the conveyor, may include a third set of ingredients, the third set of ingredients different from the first set of ingredients and different from the second set of ingredients. The method of operation of an on-demand robotic food preparation assembly line may further include: dispensing, by at least a first sauce dispenser that includes a first reservoir to hold a first sauce, a first quantity of the first sauce on ones of flat pieces of dough on the conveyor, and spreading, by a rounded portion of a respective tool of the first one of the first plurality of robots, the first quantity of sauce on the ones of the flat pieces of dough. Spreading the first quantity of sauce on the ones of the flat pieces of dough may include causing the appendage of the first one of the first plurality of robots to move in a spiral while the respective tool of the first one of the first plurality of robots rotates. Causing a respective tool of a respective appendage of each of a plurality of robots to assemble the instances of the food items based at least in part on the control signals may include causing a second one of the first plurality of robots to retrieve a quantity of cheese from a first receptacle and deposit the quantity of cheese on the ones of the flat pieces of dough on the conveyor. Causing a respective tool of a respective appendage of each of a plurality of robots to assemble the instances of the food items based at least in part on the control signals may include causing a third one of the first plurality of robots to retrieve a quantity of a first topping from a second receptacle and deposit the quantity of the first topping on selected ones of the flat pieces of dough on the conveyor. Causing a respective tool of a respective appendage of each of a plurality of robots to assemble the instances of the food items based at least in part on the control signals may include causing a fourth one of the first plurality of robots to retrieve a quantity of a second topping from a third receptacle and deposit the quantity of the second topping on selected ones of the flat pieces of dough on the conveyor. The method of operation of an on-demand robotic food preparation assembly line may further include: causing an oven downstream of the first plurality of robots to at least partially cook the instances of the food items. The method of operation of an on-demand robotic food preparation assembly line may further include: causing at least one robot positioned downstream of the oven to retrieve a fresh topping from a fresh topping receptacle; and causing at least one robot positioned downstream of the oven to dispense the fresh topping on selected ones of the at least partially cooked instances of the food items. The at least one conveyor may include a food grade conveyor belt that operates at a first speed and at least one oven conveyor rack that transits the food items through the oven at a second speed, the second speed slower than the first speed, and may further include: transferring food items, by a first transfer conveyor, from the food grade conveyor belt to the at least one oven conveyor rack. The method of operation of an on-demand robotic food preparation assembly line may further include: receiving, by the control system, orders for food items electronically generated directly by customers; and assembling, by the control system, the received orders for food items in an order fulfillment queue, where at least some of the received orders for food items are arranged in the order fulfillment queue out of sequence with respect to an order in which the orders for food items were received. Assembling the received orders for food items in the order fulfillment queue may include assembling the received orders for food items in the order fulfillment queue based at least in part on an estimated time to a respective delivery destination for each of the received orders for food items.

An on-demand food preparation assembly line may be summarized as including: a first set of assembly stations, each station at which a portion of a food item is assembled; at least one food grade conveyor belt that transits past the assembly stations of the first plurality of assembly stations at a first speed; at least one oven; at least one oven conveyor rack that conveys food items through the at least one oven at a second speed, the second speed slower than the first speed; a first transfer conveyor that transfers food items from the food grade conveyor belt that moves at the first speed to the at least one oven conveyor rack that moves at the second speed.

The on-demand food preparation assembly line may further include: a by-pass conveyor that bypasses the at least one oven conveyor rack to convey food items past the at least one oven, wherein the first transfer conveyor selectively transfers each food item from the food grade conveyor belt to one of the at least one oven conveyor rack and the by-pass conveyor. The at least one oven may include a first oven and at least a second oven, the second oven in parallel with the first oven along on-demand robotic food preparation assembly line; and the at least one oven conveyor rack may include a first oven conveyor rack and at least a second oven conveyor rack, the first oven conveyor rack which transits through the first oven and the second oven conveyor rack which transits through the second oven. The first oven conveyor rack may transit through the first oven at the first speed and the second oven conveyor rack may transit through the second oven at the first speed. The first transfer conveyor may transfer food items from the food grade conveyor belt to both the first and the second oven conveyor racks. The first transfer conveyor may include a robot having an appendage that is moveable with respect to the food grade conveyor belt and with respect to both the first and the second oven conveyor racks. The first transfer conveyor may further include a transfer conveyor rack positioned at least proximate an end of the appendage of the robot, the transfer conveyor rack selectively operable in at least a first direction. The transfer conveyor rack may be selectively operable in a second direction, the second direction opposite the first direction. The transfer conveyor rack may be selectively operable at a plurality of speeds in the first direction. At least one of the assembly stations may include a robot, the robot having at least one respective appendage that is selectively moveable and a tool physically coupled to the respective appendage, the robot responsive to dynamic instructions to assemble a plurality of specific instances of the food item on-demand.

A method of operation of an on-demand robotic food preparation assembly line may be summarized as including: transiting at least one food grade conveyor belt past a first set of assembly stations at a first speed, each assembly station at which a portion of a customized food item is assembled; conveying, via at least one oven conveyor rack, at least partially assembled customized food items through at least one oven at a second speed, the second speed slower than the first speed; transferring, by a first robotic transfer conveyor, the at least partially assembled customized food items from the food grade conveyor belt that moves at the first speed to the at least one oven conveyor rack that moves at the second speed, without changing the first or the second speeds.

Transferring the at least partially assembled customized food items from the food grade conveyor belt to the at least one oven conveyor rack may include transferring one instance of the at least partially assembled customized food items to a first oven conveyor rack that transits a first oven and transferring another instance of the at least partially assembled customized food items to a second oven conveyor rack that transits a second oven, the second oven in parallel with the first oven along the on-demand robotic food preparation assembly line. The first transfer conveyor may include a robot having an appendage and transferring the at least partially assembled customized food items from the food grade conveyor belt to the at least one oven conveyor rack includes transferring moving the appendage with respect to the food grade conveyor belt and with respect to both the first and the second oven conveyor racks. The first transfer conveyor may further include a transfer conveyor rack positioned at least proximate an end of the appendage of the robot, and transferring the at least partially assembled customized food items from the food grade conveyor belt to the at least one oven conveyor rack may include selectively operating the transfer conveyor rack in at least a first direction. Transferring the at least partially assembled customized food items from the food grade conveyor belt to the at least one oven conveyor rack may include selectively operating the transfer conveyor rack in at least a second direction the, the second direction opposite the first direction. Transferring the at least partially assembled customized food items from the food grade conveyor belt to the at least one oven conveyor rack may include selectively operating the transfer conveyor rack at a plurality of speeds in the first direction. At least one of the assembly stations may include a robot, the robot having at least one respective appendage, and may further include selectively moving a tool physically coupled to the respective appendage of the robot responsive to dynamic instructions to assemble a plurality of specific instances of the food item on-demand.

A piece of equipment for use in an on-demand food preparation assembly line, the on-demand food preparation assembly line including at least one food grade conveyor belt that transits at a first speed, a number of ovens, and at number of oven conveyor racks that conveys food items through the ovens at a second speed, the second speed slower than the first speed, may be summarized as including: a robot, the robot having at least one appendage that is selectively moveable with respect to an end of the food grade conveyor belt and a respective end of each of the oven conveyor racks; and a transfer conveyor rack positioned at least proximate an end of the appendage of the robot for movement therewith; and at least one motor drivingly coupled to the transfer conveyor rack and selectively operable to move the transfer conveyor rack in at least a first direction with respect to the end of the appendage.

The at least one motor may be selectively operable to move the transfer conveyor rack in a second direction with respect to the end of the appendage, the second direction opposite the first direction. The transfer conveyor rack may be selectively operable at a plurality of speeds in the first direction. The transfer conveyor rack may be an endless rack, and may further include a set of rollers about which the transfer conveyor rack is mounted. At least one of rollers may have a set of teeth that physically drivingly engage the transfer conveyor rack. The appendage of the robot may have 6 degrees of freedom, and the robot may include a plurality of motors drivingly coupled to move the appendage in response to a set of controller-executable instructions.

A method of operating a piece of equipment for use in an on-demand food preparation assembly line, the on-demand food preparation assembly line including at least one food grade conveyor belt that transits at a first speed, a number of ovens, and at number of oven conveyor racks that conveys food items through the ovens at a second speed, the second speed slower than the first speed, may be summarized as including: selectively moving at least one appendage of a robot to position a transfer conveyor rack carried by the appendage of the robot proximate an end of the food grade conveyor belt and a respective end of a first one of the oven conveyor racks; driving the transfer conveyor rack to transfer a first instance of a food item to the first one of the oven conveyor racks; selectively moving the at least one appendage of the robot to position the transfer conveyor rack carried by the appendage of the robot proximate the end of the food grade conveyor belt and a respective end of a second one of the oven conveyor racks; and driving the transfer conveyor rack to transfer a second instance of a food item to the second one of the oven conveyor racks.

The at least one motor may be selectively operable to move the transfer conveyor rack in a second direction with respect to the end of the appendage, the second direction opposite the first direction. Driving the transfer conveyor rack to transfer a first instance of a food item to the first one of the oven conveyor racks may include selectively driving the transfer conveyor rack at a plurality of speeds in the first direction.

A food preparation robotic system may be summarized as including: a number of arms; an end of arm tool having a contact portion with a round shape that performs redistribution of a component on a portion of a food item without cutting the food item and without adding any material to the food item; at least one motor drivingly coupled to selectively move the end of arm tool in an at least two-dimensional pattern; at least one sensor that senses a position of the at least one component of the food item; and at least one controller, the at least one controller communicatively coupled to receive information from the at least one sensor, the at least one controller which determines a pattern of movement based at least on part on the received information, the at least one controller communicatively coupled to supply control signals to drive the end of arm tool in the determined pattern of movement.

The at least one motor may be further drivingly coupled to selectively move the end of arm tool in the at least two-dimensional pattern while the end of arm tool spins. The at least one motor may include a first motor driving coupled to move the arms in the determined pattern of movement and a second motor drivingly coupled to spin the end of arm tool while the first motor moves the end of arm tool in the determined pattern of movement. The at least one controller may determine a spiral pattern of movement based at least on part on the received information. The contact portion of the end of arm tool may be spherical, and the end of arm tool may include stainless steel. At least the contact portion of the end of arm tool may be a food grade polymer, and the end of arm tool may be selectively detachable from the number of arms. At least the end of arm tool may be one of a food grade polymer or stainless steel and may have a convex contact portion, and may further include: at least one fastener that selectively detachably couples the end of arm tool to the number of arms. The food preparation robotic system may further include: a reservoir to contain a cleaning agent, wherein the controller provides instructions to move at least the contact portion of the end of arm tool into the reservoir and then out of the reservoir. The controller may provide instructions to cause the end of arm tool to spin after the at least the contact portion of the end of arm tool is moved out of the reservoir and before contact portion of the end of arm tool engages a subsequent food item. At least one sensor may sense at least one of a position, a shape or an orientation of at least a deposit of a sauce on a flat piece of dough, and the at least one controller may determine a pattern of movement based at least on part on at least one of the position, the shape or the orientation of at least a deposit of a sauce on a flat piece of dough. At least one sensor may sense at least one sensor that senses at least one of a position a flat piece of dough on a food grade conveyor belt, a shape of the piece of flat dough or an orientation of the piece of flat dough, and the at least one controller may determine a pattern of movement based at least on part on at least one of the position a flat piece of dough on a food grade conveyor belt, the shape or the orientation of the piece of flat dough. At least one sensor may sense at least one of a position, a shape or an orientation of at least a deposit of a sauce on a flat piece of dough, at least one of a position a flat piece of dough on a food grade conveyor belt, a shape of the piece of flat dough or an orientation of the piece of flat dough, and the at least one controller may determine a pattern of movement based at least on part on at least one of the position, the shape or the orientation of at least a deposit of a sauce on a flat piece of dough and based at least in part on at least one of the position a flat piece of dough on a food grade conveyor belt, the shape or the orientation of the piece of flat dough. At least one sensor may sense at least one of a position, a shape or an orientation of at least a deposit of a sauce on a flat piece of dough, at least one of a position a flat piece of dough on a food grade conveyor belt, a shape of the piece of flat dough or an orientation of the piece of flat dough, and the at least one controller may determine a pattern of movement based at least on part on at least one of the position, the shape or the orientation of at least a deposit of a sauce on a flat piece of dough and based at least in part on at least one of the position a flat piece of dough on a food grade conveyor belt, the shape or the orientation of the piece of flat dough.

A method of operation of a food preparation robotic system may be summarized as including: sensing, by at least one sensor, at least one of a position, a shape or an orientation of at least one component of a food item; and receiving information, by a controller, from the at least one sensor; determining, by the controller, a pattern of movement of an end of arm tool based at least on part on the received information; supplying, via the controller, control signals to drive the end of arm tool in the determined pattern of movement, where the end of arm tool has a contact portion with a round shape that performs redistribution of a component on a portion of a food item without cutting the food item and without adding any material to the food item.

Supplying control signals to drive the end of arm tool in the determined pattern of movement may include supplying control signals to drive at least one motor drivingly coupled to a number of arms to selectively move the end of arm tool in an at least two-dimensional pattern. The method may further include: causing at least the contact portion of the end of arm tool to spin while selectively moving the end of arm tool in the at least two-dimensional pattern while the end of arm tool spins. Supplying control signals to drive the end of arm tool in the determined pattern of movement may include supplying control signals to a first motor driving coupled to move the arms in the determined pattern of movement and supplying control signals to a second motor drivingly coupled to spin the end of arm tool while the first motor moves the end of arm tool in the determined pattern of movement. Determining a pattern of movement of an end of arm tool based at least on part on the received information may include determining a spiral pattern of movement based at least on part on the received information. The method may further include: providing instructions, by the controller, to at least one motor to move at least the contact portion of the end of arm tool into a reservoir that contains a cleaning agent, and then to move out of the reservoir. The method may further include: providing instructions, by the controller, to at least one motor to cause the end of arm tool to spin after the at least the contact portion of the end of arm tool is moved out of the reservoir and before contact portion of the end of arm tool engages a subsequent food item. Sensing, by at least one sensor, at least one of a position, a shape or an orientation of at least one component of a food item may include sensing at least one of a position, a shape or an orientation of at least a deposit of a sauce on a flat piece of dough, and determining a pattern of movement may be based at least on part on at least one of the position, the shape or the orientation of at least a deposit of a sauce on a flat piece of dough. Sensing, by at least one sensor, at least one of a position, a shape or an orientation of at least one component of a food item may include sensing at least one of a position a flat piece of dough on a food grade conveyor belt, a shape of the piece of flat dough or an orientation of the piece of flat dough, and determining a pattern of movement may be based at least on part on at least one of the position a flat piece of dough on a food grade conveyor belt, the shape or the orientation of the piece of flat dough. Sensing, by at least one sensor, at least one of a position, a shape or an orientation of at least one component of a food item may include: i) sensing at least one of a position, a shape or an orientation of at least a deposit of a sauce on a flat piece of dough; and ii) sensing at least one of a position a flat piece of dough on a food grade conveyor belt, a shape of the piece of flat dough or an orientation of the piece of flat dough, determining a pattern of movement may be based at least on part on at least one of the position, the shape or the orientation of at least a deposit of a sauce on a flat piece of dough and based at least on part on at least one of the position a flat piece of dough on a food grade conveyor belt, the shape or the orientation of the piece of flat dough.

An end of arm tool for use with a food preparation robotic system having a number of arms may be summarized as including: a body having a contact portion with a round shape that performs redistribution of a viscous liquid component on a portion of a food item without cutting the food item and without adding any material to the food item, at least the contact portion of the end of arm tool is one of a food grade polymer or a stainless steel, and at least one fastener that selectively detachably couples the end of arm tool to the number of arms of the food preparation robotic system.

The at least one fastener may selectively detachably couple the end of arm tool to the number of arms of the food preparation robotic system for movement in an at least two-dimensional pattern while the end of arm tool spins. At least the end of arm tool may be one of a food grade polymer or stainless steel and has a convex contact portion: The contact portion of the end of arm tool may be spherical. The end of arm tool may include a stainless steel. The end of arm tool may include a food grade polymer. The at least one fastener may include at least one of a male thread or female thread. The at least one fastener may include a first fastener that is a single piece unitary portion of the end of arm tool and a second fastener that is complementary to the first fastener and is selectively detachable therefrom.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of an on-demand robotic food assembly line environment that includes an order front end server computer system to, for example, receive orders from consumers or customers, an order assembly control system to control an on-demand robotic food assembly line, and order dispatch and en route cooking control system to control dispatch and en route cooking of food items, the on-demand robotic food assembly line can include one or more conveyors and one or more robots, operable to assemble food items in response to received orders for food items, according to one illustrated embodiment.

FIG. 2A is a schematic diagram of an on-demand robotic food assembly line such as that depicted in FIG. 1, that employs one or more conveyors and one or more robots to assemble food items based on received food orders, package the assembled food items in packaging, and optionally load the packaged assembled food items into cooking units (e.g., ovens) that are optionally loaded into cooking racks that are, in turn, optionally loaded into delivery vehicles where the food is cooked under controlled conditions while en route to consumer destinations, according to one illustrated embodiment.

FIG. 2B is a side elevational view of a dispensing container that may have a number of different dispensing ends for dispensing various toppings, including a grater, a nozzle, a rotating blade, and a linear blade.

FIG. 2C is a side elevational view of a dispensing container along with a single-use canister that contains sufficient topping items to provide toppings for a single item on the conveyor, according to one illustrated implementation.

FIG. 2D is an isometric view of a refrigerated environment that may be used for one or more of the workstations used on an on-demand robotic food assembly line such as that depicted in FIG. 1, workstations that include the cheese application robots and the toppings application robots, according to one illustrated implementation.

FIG. 2E is an isometric view of a linear dispensing array that may be used to dispense various toppings from multiple dispensing containers onto items being transported by the conveyor, according to one illustrated implementation.

FIG. 2F is an isometric top-side view of a dispenser carousel that may be used to dispense one or more toppings on items being transported by the conveyor, according to at least one illustrated implementation.

FIG. 2G is a top plan view showing the carousel from FIG. 2F in a position to dispense from one dispensing container onto a conveyer.

FIG. 2H is a top plan view showing the carousel from FIG. 2F in a position to concurrently dispense from two dispensing containers onto two parallel conveyors.

FIG. 2I is a top plan view showing the carousel from FIG. 2F in a position to concurrently dispense from two dispensing containers onto one conveyor.

FIG. 2J is a side elevational view of a dispensing end that has a grating attachment, according to at least one illustrated implementation.

FIG. 2K is a side elevational view of a dispensing end that has a nozzle, according to at least one illustrated implementation.

FIG. 2L is a side elevational view of a dispensing end that has a rotating blade attachment, according to at least one illustrated implementation.

FIG. 2M is a side elevational view of a dispensing end that has a linear slicer attachment, according to at least one illustrated implementation.

FIG. 3A is a front elevational view of a sauce dispenser of the on-demand robotic food assembly line of FIG. 2, operable to selective dispense a quantity of sauce as part of an food item assembly process, according to at least one illustrated embodiment.

FIG. 3B is a front elevational view of a cover for a cutter robot of the on-demand robotic food assembly line of FIG. 2, operable to slice or cut a food item into sections, according to at least one illustrated implementation.

FIG. 4 is an isometric view of a robotic spreader, according to one or more illustrated embodiments, the robotic spreader having a number of arms and an end of arm spreader tool.

FIG. 5 is an isometric view of an end of arm spreader tool of the robotic spreader of FIG. 4, according to one or more illustrated embodiments, the end of arm spreader tool having a contact portion and a coupler, the coupler which selectively detachably couples the contact portion to one or more arms of the robotic spreader.

FIG. 6A a bottom plan view of the coupler of the end of arm spreader tool of the robotic spreader of FIG. 4, according to one or more illustrated embodiments.

FIG. 6B a side elevational view of the coupler of the end of arm spreader tool of the robotic spreader of FIG. 4, according to one or more illustrated embodiments.

FIG. 6C a top plan view of the coupler of the end of arm spreader tool of the robotic spreader of FIG. 4, according to one or more illustrated embodiments.

FIG. 7A an isometric view of the contact portion of the end of arm spreader tool of the robotic spreader of FIG. 4, according to one or more illustrated embodiments.

FIG. 7B a side elevational view of the contact portion of the end of arm spreader tool of the robotic spreader of FIG. 4, according to one or more illustrated embodiments.

FIG. 7C a top plan view of the contact portion of the end of arm spreader tool of the robotic spreader of FIG. 4, according to one or more illustrated embodiments.

FIG. 8 is a high level logic flow diagram of operation of the robotic spreader of FIG. 4, according to an illustrated embodiment.

FIG. 9 is a partially exploded view of a transfer conveyor end of arm tool, according to an illustrated embodiment, the transfer conveyor end of arm tool may be physically coupled to an appendage of a robot for movement, for instance movement between a first and a second conveyor which operate at different transport speeds from one another.

FIG. 10 is a schematic diagram showing a processor-based system interacting with a number of delivery vehicles which each include a plurality of cooking units, for example ovens, and respective processor-based routing an cooking modules, according to an illustrated embodiment.

FIG. 11 is a logic flow diagram of an example order processing method, according to an illustrated embodiment.

FIG. 12 is a logic flow diagram of an example method of controlling on-demand robotic food assembly line, according to an illustrated embodiment.

FIG. 13 is a logic flow diagram of an example method of controlling on-demand robotic food assembly line, according to an illustrated embodiment.

FIG. 14 is a logic flow diagram of an example method of controlling dispatch and/or en route cooking of ordered food items, according to an illustrated embodiment.

FIG. 15 is a logic flow diagram of an example method of controlling dispatch and/or en route cooking of ordered food items, according to an illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, certain structures associated with food preparation devices such as ovens, skillets, and other similar devices, closed-loop controllers used to control cooking conditions, food preparation techniques, wired and wireless communications protocols, geolocation, and optimized route mapping algorithms have not been shown or described in detail to avoid unnecessarily obscuring descriptions of the embodiments. In other instances, certain structures associated with conveyors and/or robots are have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

As used herein the terms “food item” and “food product” refer to any item or product intended for human consumption. Although illustrated and described herein in the context of pizza to provide a readily comprehensible and easily understood description of one illustrative embodiment, one of ordinary skill in the culinary arts and food preparation will readily appreciate the broad applicability of the systems, methods, and apparatuses described herein across any number of prepared food items or products, including cooked and uncooked food items or products.

As used herein the terms “robot” or “robotic” refer to any device, system, or combination of systems and devices that includes at least one appendage, typically with an end of arm tool or end effector, where the at least one appendage is selectively moveable to perform work or an operation useful in the preparation a food item or packaging of a food item or food product. The robot may be autonomously controlled, for instance based at least in part on information from one or more sensors (e.g., optical sensors used with machine-vision algorithms, position encoders, temperature sensors, moisture or humidity sensors). Alternatively, one or more robots can be remotely controlled by a human operator.

As used herein the term “cooking unit” refers to any device, system, or combination of systems and devices useful in cooking or heating of a food product. While such preparation may include the heating of food products during preparation, such preparation may also include the partial or complete cooking of one or more food products. Additionally, while the term “oven” may be used interchangeably with the term “cooking unit” herein, such usage should not limit the applicability of the systems and methods described herein to only foods which can be prepared in an oven. For example, a hot skillet surface, a deep fryer, a microwave oven, and/or toaster can be considered a “cooking unit” that is included within the scope of the systems, methods, and apparatuses described herein. Further, the cooking unit may be able to control more than temperature. For example, some cooking units may control pressure and/or humidity. Further, some cooking units may control airflow therein, thus able to operate in a convective cooking mode if desired, for instance to decrease cooking time.

### Description of Delivery System Environments

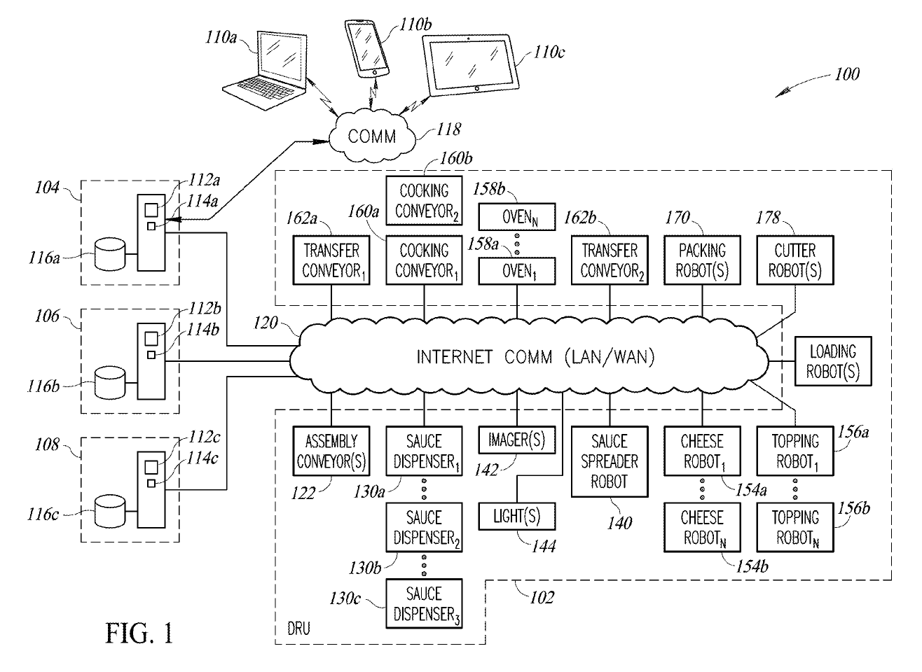

FIG. 1 shows an on-demand robotic food assembly line environment 100 according one illustrated embodiment. The on-demand robotic food assembly line environment 100 includes one or more on-demand robotic food assembly lines 102 (one shown). The on-demand robotic food assembly line environment 100 can include one or more processor-based control systems 104, 106, 108 communicatively coupled to receive orders for food items or food products, to dynamically generate, maintain and update a dynamic order queue, generate assembly instructions, packaging instructions, and to control loading and/or dispatch of food items or food products, and optionally control en route cooking of food items or food products.

For example, the on-demand robotic food assembly line environment 100 can include one or more order front end server computer control systems 104 to, for example, receive orders from consumer or customer processor-based devices, for instance a desktop, laptop or notebook computer 110a, smartphone 110b or tablet computer 110c (collectively consumer or customer processor-based device 110). The one or more order front end server computer control systems 104 can include one or more hardware circuits, for instance one or more processors 112a and/or associated nontransitory storage media, e.g., memory (e.g., FLASH, RAM, ROM) 114a and/or spinning media (e.g., spinning magnetic media, spinning optical media) 116a that stores at least one of processor-executable instructions or data. The one or more order front end server computer control systems 104 is communicatively coupled to the consumer or customer processor-based device 110, for example via one or more communications channels, for instance one or more non-proprietary network communications channels like a Wide Area Network (WAN) such as the Internet and/or cellular provider communications networks including voice, data and short message service (SMS) networks or channels 118.

The one or more order front end server computer control systems 104 may provide or implement a Web-based interface that allows a consumer or customer to order food items. The Web-based interface can, for example, provide a number of user selectable icons that correspond to respective ones of a number of defined food items, for instance various pizza with respective combinations of toppings. Alternatively or additionally, the Web-based interface can, for example, provide a number of user selectable icons that correspond to respective ones of a number of specific food items, for instance various toppings for pizza, allowing the consumer or customer to custom design the desired food item.

Also for example, the on-demand robotic food assembly line environment 100 can include one or more, order assembly control systems 106 to either submit to or to control the on-demand robotic food assembly line 102. The one or more order assembly control systems 106 can include one or more hardware circuits, for instance one or more processors 112b and/or associated nontransitory storage media, e.g., memory (e.g., FLASH, RAM, ROM) 114b and/or spinning media (e.g., spinning magnetic media, spinning optical media) 116b that stores at least one of processor-executable instructions or data. The one or more order assembly control systems 106 is communicatively coupled to the order front end server computer control systems 104 and communicatively coupled to the on-demand robotic food assembly line(s) 102, for example via one or more communications channels, for instance a network communications channel like a proprietary Local Area Network (LAN) or proprietary Wide Area Network (WAN) such as one or more intranets or other networks 120.

Also for example, the on-demand robotic food assembly line environment 100 can include one or more, order dispatch and en route cooking control systems 108 to control dispatch and en route cooking of food items. The one or more, order dispatch and en route cooking control systems 108 can include one or more hardware circuits, for instance one or more processors 112c and/or associated nontransitory storage media, e.g., memory (e.g., FLASH, RAM, ROM) 114c and/or spinning media (e.g., spinning magnetic media, spinning optical media) 116c that stores at least one of processor-executable instructions or data. The one or more, order dispatch and en route cooking control systems 108 is communicatively coupled to the order front end server computer control systems 104, the order assembly control systems 106 and/or various delivery vehicles and associated cooking units of the delivery vehicles. Some communications can employ one or more proprietary communications channels, for instance a proprietary network communications channel like a proprietary Local Area Network (LAN) or proprietary Wide Area Network (WAN) such as one or more intranets or other networks 120. For instance, communications between the order dispatch and en route cooking control systems 108 and the order front end server computer control systems 104 or the order assembly control systems 106 can occur via one or more proprietary communications channels. Some communications can employ one or more non-proprietary communications channels, for instance one or more non-proprietary network communications channels like a Wide Area Network (WAN) such as the Internet and/or cellular provider communications networks including voice, data and short message service (SMS) networks or channels 118. For instance, communications between the order dispatch and en route cooking control systems 108 and the vehicles or cooking units of the vehicles can occur via one or more non-proprietary communications channels, e.g., cellular communications network system.

The on-demand robotic food assembly line 102 can include one or more assembly conveyors 122a, 122b (collectively 122) and/or one or more workstations 124a-124j (collectively 124) at which food items or food products are assembled. The assembly conveyors 122 operate to move a food item or food product being assembled past a number of workstations 124 and associated equipment. The assembly conveyors 122 may take the form of conveyor belts, conveyor grills or racks or conveyor chains, typically with an endless belt, grill or chain that is driven in a closed circular path by one or more motors (e.g., electrical motor, electrical stepper motor) via a transmission (e.g., gears, traction rollers).

The on-demand robotic food assembly line 102 can include one or more robots 140, 154a, 154b, 156a, 156b (FIG. 1), operable to assemble food items or food products on demand (i.e. in response to actually received orders for food items or self-generated orders for food items). The robots 126 may each be associated with one or more workstations 124, for instance one robot per workstation. In some implementations, one or more workstation 124 may not have an associated robot 126, and may have some other piece of associated equipment (e.g., sauce dispenser, oven) and/or even a human present to perform certain operations.

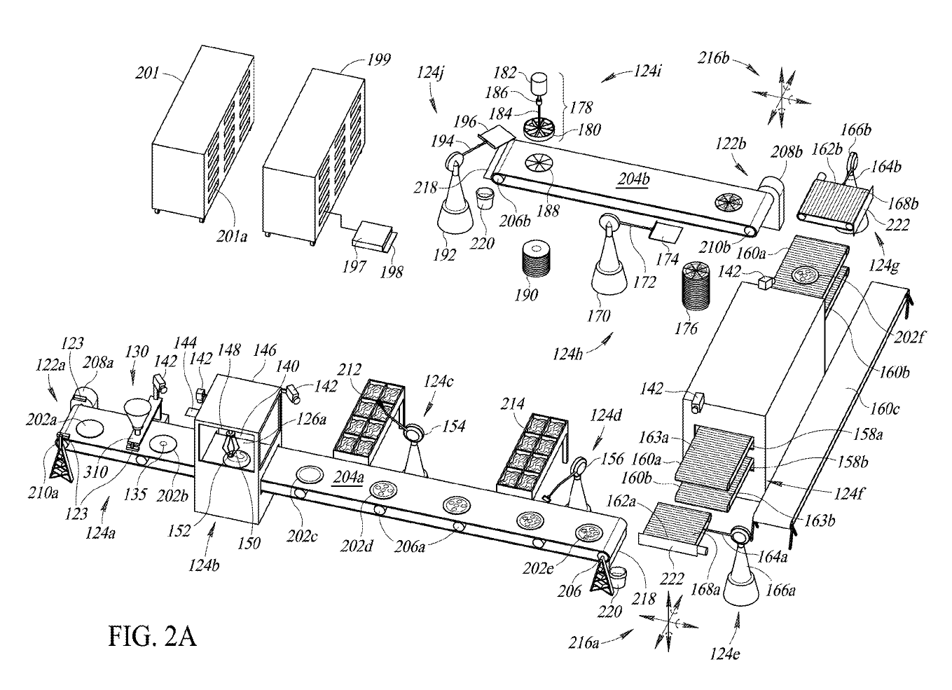

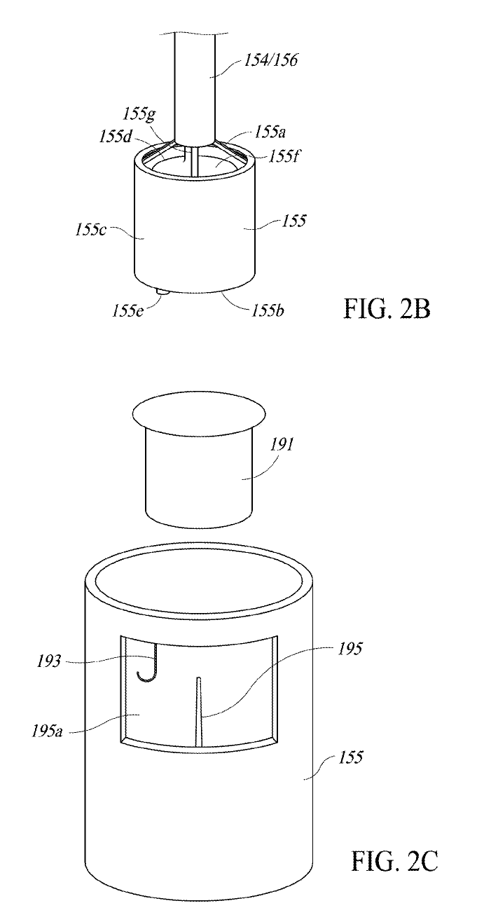

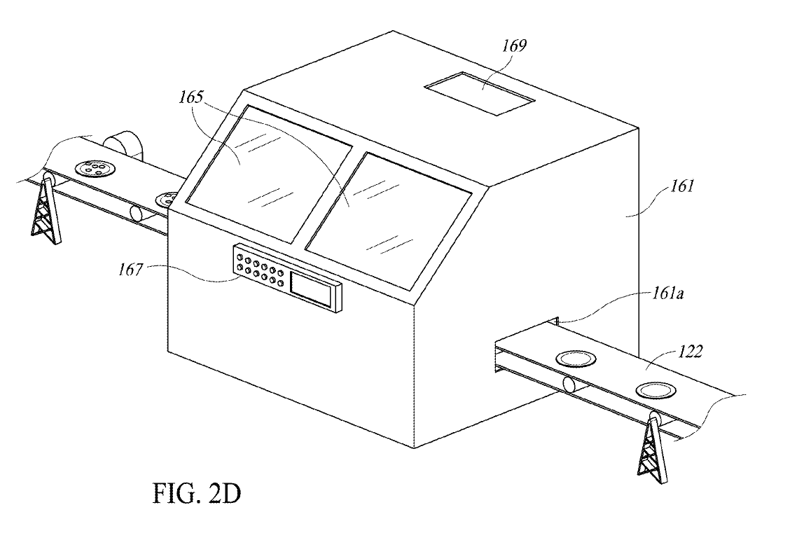

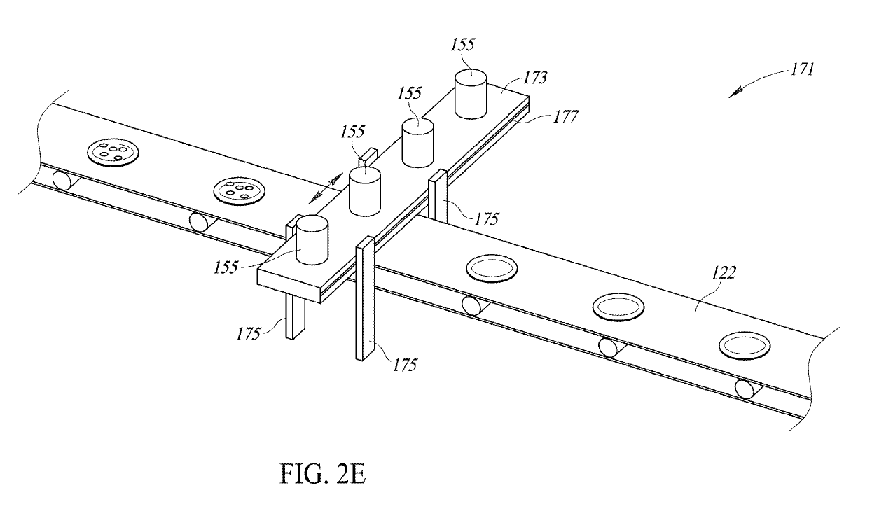

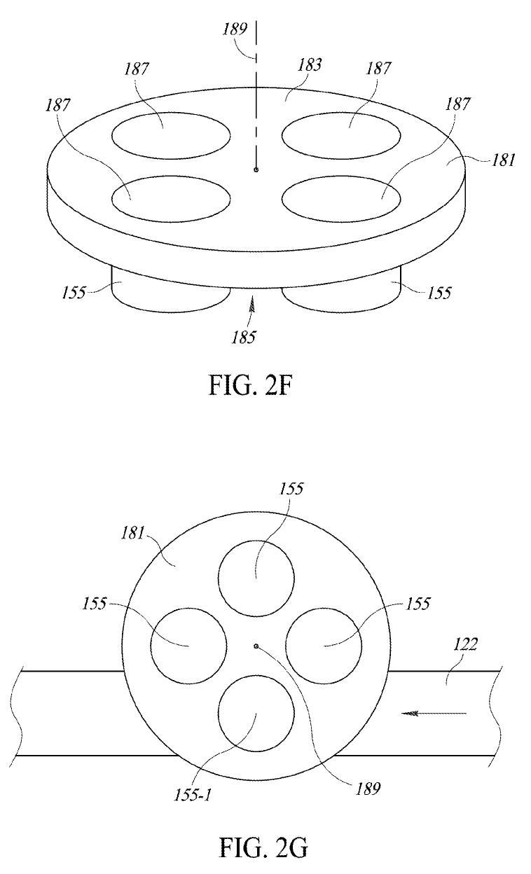

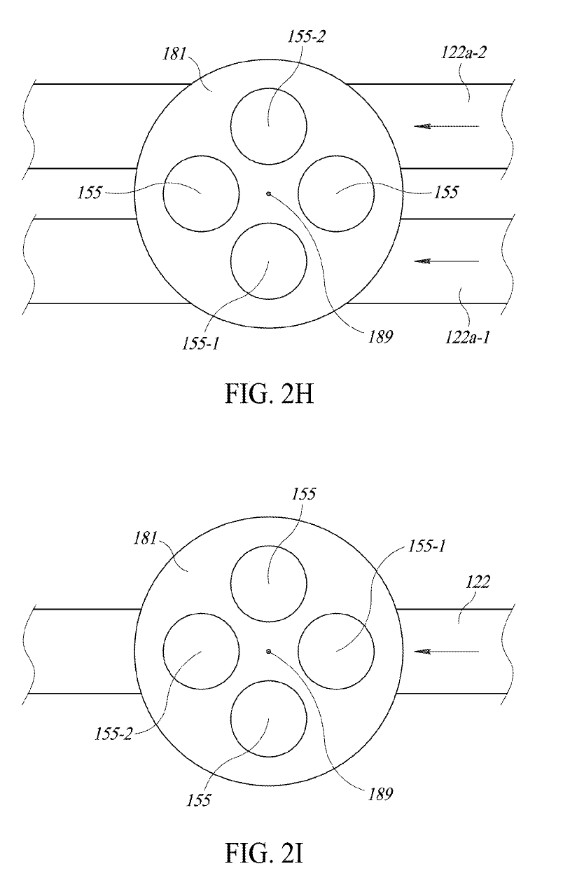

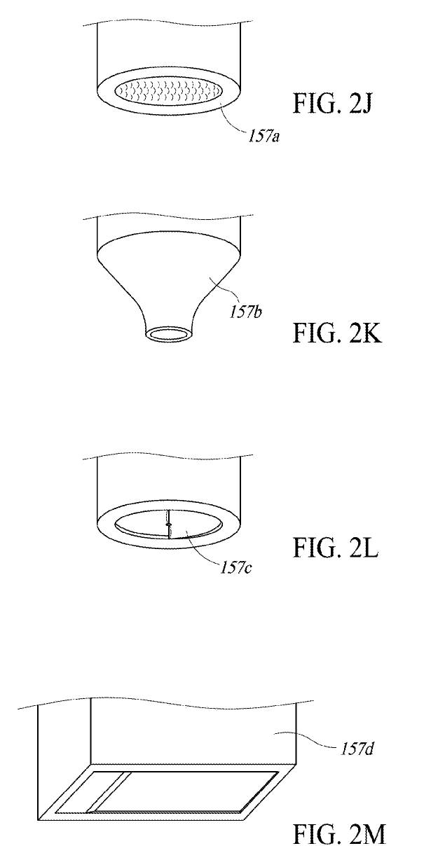

The example on-demand robotic food assembly line 102 illustrated in FIGS. 1, 2A, and 2B is now discussed in terms of an exemplary workflow, although one of skill in the art will recognize that any given application (e.g., type of food item) may require additional equipment, may eliminate or omit some equipment, and/or may arrange equipment in a different order, sequence or workflow.

The one or more order front end server computer control systems 104 receive orders for food items from consumer or customer processor-based devices. The order specifies each food item by an identifier and/or by a list of ingredients (e.g., toppings). The order also specifies a delivery destination, e.g., using a street address and/or geographic coordinates. The order also specifies a customer or consumer by name or other identifier. The order can further identify a time that the order was placed.

The order front end server computer control systems 104 communicates orders for food items to the one or more order assembly control systems 106. The order assembly control system(s) 106 generates a sequence of orders, and generates control instructions for assembling the food items for the various orders. The order assembly control systems 106 can provide instructions to the various components (e.g., conveyors, robots, appliances such as ovens, and/or display screens and/or headset speakers worn by humans) to cause the assembly of the various food items in a desired order or sequence according to a workflow.

The on-demand robotic food assembly line 102 may include a first or primary assembly conveyor 122a. The first or primary assembly conveyor 122a may convey or transit a partially assembled food item 202a-202e (FIG. 2A, collectively 202) past a number of workstations 124a-124d, at which the food item 202 is assembled in various acts or operations. As illustrated in FIG. 2, the first or primary assembly conveyor 122a may, for example, take the form of a food grade conveyor belt 204a that rides on various axles or rollers 206a driven by one or more motors 208a via one or more gears or teethed wheels 210a. In the example of pizza, the first or primary assembly conveyor 122a may initially convey a round of dough or flatten dough 202a (FIG. 2A) either automatically or manually loaded on the first or primary assembly conveyor 122a.

In some instances, the on-demand robotic food assembly line 102 may include two or more parallel first or primary assembly conveyors, an interior first or primary assembly conveyor 122a-1, and an exterior first or primary assembly conveyor 122a-2. The workstations and one or more robots 140, 154a, 154b, 156a, 156b (FIG. 1) may be operable to assemble food items or food products on demand on either or all of the two or more parallel first or primary assembly conveyors 122a-1, 122a-2. In some instances, at least one of the two or more parallel first or primary assembly conveyors (e.g., interior first or primary assembly conveyor 122a-1) may be placed and located to provide access to a human operator to place sauce, cheese, or other toppings onto the flatten dough 202a or other food item being transported by the interior one first or primary assembly conveyor 122a-1. The human operator may place the sauce, cheese, and/or other toppings, for example, when the associated robot(s) 140, 154a, 154b, 156a, and/or 156b is not functioning. Pizzas or other food items that do not require the sauce, cheese, and/or other topping from the non-functioning associated robot 140, 154a, 154b, 156a and/or 156b may continue to be assembled on the other, exterior first or primary assembly conveyor 122a-2.

One or more sensors or imagers 123 may be located along the edge of the first or primary assembly conveyor 122a at the location at which the round of dough or flatten dough 202a is loaded. The one or more sensors or imagers 123 may include: mechanical position encoders or optical position encoders such as rotary encoders, optical emitter and receivers pairs that pass a beam of light (e.g., infrared light) across a conveyor, commonly referred to as an “electric eye”, ultrasonic position detectors, digital cameras, Hall effect sensors, load cells, magnetic or electromagnetic radiation (e.g., infrared light) proximity sensors, video cameras, etc.

Such sensors or imagers 123 may be placed at the beginning of the primary assembly conveyor 122a. In some instances, the sensors or imagers 123 may be used to detect whether the round of dough or flatten dough 202a was correctly loaded onto the primary assembly conveyor 122a, for example, approximately towards the center of the width of the primary assembly conveyor 122a. For example, optical emitter and receiver pairs can be used to detect the location of the round or flatten dough 202a. In some implementations, the color of the primary assembly conveyor 122a may be based on the color of the emitter being used to detect the location of the round or flatten dough 202a. Thus, for example, the primary assembly conveyor 122a may be colored red or blue to facilitate the detection capabilities of a laser that emits red light. The intensity of the light being emitted by the emitter may vary as the flatten dough is being processed along the primary assembly conveyor 122a. For example, the intensity of the emitter may increase when a flatten dough 202a is placed on the primary assembly conveyor 122a, and the intensity of the emitter may be decreased when the flatten dough 202a is confirmed to be properly situated on the primary assembly conveyor 122a. In some instances, the imager 123 placed at the beginning of the primary assembly conveyor 122a may identify a shape for a particular food item (e.g., full pizza, half pizza, pizza slice, calzone, etc.). In such instances, the on-demand robotic food assembly line 102 may process and assemble food items of different sizes and shapes. The imager 123 may be used to identify the location and orientation of each food item as it is placed on the primary assembly conveyor 122a so that sauce, cheese, and other toppings may be correctly placed on the food item as it transits the on-demand robotic food assembly line 102.

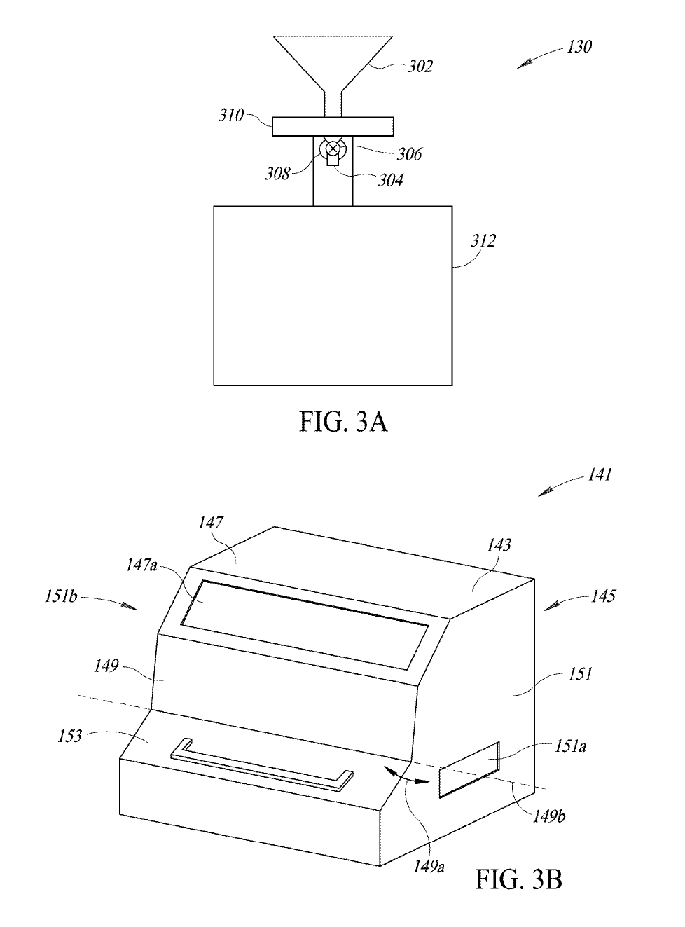

The on-demand robotic food assembly line 102 may include one or more sauce dispensers 130a, 130b (two shown in FIG. 1, one shown in FIG. 2A to improve drawing clarity, collectively 130), for example positioned at a first workstation 124a along the on-demand robotic food assembly line 102. As best illustrated in FIG. 3A, the sauce dispensers 130 include a reservoir 302 to retain sauce, a nozzle 304 to dispense an amount of sauce 135 (FIG. 2A) and at least one valve 306 that is controlled by control signals via an actuator (e.g. solenoid, electric motor) 308 to selectively dispense the sauce 135 from the reservoir 302 via the nozzle 304. The reservoir 302 can optionally include a paddle, agitator, or other stirring mechanism to agitate the sauce stored in the reservoir 302 to prevent the ingredients of the sauce from separating or settling out. The reservoir 302 may include one or more sensors that provide measurements related to the amount of sauce remaining in a reservoir 302. Such measurements can be used to identify when the amount of sauce in the reservoir is running low and should be refilled. In some implementations, the refilling of the reservoir 302 with sauce may be performed automatically without operator intervention from one or more sauce holding containers located elsewhere in the on-demand robotic food assembly line environment 100 that are fluidly coupled to the reservoirs 302.

The sauce dispenser 130 can optionally include a moveable arm 310 supported by a base 312, which allows positioning the nozzle 304 (FIG. 3A) over the first or primary assembly conveyor 122a (FIG. 2A). The sauce dispenser 130 may have multiple different nozzles 304 that dispense sauce in different patterns. Such patterns may be based, for example, on the size of the pizza or other food item being sauced. Relatively smaller food items, such as personal pizzas, may be sauce with a nozzle 304 that creates a star shaped pattern whereas relatively larger food items, such as large or super-sized pizzas, may be sauced with a nozzle 304 that creates a spiral pattern. The sauce dispenser 130 may dispense a defined volume of sauce for each food item or size of food item being sauced. In some implementations, there may be one sauce dispenser 130 for each of one or more sauces. In the example of pizza assembly, there may be a sauce dispenser 130a (FIG. 1) that selectively dispenses a tomato sauce, a sauce dispenser 130b (FIG. 1) that selectively dispenses a white (e.g., béchamel) sauce, a sauce dispenser 130c (FIG. 1) that dispensers a green (e.g., basil pesto) sauce.

The on-demand robotic food assembly line 102 may include one or more sauce spreader robots 140 and one or more imagers (e.g., cameras) 142 with suitable light sources 144 to capture images of the flatten dough with sauce 202b (FIG. 2A) for use in controlling the sauce spreader robot(s) 140. The sauce spreader robot(s) 140 may be positioned at a second workstation 124b along the on-demand robotic food assembly line 102. The sauce spreader robot(s) 140 may be housed in a cage or cubicle 146 to prevent sauce splatter from contaminating other equipment. The cage or cubicle 146 may be stainless steel or other easily sanitized material, and may have clear or transparent windows 148 (only one called out).

The one or more imagers 142 may be used to perform quality control for making the flatten dough and/or for spreading the sauce by the one or more sauce spreader robots 140. In some implementations, the one or more imagers 142 may be programmed to differentiate between instances of flatten dough without sauce and instances of flatten dough with sauce. The one or more imagers 142 may further be programmed to detect the shape of the flatten dough and/or the pattern of the sauce spread onto the flatten dough from the captured images, and compare the detected shape and/or pattern against a set of acceptable shapes, patterns or other criteria. Such criteria for the shape of the flatten dough may include, for example, the approximate diameter of the flatten dough and the deviation of the flatten dough from a circular shape. Such criteria for the coverage of the sauce may include, for example, amount or percentage of the flatten dough covered by sauce, proximity of sauce to the outer edge of the flatten dough, and/or the shape of the annulus of crust between the outer edge of the sauce and the outer edge of the flatten dough. If the imager 142 detects a defective flatten dough or sauce pattern, it may transmit an alert to the control system 104, which may cause the defective product to be rejected and a new instance to be made. Such imagers 142 may capture and process black-and-white images in some instances (e.g., determining whether a flatten dough has sauce) or may capture color images. In some implementations, the primary assembly conveyor 122a may have a specific color to create a better contrast with the flatten dough and/or sauce. For example, the primary assembly conveyor 122a may be colored blue to create a better contrast with the flatten dough and/or sauce for the imager 142.

As described in more detail below, the sauce spreader robot 140 includes one or more appendages or arms 150, and a sauce spreader end effector or end of arm tool 152. The appendages or arms 150 and a sauce spreader end effector or end of arm tool 152 are operable to spread sauce around the flatten round of dough. Various machine-vision techniques (e.g., blob analysis) are employed to detect the position and shape of the dough and/or to detect the position and shape of the sauce on the dough 202b (FIG. 2A). One or more processors generate control signals based on the images to cause the appendages or arms 150 to move in defined patterns (e.g., spiral patterns) to cause the sauce spreader end effector or end of arm tool 152 to spread the sauce evenly over the flatten round of dough while leaving a sufficient border proximate a perimeter of the flatten dough without sauce 202c (FIG. 2A). The sauce spreader end effector or end of arm tool 152 may rotate or spin while the appendages or arms 150 to move in defined patterns, to replicate the manual application of sauce to flatten dough.

The on-demand robotic food assembly line 102 may include one or more cheese application robots 154a, 154b (two shown in FIG. 1, one shown in FIG. 2A, collectively 154) to retrieve and dispense cheese of the sauced dough 202d (FIG. 2A). The cheese application robot(s) 154 can be located at a third workstation 124c. In the example of pizza assembly, one or more cheese application robots 154 can retrieve cheese and dispense the cheese on the flatten and sauced dough. The cheese application robots 154 can retrieve cheese from one or more repositories of cheese 212. For example, there may be one cheese application robot 154 for each of one or more cheese. Alternatively, one cheese application robot 154 can retrieve and dispense more than one type of cheese, the cheese application robot 154 operable to select an amount of cheese from any of a plurality of cheese in the repositories of cheese 212. In the example of pizza assembly, there may be a cheese application robot 154a (FIG. 1) that selectively dispenses a mozzarella cheese and a cheese application robot 154b (FIG. 1) that selectively dispenses a goat cheese. The cheese application robots 154 can have various end effectors or end of arm tools designed to retrieve various cheeses. For example, some end effectors or end of arm tools can include opposable digits, while others take the form of a scoop or ladle, and still others a rake or fork having tines, or even others a spoon or cheese knife shape. The cheese application robot 154 may be covered by a top cover located vertically above some or all of the cheese application robot 154 and/or the one or more repositories of cheese 212. In some applications, the top cover may be located above arm of the cheese application robot 154 and/or the one or more repositories of cheese 212.

The on-demand robotic food assembly line 102 may include one or more toppings application robots 156a, 156b (two shown in FIG. 1, one shown in FIG. 2A, collectively 156) to provide toppings. In one example involving pizza, one or more toppings application robots 156 can retrieve meat and/or non-meat toppings and dispense the toppings on the flatten, sauced and cheesed dough 202e. The toppings application robots 156 can retrieve toppings from one or more repositories of toppings 214. For example, there may be one respective toppings application robot 156a, 156b for each of one or more toppings. Alternatively or additionally, one toppings application robot 156 can retrieve and dispense more than one type of toppings. In the example of pizza assembly, there may be a toppings application robot 156a that selectively retrieves and dispenses meat toppings (e.g., pepperoni, sausage, Canadian bacon) and a toppings application robot 156b that selectively dispenses non-meat toppings (e.g., mushrooms, olives, hot peppers). The toppings application robots 156 can have various end effectors or end of arm tools designed to retrieve various toppings. For example, some end effectors or end of arm tools can include opposable digits, while others take the form of a scoop or ladle, and still others a rake or fork having tines. In some instances, the end effector may include a suction tool that may be able to pick and place large items. In some instances, the toppings application robot 156 may include multiple end effectors or end of arm tools. The used of multiple end effectors or end of arm tools may facilitate coverage of toppings. The toppings application robot 156 may be covered by a top cover located vertically above some or all of the toppings application robot 156 and/or the one or more repositories of toppings 214. In some applications, the top cover may be located above arm of the toppings application robot 156 and/or the one or more repositories of toppings 214.

The on-demand robotic food assembly line 102 may include one or more imagers (e.g., cameras) 142 with suitable light sources 144 proximate to one or both of the cheese application robots 154 and the toppings application robots 156 to capture images of food items, such as pizzas, that have been processed with these toppings. The captured images may be used for quality control purposes, for example, to ensure that the cheese application robots 154 and/or the toppings application robots 156 sufficiently cover sauced dough 202d with the requested toppings.

FIG. 2B shows a dispensing container 155 that may have a number of different dispensing ends for dispensing various toppings (four shown in FIGS. 2J-2M). In some implementations, one or both of the cheese application robots 154 and the toppings application robots 156 may include one of a plurality of dispensing containers 155 with one or more dispensing ends. Each of the dispensing containers 155 may have a top face 155a that is physically coupled to the cheese application robot 154 or toppings application robot 156, and a bottom face 155b to which a dispensing end attaches. The top face 155a and the bottom face 155b may be separated by a distance across which extends one or more side walls 155c. The side walls 155c may be substantially perpendicular to one or both of the top face 155a and the bottom face 155b. A cross section of the side walls 155c forms an interior for the dispensing container 155 that may be of various shapes (e.g., circular, elliptical, square, rectangular, etc.). The size, shape, and/or dimensions of the interior of the dispensing container 155 may be based on the type of topping to be dispensed. The dispensing ends may be detachable from the dispensing container 155. The dispensing ends may be cleanable and interchangeable, such that a single dispensing container 155 may be used to dispense various different toppings.

FIGS. 2J, 2K, 2L, and 2M show different types of dispensing ends that may be selected based on the type of item or topping to be dispensed. For example, FIG. 2J shows a grating attachment 157a that may be used, for example, for grating various types of hard cheeses (e.g., parmesan cheese, Romano cheese, etc.) or other topping items (e.g., garlic, boiled eggs, chocolate, etc.). The grating attachment 157a may be physically coupled to a motor that causes the grating attachment 157a to move laterally across the bottom face 155b of the dispensing container 155, thereby grating the cheese or other topping item to provide the topping.

FIG. 2K shows a dispensing end that incorporates a nozzle 157b that may be used to dispense semi-solid, viscous, or flowable topping items, such as, for example goat cheese, brie, peanut butter, cream cheese, etc. The size of the opening of the nozzle may be selected based on the type of topping item to be dispensed. For example, the opening for a nozzle 157b to dispense peanut butter may be relatively smaller than the opening for a nozzle 157b to dispense goat cheese.

FIG. 2L shows a dispensing end that incorporates a rotating blade 157c, such as a blade used in a food processor. The rotating blade 157c may rotate within a plane defined by the bottom face 155b of the dispensing container 155. The rotating blade 157c may have one or more blade edges that extend radially outward from the center of the rotating blade 157c towards the outside edges. The blade edges may be straight or the blade edges may curved. The rotating blade 157c may be used, for example, to provide fresh cut fruits or vegetables, such as sliced tomatoes, onions, and carrots, or other items, such as slices of mozzarella cheese, as toppings.

FIG. 2M shows a dispensing end that incorporates a linear slicer 157d, such as a slicing machine used to slice meats. The linear slicer 157d includes a blade edge that may extend transversely across a length or width of the linear slicer 157d along the bottom face 155b of the dispensing container 155. The blade edge travels along the bottom face 155b of the dispensing container 155 in a direction perpendicular to the direction in which the blade edge extends. In some implementations, the blade edge may be arranged at an angle to the length or width of the linear slicer 157d. The blade edge may further be slightly recessed into the bottom face 155b of the dispensing container 155 to form a gap between the blade edge and the bottom face 155b of the dispensing container 155 such that the processed food item may be ejected from the gap as the blade edge travels across the bottom face 155b. Such a linear slicer 157d may be used, for example, to slice various types of meats, such as salami or ham, or to slice other topping items, such as fruits, vegetables, etc.,

Each of the dispensing ends 157a-157d, and any other dispensing ends, may be detachably removed from the cheese application robots 154 and/or the toppings application robots 156. Such removal may allow for the dispensing ends 157a-157d to be cleaned. In some implementations, the cheese application robots 154 and/or the toppings application robots 156 may automatically remove one dispensing end 157a-157d (e.g., for cleaning after a certain number of uses) and replace the removed dispensing end 157a-157d with an identical or with a different type of dispensing end 157a-157d. The removed dispensing end 157a-157d may be placed inside of an apparatus for cleaning, such as a sink or reservoir that contains a cleaning agent, or an industrial dishwasher. In some implementations, the dispensing containers 155 may be detachably removed from the cheese application robots 154 and/or the toppings application robots 156, such as, for example, for cleaning.

The dispensing container 155 and attached dispensing end 157a-157d may be moved relative to the food item on the assembly conveyor 122 to arrange the topping in a desired pattern. For example, as a rotating blade 157c is used to dispense fresh cut pepperoni onto a pizza being moved along the assembly conveyor 122, the dispensing container 155 may be moved relative to the pizza to arrange the pepperoni in a triangular pattern. In some implementations, a dispensing container 155 may dispense a topping onto a food item moving along the assembly conveyor 122, and a toppings application robot 156 with various end effectors or end of arm tools (e.g., end of arm tools that include opposable digits) may be used to arrange the toppings into a desired pattern.

The topping item to be used for the topping may be contained within the interior of the dispensing container 155 and have a force applied to it in the direction of the bottom face 155b of the dispensing container 155 towards the attachment, e.g., dispensing ends 157a-157d. For example, the dispensing container 155 may include a plunger 155f that is located relatively towards the top face 155a of the dispensing container 155 compared to the topping item to be processed. A plunger 155f can be used to, for example, dispense a soft cheese (e.g. goat cheese) or similar viscous substance. The plunger 155f may have a flat surface arranged to be perpendicular to the side walls 155c of the dispensing container 155, and that is sized and shaped to fit substantially flush within the interior walls of the dispensing container 155. In some implementations, the plunger 155f may form a seal with the interior surface of the dispensing container 155, thereby preventing the topping item from escaping to and dirtying the top surface of the plunger 155f. The plunger 155f may be coupled to a pneumatic or spring component 155g that exerts a force on the plunger 155f towards the bottom surface 155b, causing the plunger 155f to apply a force in the same direction upon the topping item held within the dispensing container 155. The plunger 155f, motor/piston, and any other components that are used by the dispensing container 155 and/or dispensing ends 157a-157d to provide the topping may be actuated by a signal received from the control system 104. The plunger 155f and dispensing container 155 can form a piston and cylinder, with the piston moveable with respect to the cylinder to drive contents from the cylinder.

The dispensing container 155 may include one or more sensors that provide measurements related to the amount of topping item remaining in a dispensing container 155. Such measurements can be used to identify when the topping item to be processed to provide the topping is running low. For example, location sensors 155d may be located within the interior surface of the dispensing container 155 and can be used to identify the level of the plunger 155f. Such location sensors 155d may include line of sight sensors that include a light source that is aimed across the interior of the dispensing container 155 towards a light-sensing transducer, which can be used to indicate when the path of the light source to the light-sensing transducer is blocked. Such a location sensor 155d may include a plurality of electrical contacts located within the interior surface of the side walls that result in a high or a low signal when the electrical contacts are electrically coupled to the plunger 155f.

In some implementations, the amount of the topping item held within the dispensing container 155 may be determined by measuring a weight of the topping item using a weight sensor 155e, for instance one or more load cells. For example, the topping item may be contained in an insert suspended within the interior of the dispensing container 155 such that the combined weight of the insert and the topping item may be measured by the weight sensor 155e, such as an automated scale. The weight of the contained topping item may be determined by subtracting a known weight of the insert.

The control system 104 may include one or more threshold values for each of the dispensing containers 155 to identify when the contained topping item should be replenished or the dispensing container 155 refilled. The control system 104 may be electrically and communicatively coupled to receive signals from the one or more location sensors 155d and/or weight sensors 155e that are representative of the location of the plunger 155f and/or the weight of the remaining topping item to be used as the topping. The control system 104 may use the received signals to determine a value for the plunger location and/or the topping item weight, and compare this determined value to the threshold value. In some implementations, the control system 104 may modify the threshold value based upon the received and/or expected orders. Thus, for example, the threshold value for reloading pepperoni may be raised, causing the pepperoni to be reloaded more regularly, if the control system 104 receives an unexpectedly high number of orders for pizzas containing pepperoni. The control system 104 may cause an alarm to be activated when the threshold value is met or passed. In some implementations, the control system 104 may cause the topping item to be automatically reloaded when the threshold value is met or passed, such as, for example, by detaching the current, nearly empty dispensing container 155 and attaching a new, full dispensing container 155, or by removing the current insert and attaching a new insert into the interior of the dispensing container 155. In some implementations, the dispensing container 155 may be reloaded by hand, such as by pouring additional sauce or other topping items into an opening on the top of the dispensing container 155.

In some implementations, the control system 104 may use predictive determinations and/or machine learning to calculate times to refill or replenish a dispensing container 155. Such predictive determinations and/or machine learning may base it calculations for refilling or replenishing for a particular topping item on the velocity at which that particular topping items is being used. The control system 104 may schedule frequent refillings and/or replenishings for topping items currently being used at a high “velocity.” In addition or alternatively, the control system 104 may use machine learning to determine times for refilling or replenishing a particular topping item based on past usage of the topping item. For example, the control system 104 may use historical information regarding the high usage of a topping item at a particular time (e.g., high usage of pepperoni on a Friday night) to schedule more frequent refilling or replenishing of that topping item.

The control system 104 may control one or more of the dispensing containers 155 to dispense the same amount of topping each time a topping is used for an item on the assembly conveyor 122. For liquid toppings, the dispensing containers 155 may use a volumetric dispenser that dispenses a certain volume of topping item each time it is activated. For example, the control system 104 may activate a volumetric dispenser within a dispensing container 155 for “Buffalo” sauce to always dispense four fluid ounces of buffalo sauce for each medium-sized pizza that requests a “Buffalo” sauce topping. For dry goods or non-liquid toppings, the dispensing containers 155 may dispense a certain number or a specified weight of a topping item each time it is activated. For example, the control system 104 may control a dispensing container 155 for pepperoni to always dispense ten pieces of pepperoni for each medium sized pizza that requests a pepperoni topping.

FIG. 2C shows a dispensing container 155 along with a single-use canister 191 that contains sufficient topping items to provide toppings for a single item on the assembly conveyor 122. The single-use canister 191, for example, may contain an amount of sauce that is sufficient to provide toppings for a single pizza. As another example, the single-use canister 191 may provide olives, mushrooms, peppers, and other like food items that may be used as toppings for pizzas, hamburgers, etc. In some implementations, the dispensing container 155 may be able to receive single-use canisters 191 from multiple sources, with each source to provide a different type of topping. In such an implementation, a single dispensing container 155 may be used to provide multiple different toppings. In addition, the dispensing container 155 may include an extractor 193 and an ejector 195 to eject a spent single-use canister 191 once the single-use canister 191 has been used to dispense a topping. The extractor 193 may be used to move the spent single-use canister 191 towards an opening 195a in the dispensing container 155, and once the spent single-use canister 191 is at the opening 195a, the ejector 195 may be used to push the spent single-use canister 191 out from the dispensing container 155. Once the spent single-use canister 191 is ejected, the dispensing container 155 may be loaded with a new single-use canister 191 of the appropriate topping item to provide the next topping for the items on the assembly conveyor 122.

The dispensing containers 155 may be loaded with other types of containers that hold the various cheese and other topping items. In some instances, the dispensing containers 155 may be loaded with clam-shell canisters that may be selectively, detachably removed from the dispensing containers 155. Such clam-shell canisters may have a base end and a top end, and may be sized and shaped to be inserted into a dispensing container 155 with the base end first. The clam-shell canisters may further be configured such that the base end opens (e.g., pivots open about an axis) as the clam-shell canister is being inserted into the dispensing container 155, thereby providing access to the food item contained within the clam-shell canisters. In some instances, the clam-shell canisters may be configured such that the base end closes as the clam-shell canisters is removed from the dispensing container 155, thereby preventing the food item enclosed within the clam-shell canisters from dropping out as the clam-shell canisters is being inserted or removed from the dispensing container.

FIG. 2D shows a refrigerated environment that may be used for one or more of the workstations 124, such as the workstations 124 that include the cheese application robots 154 and the toppings application robots 156. Such refrigeration may be used to keep the topping item at a temperature, such as 42° F., that prolongs the shelf-life and improves the freshness of the cheese and other topping items used for the toppings. In some implementations, each of the workstations 124 that include the cheese application robots 154 and the toppings application robots 156 may be enclosed within individual refrigeration stations 161. The refrigeration stations may include one or more slots 161a located along the path of the assembly conveyor 122 that provide for ingress and/or egress of the pizza or other food item relative to the interior of the refrigeration station 161. The refrigeration station 161 may include an opening or door 169 that provides access to the interior of the refrigeration station 161 proximate the dispensing container 155. Such a door 169 may be used to reload the dispensing container 155 when the topping item is running low.

The refrigeration station 161 may provide for monitoring of the one or more workstations 124 enclosed within the refrigerated environment. For example, one or more windows 165 may provide for visual inspection, either by an operation and/or by an automated visual inspection system, of the interior of the refrigeration station 161. The interior temperature of the refrigeration system 161 may be monitored using, for example, a thermocouple or other temperature measuring device that may provide feedback signals to the control system 104. In some implementations, the refrigeration station 161 may include a control panel 167 that provides for monitoring and/or control of the refrigeration station 161. For example, the interior temperature of the refrigeration station 161 may be set using manual controls in the control panel 167. The control panel 167 may further provide a display that provides various types of information, such as the temperature of the interior of the refrigeration station 161, the amount of topping item remaining in the dispensing container 155, and the current operation being performed by the enclosed workstation 124. The control panel 167 may activate an alarm, such as a flashing light or other signal, when a fault condition occurs (e.g., when a dispensing container is running low on a topping item, when the interior temperature exceeds a certain threshold, etc.). In some implementations, multiple workstations 124 may be enclosed within a single refrigeration station 161. In some implementations, at least some, and potentially all, of the workstations 124, including the workstations that include the cheese application robots 154 and the toppings application robots 156 may be enclosed within a single refrigerated room.

FIG. 2E shows a linear dispensing array 171 that may be used to dispense various toppings from multiple dispensing containers 155 onto items being transported along the assembly conveyor 122. The linear dispensing array 171 may include a shelf 173 that is located above the assembly conveyor 122 and extends transversely across the path of the assembly conveyor 122. In some implementations, one or more legs 175 may be used to suspend the shelf 173 above the assembly conveyor 122 and provide sufficient clearance for each of the dispensing containers 155 to dispense a topping onto the item being transported by the assembly conveyor 122. In some implementations, the shelf 173 may be physically coupled to and supported by one or more arms that descend from the ceiling. The shelf 173 may include one or more translating components or tracks 177 that enable the shelf 173 to move laterally with respect to the path of the assembly conveyor 122. Such lateral movement enables the shelf 173 to place the appropriate dispensing container 155 over the conveyor to dispense the requested topping. In some implementations, the linear dispensing array 171 may be controlled to dispense multiple toppings onto a single item being transported by the assembly conveyor 122. In some implementations, the linear dispensing array 171 may be oriented to be parallel to the assembly conveyor 122 such that each of the dispensing containers 155 is located over the assembly conveyor 122 and may concurrently dispense toppings onto food items being transported along the assembly conveyor 122.

FIGS. 2F, 2G, 2H, and 2I show a dispenser carousel 181 that may be used to dispense toppings from one or more dispensing containers 155. The dispenser carousel 181 may be substantially shaped like a disk, with a circular top surface 183 and a circular bottom surface 185 that are arranged to be parallel to the surface of the assembly conveyor 122. The dispenser carousel 181 may include one or more openings 187, each of which is associated with a dispensing container 155 that may be used to dispense various toppings onto the items being transported by the assembly conveyor 122. The dispenser carousel 181 is located above the assembly conveyor 122 with sufficient clearance for toppings to be dispensed from each of the dispensing containers 155 and the associated dispensing ends 157a-157d. The dispenser carousel 181 rotates about an axis of rotation 189 that extends vertically from a center point of the circular top surface 183.

The dispenser carousel 181 may rotate about the axis of rotation 189 such that at least one of the dispensing containers 155 is located directly above the path of the assembly conveyor 122 and in a position to dispense a topping. As shown in FIG. 2G, a single one of the dispensing containers 155-1 may be located in a position over the assembly conveyor 122 to dispense a topping onto the item being transported on the assembly conveyor 122. The dispenser carousel 181 may be rotated about the axis of rotation 189 to change the dispensing container 155 located above the assembly conveyor 122. FIG. 2H shows an optional configuration in which two parallel conveyors, a first assembly conveyor 122a-1 and a second assembly conveyor 122a-2, are both traversed by the dispenser carousel 181. In such an implementation, a first dispensing container 155-1 may be in a position to dispense toppings onto items being transported along the first assembly conveyor 122a-1, while a second dispensing container 155-2 may be in a position to dispense toppings onto items being transported along the second assembly conveyor 122a-2. Alternatively, as shown in FIG. 2I, multiple dispensing containers 155-1 and 155-2 may be concurrently located over the assembly conveyor 122 and be in a position to dispense toppings onto separate items being transported by the assembly conveyor 122.

The on-demand robotic food assembly line 102 may include one or more ovens 158a, 158b (two shown in FIG. 2A, collectively 158) to cook or partially cook food items (e.g., the flatten, sauced and cheesed dough 202e). The on-demand robotic food assembly line 102 may include one or more cooking conveyors 160a, 160b to convey the food items (e.g., the flatten, sauced and cheesed dough 202e) to, through, and out of the ovens 158. The on-demand robotic food assembly line 102 may, for example, include a respective cooking conveyor 160a, 160b, for each of the ovens 158a, 158b. As best illustrated in FIG. 2, the cooking conveyors 160 may, for example, take the form of grills or racks 163a, 163b that form a loop or belt that rides on various rollers or axles (not called out in Figures) driven by one or more motors (not called out in Figures) via one or more gears or teethed wheels (not called out in Figures). The grills or racks 163 or chains may be made of a food grade material that is able to withstand the heat of the ovens, for instance stainless steel. In the example of pizza assembly, the ovens 158 may produce a temperature above 500 F, preferably in the 700 F and above range. The ovens 158 will typically be at or proximate the same temperature, although such is not limiting. In some applications, the ovens 158 may be set a different temperatures from one another. In some applications, the ovens 158 a selectively adjustable on a per order basis. Thus, when ordering a pizza, a consumer or customer may specify an amount of charring desired on the partially cooked sauced, cheesed and topped dough 202f. A processor-based device can determine a desired temperature based on the specified amount of charring, and adjust a temperature of the oven 158 to achieve the desired amount of charring. The amount of charring may be based on the temperature and/or time spent trans versing the oven 158 on the respective cooking conveyor 160.

Typically, the cooking conveyors 160 will travel at a different speed than the first or primary assembly conveyor 122a. Hence, the on-demand robotic food assembly line 102 may include one or more first transfer conveyors 162a to transfer the uncooked food items (e.g., the flatten, sauced and cheesed dough 202e) from the first or primary assembly conveyor 122a to one of the cooking conveyors 160a, 160b. In the example of pizza assembly, the cooking conveyors 160a, 160b will likely travel at a much slower speed than the first or primary assembly conveyor 122a. Notably, while the cooking conveyors 160a, 160b will typically travel at the same speed as one another, such should not be considered limiting. In some applications, the cooking conveyors 160a, 160b can travel at different speeds from one another. In some applications, the speed at which each cooking conveyor 160a, 160b travels may be controlled to account for cooking conditions, environmental conditions, and/or the spacing or composition of uncooked food items (e.g., the flatten, sauced and cheesed dough 202e) being transported by the cooking conveyor 160a, 160b. For example, the first transfer conveyor 162a may place multiple uncooked food items (e.g., the flatten, sauced and cheesed dough 202e) close together on one cooking conveyor 160, the close spacing which may cause a reduction in the temperature of the associated oven 158 as the uncooked food items (e.g., the flatten, sauced and cheesed dough 202e) pass through. In such a situation, the speed of the one cooking conveyor 160 may be reduced, providing additional time for the uncooked food items 202e which are being cooked or par-based to reside in the oven 158. In some applications, the first transfer conveyor 162a may leave additional space between adjacent uncooked food items 202e, which may enable the oven 158 to maintain a higher temperature. In such an application, the speed of the associated cooking conveyor 160 may need to be relatively faster to prevent the uncooked food item (e.g., the flatten, sauced and cheesed dough 202e) from being burned. Additional considerations, such as humidity, dough composition, or food/pizza type (e.g., thin crust pizza versus deep dish pizza) may be used to independently control the speeds for each of the cooking conveyors 160a, 160b. In some implementations, cooking may be controlled at an individual item by item level using an assembly line. Thus, a sequence of food items, for instance pizzas, may vary in constituents from item to item in the sequence. For instance, a first item may be a thin wheat crust cheese pizza, while a second item may be a thick wheat crust pizza loaded with four types of meat, while a third item may be a medium semolina crust pizza with mushrooms.

In some applications, the temperatures of the ovens 158a, 158b and/or the speed of the cooking conveyors 160a, 160b may be controlled by one or more processor-based devices executing processor-executable code based on temperature, humidity, or other conditions fed back to the processor-based devices. In some implementations, the temperature of the ovens 158a, 158b and/or the speed of the cooking conveyors 160a, 160b may be controlled by the operator via one or more controls (e.g., a touch-screen control, one or more knobs, a remote RF control, a networked Web-based control, etc.). The ovens 158a, 158b may be programmed to have a tight hysteresis control that prevents the ovens 158a, 158b from deviating too much from a set temperature, which may further impact the speed of each of the cooking conveyors 160a, 160b. A processor-based device can adjust a speed of travel of the first transfer conveyor 162a to accommodate for such differences in speed of the cooking conveyors 160a, 160b.

The first transfer conveyor 162a may be coupled to a first appendage 164a of a first transfer conveyor robot 166a as an end effector or end of arm tool. The first transfer conveyor robot 166a may be able to move the first transfer conveyor 162a with 6 degrees of freedom, for example as illustrated by the coordinate system 216a. The first appendage 164a can be first be operated to move the first transfer conveyor 162a proximate an end of the first or primary assembly conveyor 122a to retrieve sauced, cheesed, and topped flatten dough 202e from to first the first or primary assembly conveyor 122a. The first transfer conveyor 162a is preferably operated to move the grill, rack, chains 168a in a same direction and at least approximately same speed as a direction and speed at which the first or primary assembly conveyor 122a travels. This helps to prevent the flatten dough 202e from becoming elongated or oblong. The grill, rack, chains 168a of the first transfer conveyor 162a should be closely spaced to or proximate the end of the first or primary assembly conveyor 122a to prevent the sauced, cheesed and topped flatten dough 202e from drooping.

One or more wipers or scrapers 218 may be located towards the end of the first or primary assembly conveyor 122a proximate the first transfer conveyor 162a. The one or more wipers or scrapers 218 may stretch transversely across the first or primary assembly conveyor 122a to clean the first or primary assembly conveyor 122a of debris. The one or more wipers or scrapers 218 may, for example, have a blade shape, and may consist of a food grade material (e.g., silicone rubber, stainless steel) or may comprise two or more materials, with any portion that may contact food or a food handling surface comprised of a food grade material (e.g., silicone rubber, stainless steel). In some implementations, the one or more wipers or scrapers 218 may stretch across the first or primary assembly conveyor 122a at a diagonal with respect to the direction of travel of the first or primary assembly conveyor 122a to direct the debris off of the first or primary assembly conveyor 122a and towards a trash receptacle 220 placed to the side of the first or primary assembly conveyor 122a. In some implementations, the wipers or scrapers 218 may be located proximate the outside surface of the first or primary assembly conveyor 122a that carries the partially assembled food item 202a-202e. In some implementations, the wipers or scrapers 218 may be in contact with the outside surface of the first or primary assembly conveyor 122a.

The first appendage 164a can then be operated to move the first transfer conveyor 162a proximate a start of one of the cooking conveyors 160a, 160b. The grill, rack, chains 168a of the first transfer conveyor 162a are then operated to transfer the sauced, cheesed, and topped flatten dough 202e from the first transfer conveyor 162a to one of cooking conveyors 160a, 160b. The grill, rack, chains 168a may be coated with a non-stick coating (e.g., food grade PTFE (polytetrafluoroethylene) commonly available under the trademark TEFLON®, ceramics) to facilitate the transfer of the sauced, cheesed, and topped flatten dough 202e to one of cooking conveyors 160a, 160b. The first transfer conveyor 162a is preferably operated to move the grill, rack, chains 168a in a same direction and at least approximately same speed as a direction and speed at which the oven conveyor 160a, 160b travels. This helps to prevent the flatten, sauced and cheesed dough 202e from becoming elongated or oblong. The first transfer conveyor 162a may have a short end-of-arm wall 222 that runs perpendicular to the direction of travel of the grill, rack, chains 168a. The short end-of-arm wall 222 may be attached to (e.g., by clipping onto) the end of the grill, rack, chains 168a opposite the end at which the first transfer conveyor 162a loads the flatten dough 202e onto the oven conveyor 160a, 160b. The short end-of-arm wall 222 may be attached via fast release fasteners or clips, allowing easy removal for cleaning or replacement. The grill, rack, chains 168a of the first transfer conveyor 162a should be closely spaced or proximate the start of the oven conveyor 160a, 160b to prevent the sauced, cheesed and topped flatten dough 202e from drooping.

The use of multiple ovens 158a, 158b and cooking conveyors 160a, 160b per first or primary assembly conveyor 122a helps eliminate any backlog that might otherwise occur due to the difference in operating speeds between the first or primary assembly conveyor 122a and the cooking conveyors 160a, 160b. In particular, the first appendage 164a can alternately move between two or more cooking conveyors 160a, 160b for each successive round of sauced, cheesed, topped flatten dough 202e. This allows the first or primary assembly conveyor 122a to operate at relatively high speed, with rounds of flatten dough 202e relatively closely spaced together, while still allowing sufficient time for the sauced, cheesed and topped flatten dough 202e to pass through the respective ovens 158a, 158b to “par-bake” the sauced, cheesed and topped flatten dough 202e to produce par-baked shell 202g, thereby establishing a higher level of rigidity than associated with completely uncooked dough. The higher level of rigidity eases downstream handling requirements in the workflow.

One or more by-pass conveyors 160c may run parallel to the two or more cooking conveyors 160a, 160b to by-pass the multiple ovens 158a, 158b. The by-pass conveyors 160c may be used, for example, when a previously par-baked shell 202g has gone through the first or primary assembly conveyor 122a to receive additional sauce or toppings. The previously par-baked shell 202g may be sufficiently rigid from the previous par-bake procedure that it need not go through the par-bake procedure a second time. The first appendage 164a of the first transfer conveyor 162a can move between the first or primary assembly conveyor 122a and the one or more by-pass conveyors 160c to transfer the previously par-baked shells 202g or other food items. The one or more by-pass conveyors 160c may travel and transport food items at a different speed than the cooking conveyors 160a, 160b. For example, the one or more by-pass conveyors 160c may move faster than the cooking conveyors (i.e., oven conveyor racks) 160a, 160b, thereby quickly transporting the par-baked shells 202g, which need not be cooked within the ovens 158a, 158b, between the first transfer conveyor 162a and the second transfer conveyor 162b.

The on-demand robotic food assembly line 102 may include one or more second or secondary assembly conveyors 122b to transfer cooked or partially cooked food items 202f past a number of workstations 124h, 124i, 124j. As illustrated in FIG. 2, the second or secondary assembly conveyors 122b may, for example may, for example, take the form of a food grade conveyor belt 204b that rides on various axles or rollers 206b driven by one or more motors 208b via one or more gears or teethed wheels 210b.

Typically, the second or secondary assembly conveyor 122b will travel at a different speed than the cooking conveyors 160a, 160b. Hence, on-demand robotic food assembly line 102 may include one or more second transfer conveyors 162b to transfer the cooked or partially cooked food items 202f from the cooking conveyors 160a, 160b to the second or secondary assembly conveyors 122b. In the example of pizza assembly, the cooking conveyors 160a, 160b will likely travel at a much slower speed than the second or secondary assembly conveyor 122b. Notably, while the cooking conveyors 160a, 160b will typically travel at the same speed as one another, such should not be considered limiting. In some applications, the cooking conveyors 160a, 160b can travel at different speeds from one another. A processor-based device can adjust a speed of travel of the second transfer conveyor 162b to accommodate for such differences in speed of the cooking conveyors 160a, 160b.

The second transfer conveyor 162b may be coupled to a second appendage 164b of a second transfer conveyor robot 166b as an end effector or end of arm tool. The second transfer conveyor robot 166b may be able to move the second transfer conveyor 162b with 6 degrees of freedom, for example as illustrated by the coordinate system 216b. The second appendage 164b can be first be operated to move the second transfer conveyor 162b proximate an end of one of the cooking conveyors 160a, 160b to retrieve sauced, cheesed, and topped flatten and partially cooked dough 202f from the oven conveyor 160a, 160b. The second transfer conveyor 162b is preferably operated to move the grill, rack, chains or belt 168b in a same direction and at least approximately same speed as a direction and speed at which the oven conveyor 160a, 160b travels.

The second appendage 164b can then be operated to move the second transfer conveyor 162b proximate a start of the second or secondary assembly conveyor 122b. The belt, grill, rack, or chains 168b of the second transfer conveyor 162b are then operated to transfer the sauced, cheesed, and topped flatten and partially cooked dough 202f to the second or secondary assembly conveyor(s) 122b. The grill, rack, chains 168b may be coated with a non-stick coating (e.g., food grade PTFE (polytetrafluoroethylene) commonly available under the trademark TEFLON®, ceramics) to facilitate the transfer of the sauced, cheesed, and topped flatten and partially cooked dough 202f to the second or secondary assembly conveyor(s) 122b. The second transfer conveyor 162b is preferably operated to move the belt, grill, rack, or chains 168b in a same direction and at least approximately same speed as a direction and speed at which belt 204b of the second or secondary assembly conveyor 122b travels. The second transfer conveyor 162b may have a short end-of-arm wall 222 that runs perpendicular to the direction of travel of the grill, rack, chains 168b. The short end-or-arm wall may be attached to (e.g., clipped onto) the end of the grill, rack, chains 168b opposite the end at which the second transfer conveyor 162b loads the partially cooked dough 202f from the oven conveyor 160a, 160b.

The on-demand robotic food assembly line 102 may include one or more packaging robots 170. The packaging robot(s) 170 include one or more appendages 172 with one or more end effectors or end of arm tools 174. The end effectors or end of arm tools 174 are designed to retrieve packaging 176, for instance from a stack. The packaging may, for example, take the form of molded fiber bottom plates and domed covers, such as that described in U.S. provisional patent application Ser. No. 62/311,787; U.S. patent application Ser. No. 29/558,872; U.S. patent application Ser. No. 29/558,873; and U.S. patent application Ser. No. 29/558,874. The packaging robot(s) 170 retrieve and move the packaging 176 (e.g., bottom plates or trays) onto the second or secondary assembly conveyor 122b, onto which the sauced, cheesed, and topped flatten and partially cooked dough 202f is placed via the second transfer conveyor 162b.

The on-demand robotic food assembly line 102 may include one or more cutters or cutter robots 178. The cutters or cutter robots 178 may include a set of blades 180, an actuator 182 (e.g., solenoid, electric motor, pneumatic piston), a drive shaft 184, and one or more bushings 186. The actuator 182 moves the blades 180 up and down, to cut the sauced, cheesed, and topped flatten and partially cooked dough 202f, while the sauced, cheesed, and topped flatten and partially cooked dough 202f sits on a bottom plate or tray of the packaging 176. The bushings 186 restrain the travel of the drive shaft 184, for example, to vertical motion. The one or more cutters or cutter robots 178 may, for example, be a cutter such as that described in U.S. provisional patent application No. 62/394,063, titled “CUTTER WITH RADIALLY DISPOSED BLADES,” filed on Sep. 13, 2016. A cutting support tray 188 may underline the packaging 176. The cutting support tray 188 may include a set of cutting groove that accommodate corresponding cutting grooves in the packaging 176, preventing the packaging 176 from being cut was the blades 180 cut the sauced, cheesed, and topped flatten and partially cooked dough 202f. Where a cutting support tray 188 is employed, a robot (e.g., packaging robot 170) may position the cutting support tray 188 at the start of the second or secondary assembly conveyor 122b, then position the packaging 176 on the cutting support tray 188. The packaging robot 170 may position the cutting support tray 188 and packaging 176 such that the second transfer conveyor 162b deposits the sauced, cheesed, and topped flatten and partially cooked dough 202f on the packaging 176 supported by the cutting support tray 188.

FIG. 3B is a front elevational view of a cover 141 for the cutter robot 178 that encloses at least the portion of the cutter robot 178 that includes the set of blades 180, the actuator 182, the drive shaft 184, and the cutting support tray 188. The cover 141 includes a guard-shell 143 that has a back cover 145, a top cover 147, a partial front cover 149, and one or more side covers 151. The top cover 147 may include a window 147a, such as a window comprised of acrylic, plastic, or like suitable materials, that enables an operator to safely view the cutter robot 178. The window 147a may facilitate the positioning of the pizza or other food item by the operator under the set of blades 180 in the cutter robot 178. The side covers 151 may include opposing openings 151a, 151b that are positioned over the belt 204b to provide an ingress and/or egress for food items being moved by the belt 204b. At least one of the openings 151a, 151b may provide an entry for the one or more packaging robots 170 to retrieve a cut sauced, cheesed, and topped flatten and partially cooked dough 202f for packaging as discussed below.

The cover 141 may include a door 153 that is rotatably coupled to the partial front cover 149 of the guard-shell 143. The door 153 may rotate or pivot 149a along an axis of rotation 149b that runs transversely across the bottom of the partial front cover 149. In some implementations, the door 153 may include a trigger, such as a pneumatic actuator, to activate the actuator 182. As such, the actuator 182 may be triggered, thereby moving the set of blades 180 downward to cut the sauced, cheesed, topped flatten and partially cooked dough, when the door 153 is pivoted inwards 159a towards the interior of the cover 141 relative to the axis of rotation 149b. Such operation may provide a safety feature for the cutter robot 178.

After cutting, the packaging robot(s) 170 may retrieve and move the packaging 190 (e.g., domed covers) into engagement with the packaging 176 (bottom plates or trays), closing the packaging 176, 190, for instance by asserting a downward pressure causing pegs of the packaging 190 to engage inserts or receptacles of the packaging 176. Thus, the sauced, cheesed, and topped flatten and partially cooked dough 202f can be assembled and packaged without being touched or manually handled by humans.

One or more wipers or scrapers 218 may be located towards the end of the second or secondary assembly conveyors 122b after a point at which the loading robot 192 has retrieved the packaged sauced, cheesed, and topped flatten and partially cooked dough 202f from the second or secondary assembly conveyors 122b. The one or more wipers or scrapers 218 may, for example, have a blade shape, and may consist of a food grade material (e.g., silicone rubber, stainless steel) or may comprise two or more materials, with any portion that may contact food or a food handling surface comprised of a food grade material (e.g., silicone rubber, stainless steel). The one or more wipers or scrapers 218 may stretch transversely across the second or secondary assembly conveyors 122b to clean the second or secondary assembly conveyors 122b of debris. In some implementations, the one or more wipers or scrapers 218 may stretch across the second or secondary assembly conveyors 122b at a diagonal with respect to the direction of travel of the second or secondary assembly conveyors 122b to direct the debris off of the second or secondary assembly conveyors 122b and towards a trash receptacle 220 placed to the side of the second or secondary assembly conveyors 122b. In some implementations, the wipers or scrapers 218 may be located proximate the outside surface of the second or secondary assembly conveyors 122b that carries the packaged sauced, cheesed, and topped flatten and partially cooked dough 202f. In some implementations, the wipers or scrapers 218 may be in contact with the outside surface of the second or secondary assembly conveyors 122b.

The on-demand robotic food assembly line 102 may include one or more loading robots 192, with one or more appendages 194 and end effectors or end of arm tools 196. The loading robots 192 can retrieve and load the packaged sauced, cheesed, and topped flatten and partially cooked dough 202f into ovens 197, for instance via a door 198 of the oven 197. The end of arm tools 196 may be coated with a non-stick, food-grade coating to facilitate the transfer of the sauced, cheesed, and topped flatten and partially cooked dough 202f into ovens 197. In some applications, the end of arm tools 196 may include a flexible appendage, sized and shaped to be similar to a human finger, that can be used to open and close the doors to the ovens 197. In some applications, the end of arm tools 196 may include a sensor or imager (e.g., a camera) that can be used to confirm that the oven 197 into which the packaged sauced, cheesed, and topped flatten and partially cooked dough 202f is to be loaded is empty, and/or that the door to the oven 197 is open. The ovens 197 may be pre-mounted or pre-installed in a rack 199. The rack 199 may have wheels or casters, and is loadable into a vehicle (not shown), for dispatch to delivery destinations.

The on-demand robotic food assembly line 102 may include one or more position sensors or detectors spaced therealong to track the position or location of individual food items 202 as they transit the on-demand robotic food assembly line 102. Position sensors or detectors can take a variety of forms, for example: mechanical position encoders or optical position encoders such as rotary encoders, optical emitter and receivers pairs that pass a beam of light (e.g., infrared light) across a conveyor, commonly referred to as an “electric eye”, ultrasonic position detectors, digital cameras, Hall effect sensors, magnetic or electromagnetic radiation (e.g., infrared light) proximity sensors, etc.”

The proximity sensors or detectors can be positioned with respect to and communicatively coupled to individual pieces of equipment. For example, one or more proximity sensors or detectors can be positioned just upstream of the sauce dispenser(s), to provide a signal indicative of a passage of flatten dough 202a. Based on a known distance between the proximity sensor or detector and the sauce dispenser 130 and based on a known or measured speed of the first or primary assembly conveyor 122a, a processor-based system can determine when the flatten dough 202a will be aligned with the sauce dispenser 130, and trigger the dispensing of sauce on the flatten dough 202a. Likewise, other proximity sensors or detectors can be positioned just upstream or downstream of other pieces of equipment. For example, the proximity sensors or detectors can be positioned at the beginning of the primary assembly conveyor 122a a round of dough or flatten dough 202a is initially loaded. The signals of the proximity sensors or detectors can be used to confirm that the round of dough or flatten dough 202a was properly loaded proximate the center of the width of the primary assembly conveyor 122a. In some implementations, the proximity sensors or detectors can be communicatively coupled to control the respective pieces of equipment via the order assembly control systems 106.

The on-demand robotic food assembly line 102 may be used to create par-baked shells 202g that comprise sauced, topped flatten and partially cooked dough that includes no further toppings. Such an on-demand robotic food assembly line 102 may include one or more sauce dispensers 130, one or more sauce spreader robots 140, and one or more ovens 158a, 158b, each of which operates as described above. In some implementations, the on-demand robotic food assembly line 102 may include only those components needed to produce the par-baked shells 202g without toppings. In some implementations, the on-demand robotic food assembly line 102 may include other components, such as cheese application robots 154 and/or toppings application robots 156, that the materials to be made into a par-baked shell 202g may by-pass (e.g., by traveling on a separate by-pass conveyor to these workstations, or by passing under the workstations without having any cheese or other toppings dispensed). In some applications, the speed of the conveyors 122 may vary based on the food item 202 being transported. For example, par-baked shells 202g may be transported along conveyors 122 traveling at a relatively high speed, whereas sauced, cheesed dough 202d that has topping may be transported along conveyors 122 traveling at a relatively slow speed to prevent the toppings and/or cheese from flying off. Each type of pizza may have a “line speed” that represents the maximum speed that the assembly conveyor 122 may travel when transporting that type of pizza. In some applications, the speed of each assembly conveyor 122 may be no greater than the slowest “line speed” for each pizza or other food item currently on that conveyor 122. In some instances, the speed of the assembly conveyors 122 may vary based upon the loading or transfer time, for example, of the first transfer conveyor 162a, second transfer conveyor 162b, and/or the loading robots 192.

The on-demand robotic food assembly line 102 may include one or more loading robots 192, as described above, that may load the resulting par-baked shells 202g into a speed rack 201. The speed rack 201 may include a plurality of slots 201a arranged along multiple columns and rows, each of which is sized and shaped to hold a par-baked shell 202g. In some implementations, the speed rack 201 may be a refrigerated enclosure such that the par-baked shells 202g, or other items loaded into each of the slots, are kept refrigerated to thereby preserve the freshness and extend the shelf-life of the par-baked shells 202g. In some implementations, the speed rack 201 may have wheels or casters, to enable the speed rack 201 to be loaded into a vehicle (not shown), for further processing and dispatch to delivery destinations. The wheels may optionally be driven by one or more electric motors via one or more drive trains.

In some implementations, the par-baked shells 202g may be retrieved from the speed rack 201 to proceed a second time through the on-demand robotic food assembly line 102. The previously processed par-baked shells 202g can be re-sauced, topped with fresh cheese and other toppings, and placed on a by-pass conveyor 160c to by-pass the ovens 158a, 158b and the par-bake process. The par-baked shells 202g with fresh toppings may be placed on the second or secondary assembly conveyors 122b to be sliced by the cutter robots 178 and/or packaged by the packaging robot 170.

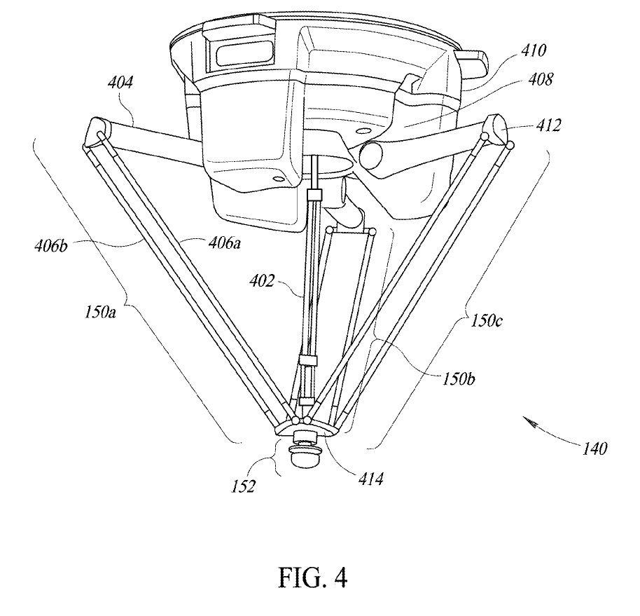

FIG. 4 shows the sauce spreader robot 140, according to at least one illustrated embodiment. The sauce spreader robot 140 includes one or more appendages or arms 150a, 150b, 150c (three shown), a rotatable drive linkage 402, and a sauce spreader end effector or end of arm tool 152. The appendages or arms 150, rotatable drive linkage 402, and a sauce spreader end effector or end of arm tool 152 are operable to spread sauce around the flatten round of dough.

The appendages or arms 150a, 150b, 150c may each comprise a multi-bar linkage that includes a driven member 404 (only one called out) and a pair of arms 406a, 406b (only one pair called out, collectively 406). A proximate end 408 of the driven member 404 is pivotally coupled to a base or housing 410, and driven by an electric motor (not shown), for example a stepper motor. The pair of arms 406 is pivotally coupled to a distal end 412 of the driven member 404, and pivotally coupled to a common plate 414. Each appendage or arm 150a, 150b, 150c may be driven by a respective motor (not shown), the motors controlled via controller hardware circuitry (e.g., programmable logic controller or PLC).

The sauce spreader end effector or end of arm tool 152 is coupled to the common plate 414, and to the rotatable drive linkage 402. Movement of the one or more appendages or arms 150a, 150b, 150c (three shown) cause the common plate 414, and hence the sauce spreader end effector or end of arm tool 152 to trace a desired pattern in space. Rotation of the rotatable drive linkage 402 causes the sauce spreader end effector or end of arm tool 152 to rotate or spin about a longitudinal axis. Thus, the sauce spreader end effector or end of arm tool 152 may rotate or spin, while the appendages or arms 150 moves the sauce spreader end effector or end of arm tool 152 in defined patterns in space, to replicate the manual application of sauce to flatten dough via a bottom of a ladle.

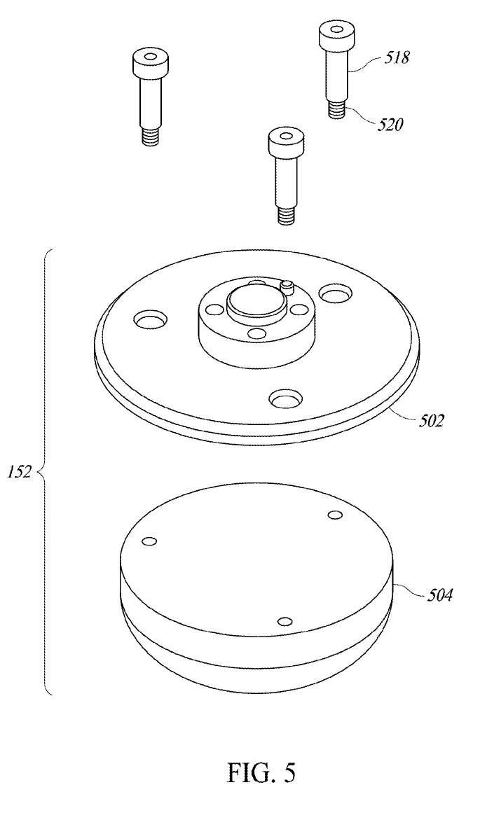

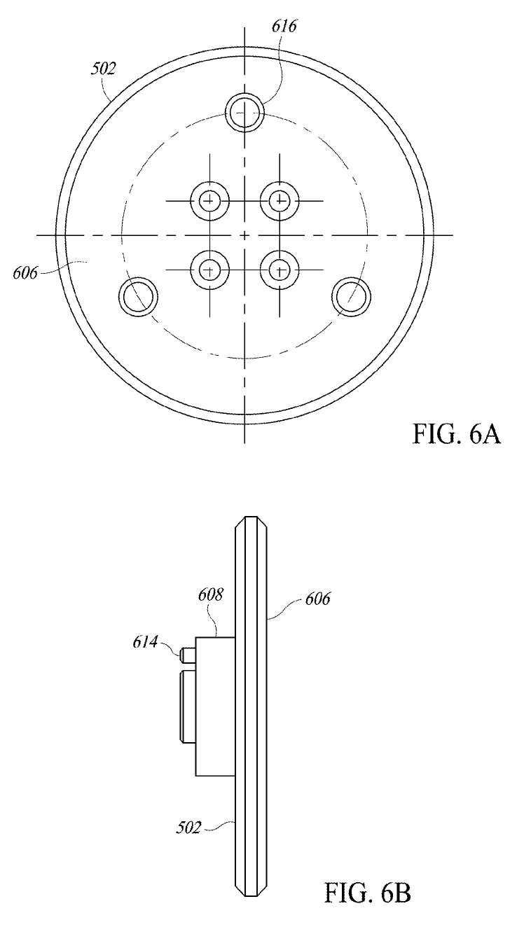

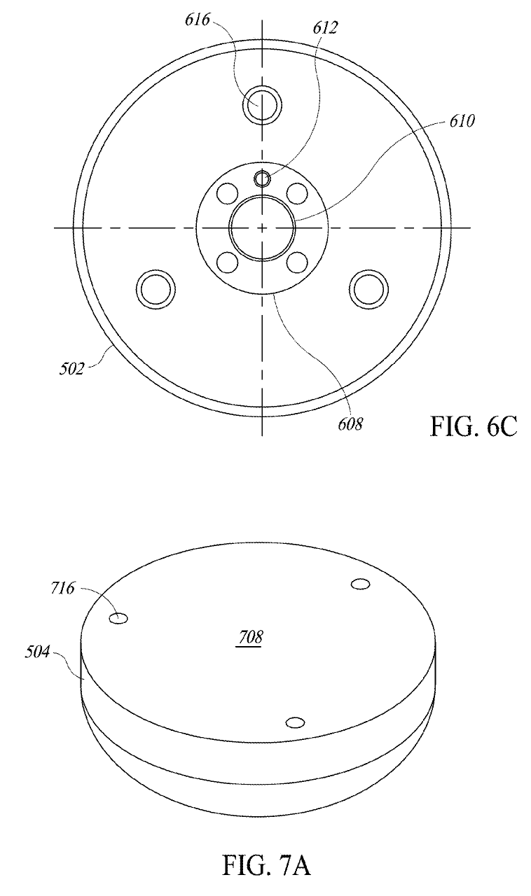

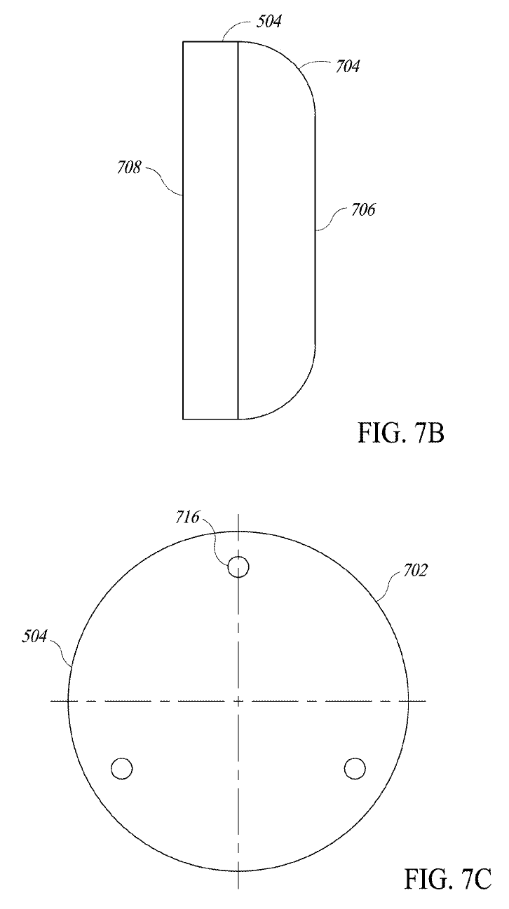

FIGS. 5, 6A, 6B, 6C, 7A, 7B, and 7C show the sauce spreader end effector or end of arm tool 152, according to at least one illustrated implementation. In particular, FIG. 5 shows both a coupler 502 and a contact portion 504 of the sauce spreader end effector or end of arm tool 152. FIGS. 6A, 6B, and 6C show the coupler, while FIGS. 7A, 7B, and 7C show the contact portion.

As best illustrated in FIGS. 6A, 6B, and 6C, the coupler 502 can take the form of a disk with a substantially flat mating side or face 606 on which the contact portion is selectively removably attached, and with an attachment neck 608 to selectively removable attach the rotatable drive linkage 402. In particular, the attachment neck 608 may include a receptacle 610 sized and dimensioned to receive a distal end of the rotatable drive linkage 402, which extends through the common plate 414. The attachment neck 508 may also include a recess 612, offset from a longitudinal axis of the coupler 502, and sized and dimensioned to receive a pin or dowel 614 (FIG. 6B). Such ensures that the coupler 502, and hence the contact portion 504, spins with the rotatable drive linkage 402. The coupler 502 may be made of food grade material, for instance stainless steel, or alternatively a food grade polymer.

As best illustrated in FIGS. 7A, 7B and 7C, the contact portion 504 may be made of food grade material, for instance a food grade polymer, or alternatively stainless steel. The contact portion 504 can take the form of a disk or puck. The disk or puck may have a circular or oval top plan profile 702 (FIG. 6C), with a curved edge or perimeter 704 (FIG. 6B) when viewed in a side elevational view. The contact portion 504 can have a substantially flat distal or contact surface 706 (FIG. 6B), or may have a more hemispherical shape, similar or identical to that of a bottom of a ladle. The contact portion 504 has a substantially flat mating face 708 (FIGS. 6B, 6C), to mate with the mating face 606 (FIG. 7B) of the coupler 502.

The coupler 502 and the contact portion 504 may have a number of holes 616, 716 (only one of each called out in FIGS. 6A, 6B, 7A, 7C) to receive fasteners 518 (only one called out, FIG. 5) to removably fasten the contact portion 504 to the coupler 502. The holes 616 in the coupler 502 may be throughholes, while the holes 716 of the contact portion 504 may not extend through the entire thickness of the contact portion 504. The holes 716 in the contact portion may include an internal thread, sized and dimensioned to receive an external thread 520 of the fasteners 518. Alternatively, nuts and bolts may be employed to removably fasten the contact portion 504 to the coupler 502.

The sauce spreader robot 140 can be controlled using various machine-vision techniques (e.g., blob analysis) to detect the position and shape of the dough and/or to detect the position and shape of the sauce on the dough 202b (FIG. 2). One or more processors generate control signals based on the images to cause the appendages or arms 150 to move in defined patterns (e.g., spiral patterns) to cause the sauce spreader end effector or end of arm tool 152 to spread the sauce evenly over the flatten round of dough while leaving a sufficient border proximate a perimeter of the flatten dough without sauce 202c (FIG. 2).

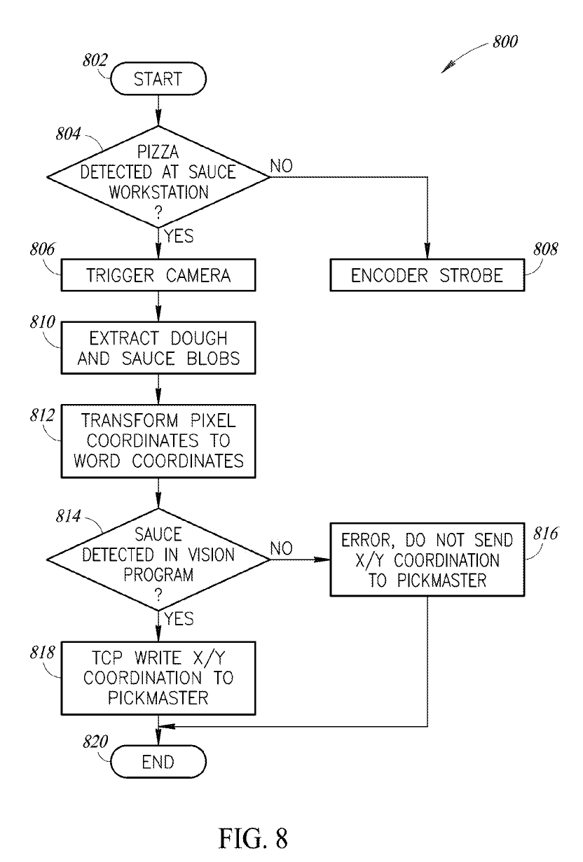

FIG. 8 shows a method 800 of operation for a sauce spreader robot 140, according to one illustrated implementation. The method is executable by hardware circuitry, for example a processor-based control system or PLC. Logic may be hardwired in the circuitry or stored as processor-executable instructions in one or more non-transitory processor-readable media.

The method 800 starts at 802. The method 800 may, for example, start on powering up of the sauce spreader robot 140 or on invocation of the method 800 from an calling routine.

At 804, a controller determines whether an object, e.g., round of flatten dough 202 (FIG. 2) is detected, for example detected at or proximate the sauce dispenser 130 or elsewhere upstream of the sauce spreader robot 140 in the workflow or assembly line. In response to detection, a controller triggers an image sensor, e.g., digital camera, to capture an image of the object at 806. In response to detection, the controller may optionally trigger an illumination source at 808, for example triggering a strobe light to illuminate the object.

At 810, the processor extracts first and second blob representations, representing the dough and the sauce, respectively. The processor can employ various machine-vision techniques and packages to extract the blog representations. The processor can determine a centroid of a blob that represents the sauce and/or determine a centroid of a blob that represents the flatten dough on which the sauce is carried.

At 812, the processor transforms the pixel coordinates of the first and second blobs into “real” world coordinates, that is coordinates of the assembly line and/or coordinates of the sauce spreader robot 140.

At 814, the processor determines whether sauce is detected. If sauce is not detected, such may be considered a mistake or error, and control passes to an error routine 816 which skips any attempt as spreading the unintentionally missing sauce. In some instances, omission of sauce may have been intentional, yet there is still no need to attempt to spread the intentionally missing sauce.

At 818, the processor determines a pattern to spread the sauce, sending resulting coordinates to drive the sauce spreader robot 140. For example, the processor may determine a starting position for the end effector or end of arm tool. The starting position may, for example, correspond or be coincident with the determined centroid of the blob that represents the sauce. Also for example, the processor may determine an ending position for the end effector or end of arm tool. The ending position may, for example, correspond or be coincident, adjacent to, or spaced from an outer edge or periphery of the blob that represents the flatten dough. Also for example, the processor may determine a path that extends from the starting position to the ending position, preferably a spiral or volute path, which extends radially outward as the end effector or end of arm tool moves about the centroid of the blob that represents the sauce.

The processor may calculate a pattern or path that spreads the sauce somewhat evenly, but not perfectly about the flatten dough, to create an “artisanal” look or effect. In fact, it may be desirable if the flatten dough is not perfectly round. In some implementations, the system can employ machine-learning techniques to develop various desired distribution or assembly patterns. For example, machine learning can be employed to develop or formulate sauce spreading patterns or paths for the sauce spreader robot 140. Additionally or alternatively, machine learning can be employed to develop or formulate cheese spreading patterns or paths for the cheese robot 154 and/or toppings robot 156. For example, the system or a machine-learning system can be supplied with images of desired or desirable patterns of sauce on flatten pieces of dough or even of pizzas. Additionally or alternatively, the system can be provided with ratings input that represents subjective evaluation of pizzas made via various patterns or paths. Additionally or alternatively, the machine-learning system can be supplied with a number of rules, for example that a pattern or path should result in an equal or roughly equal distribution of sauce, cheese, or other toppings across a surface of the food item (e.g., whole pizza pie). Additionally or alternatively, the machine-learning system can be supplied with a number of rules, for example each individual portion (e.g., slice) of the food item (e.g., pizza) should have an equal or roughly equal distribution of sauce, cheese, or other toppings as every other portion (e.g., slice) of the food item (e.g., pizza). The images and/or ratings and/or rules can be used as training data for training the machine-learning system during a training period or training time. The system can use the trained examples during operation or runtime to produce patterns and paths based on blob analysis to achieve a desired distribution of sauce, cheese, and/or toppings for any given instance of pizza or other food item. Various patterns or paths can specify movement of an appendage of a robot and/or other portions of the robots, for example rotation or pivoting of a torso, or even translation or rotation of the entire robot where the robot includes wheels or treads.

The method 800 terminates at 820, for example until invoked again. In some implementations, the method 800 repeats as long as the assembly line is in a powered ON state.

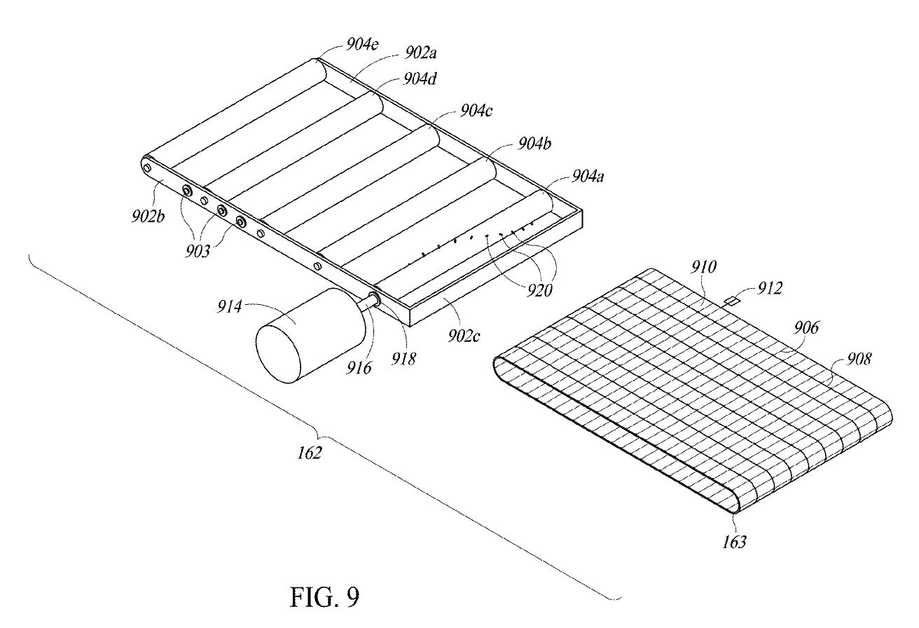

FIG. 9 shows a transfer conveyor 162, according to one illustrated implementation. The transfer conveyor 162 can serve as either the first and/or the second transfer conveyors 162a, 162b.

The transfer conveyor 162 can include a frame 902a, 902b, 902c (collectively 902), with one or more rollers 904a-904e (five shown in FIG. 9, collectively 904) which span a width of the frame 902, and a grill or rack 163. The frame 902 may include a plurality of mounts 903 that allow the frame 902 to be physically mounted or coupled to an appendage of a robot as an end effector or end of arm tool. The mounts 903 are preferably positioned laterally with respect to a direction of travel of the grill or rack 163, as to avoid interference by the appendage of a robot with other conveyors or other equipment.

The frame 902 and rollers 904 should be sufficiently strong to support the weight and acceleration forces expected for the particular application (e.g., moving pizzas). While not illustrated, the frame 902 can include cross-brace bars or wires to enhance structure rigidity. The frame 902 and rollers 904 are preferably made of a food grade material and/or easily cleanable material. For example, the frame 902 may be made of stainless steel. Also for example, the rollers 904 may be made of either stainless steel or a food grade polymer, or the rollers 904 may have a food grade material outer liner overlying a non-food grade material.

The transfer conveyor 162 can include can include a grill or rack 163 (shown in FIG. 9 as removed from the frame 902 and rollers 904 to better illustrate the transfer conveyor 162). Alternatively, the transfer conveyor 162 can include chains or a belt, for example a food grade polymer belt. The grill or rack 163 can take the form of a closed or endless grill or rack 163 as illustrated in FIG. 9. The grill or rack 163 is preferably made of a food grade material and/or easily cleanable material. The grill or rack 163 may, for example, be made of stainless steel.

The grill or rack 163 can include a plurality of laterally extending members 906 (only one called out in FIG. 9) with can take the form of wires or bars, and a number of longitudinally extending members 908 (only one called out in FIG. 9) which can take the form of wires or links. The laterally extending members 906 should be placed sufficiently close together with respect to one another to support uncooked dough during operation of the transfer conveyor 162, without significant drooping or tearing of the uncooked dough.

The grill or rack 163 can include one or more removable or releasable links 910. Removal or release of the releasable link(s) 910 uncouples one end of the otherwise endless grill or rack 163 from another end of the grill or rack 163, to allow easy removal of the grill or rack 163 from the rollers 904 and frame 902. This facilitates cleaning. The grill or rack 163 can, for example, be removed from the rollers 904 and frame 902, and placed in a dishwasher. The releasable link(s) 910 can include a fastener (e.g., nut, cam lock, cotter pin) 912 (only one called out in FIG. 9) to secure the grill or rack 163 in the endless configuration during use, yet allow easy removable for cleaning and/or servicing.

The transfer conveyor 162 can include a motor, for example an electric stepper motor 914. The motor 914 has a drive shaft 916 that is coupled to drive at least one of the rollers 904, for example a driven roller 904a. In some implementations, the drive shaft 916 may be drivingly coupled to the driven roller 904a via a D-shaped coupling in which the drive shaft 916 has a D-shaped shaft that couples with a corresponding D-shaped cavity located within the driven roller 904a. In some implementations, the drive shaft 916 may be drivingly coupled with the driven roller 904a via one or more gears or sprockets. Such gears or sprockets may be used to selectively couple or uncouple the drive shaft 916 to the driven roller 904a. The frame 902 may carry one or more bushings 918 to support the drive shaft 916. The driven roller 904a may include a plurality of teeth 920 (only three called out in FIG. 9), the teeth 920 sized and dimensioned to drivingly engage the grill or rack 163 to cause the grill or rack 163 to rotate about the rollers 904 with respect to the frame 902.

The electric motor 914 that can preferably selectively drive the grill or rack 163 in two directions (e.g., clockwise, counterclockwise). The electric motor 914 that can preferably selectively drive the grill or rack 163 in and at a variety of speeds, in either direction.

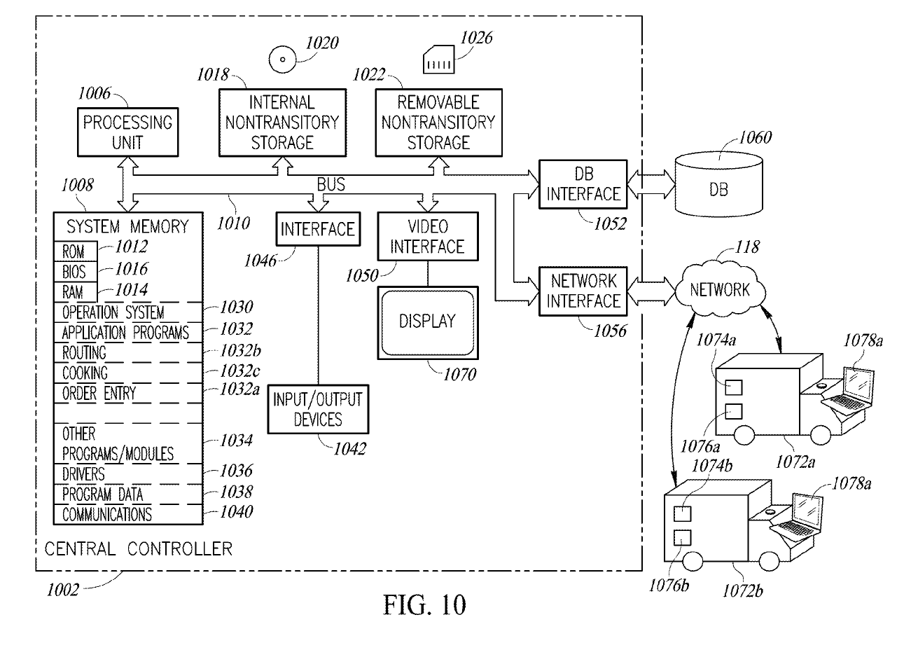

FIG. 10 and the following discussion provide a brief, general description of an exemplary central controller 1002 that may be used to implement any one or more of the processor-based control systems 104, 106, 108 (FIG. 1).

Although the order front end server computer control system(s) 104, the order assembly control system(s) 106, the order dispatch and en route cooking control systems 108, the on-board processor-based routing module 1074, and the on-board processor-based cooking module 1076 are described herein as functional elements of a central controller 1002, one of ordinary skill in the art would readily appreciate that some or all of the functionality may be performed using one or more additional computing devices which may be external to the central controller 1002. For example, the order front end server computer control system(s) 104 may be disposed in a national or regional call or order aggregation center that is remote from the order assembly control system(s) 106 and/or remote from the order dispatch and en route cooking control systems 108. In another example, the on-board processor-based routing module 1074 and/or the on-board processor-based cooking module 1076 may be disposed in some or all of the delivery vehicles 1072. The central controller 1002 may implement some or all of the various functions and operations discussed herein.

Although not required, some portion of the specific implementations will be described in the general context of computer-executable instructions or logic, such as program application modules, objects, or macros being executed by a computer. Those skilled in the relevant art will appreciate that the illustrated embodiments as well as other embodiments can be practiced with other computer system configurations, including handheld devices for instance Web enabled cellular phones or PDAs, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be stored in both local and remote memory storage devices and executed using one or more local or remote processors, microprocessors, digital signal processors, controllers, or combinations thereof.

The central controller 1002 may take the form of any current or future developed computing system capable of executing one or more instruction sets. The central controller 1002 includes a processing unit 1006, a system memory 1008 and a system bus 1010 that communicably couples various system components including the system memory 1008 to the processing unit 1006. The central controller 1002 will at times be referred to in the singular herein, but this is not intended to limit the embodiments to a single system, since in certain embodiments, there will be more than one system or other networked computing device involved. Non-limiting examples of commercially available systems include, but are not limited to, an Atom, Pentium, or 80x86 architecture microprocessor as offered by Intel Corporation, a Snapdragon processor as offered by Qualcomm, Inc., a PowerPC microprocessor as offered by IBM, a Sparc microprocessor as offered by Sun Microsystems, Inc., a PA-RISC series microprocessor as offered by Hewlett-Packard Company, an A6 or A8 series processor as offered by Apple Inc., or a 68xxx series microprocessor as offered by Motorola Corporation.

The processing unit 1006 may be any logic processing unit, such as one or more central processing units (CPUs), microprocessors, digital signal processors (DSPs), application-specific integrated circuits (ASICs), field programmable gate arrays (FPGAs), programmable logic controllers (PLCs), etc. Unless described otherwise, the construction and operation of the various blocks shown in FIG. 10 are of conventional design. As a result, such blocks need not be described in further detail herein, as they will be understood by those skilled in the relevant art.

The system bus 1010 can employ any known bus structures or architectures, including a memory bus with memory controller, a peripheral bus, and a local bus. The system memory 1008 includes read-only memory (“ROM”) 1012 and random access memory (“RAM”) 1014. A basic input/output system (“BIOS”) 1016, which can form part of the ROM 1012, contains basic routines that help transfer information between elements within the central controller 1002, such as during start-up. Some embodiments may employ separate buses for data, instructions and power.

The central controller 1002 also includes one or more internal nontransitory storage systems 1018. Such internal nontransitory storage systems 1018 may include, but are not limited to, any current or future developed persistent storage device 1020. Such persistent storage devices 1020 may include, without limitation, magnetic storage devices such as hard disc drives, electromagnetic storage devices such as memristors, molecular storage devices, quantum storage devices, electrostatic storage devices such as solid state drives, and the like.

The central controller 1002 may also include one or more optional removable nontransitory storage systems 1022. Such removable nontransitory storage systems 1022 may include, but are not limited to, any current or future developed removable persistent storage device 1026. Such removable persistent storage devices 1026 may include, without limitation, magnetic storage devices, electromagnetic storage devices such as memristors, molecular storage devices, quantum storage devices, and electrostatic storage devices such as secure digital (“SD”) drives, USB drives, memory sticks, or the like.

The one or more internal nontransitory storage systems 1018 and the one or more optional removable nontransitory storage systems 1022 communicate with the processing unit 1006 via the system bus 1010. The one or more internal nontransitory storage systems 1018 and the one or more optional removable nontransitory storage systems 1022 may include interfaces or device controllers (not shown) communicably coupled between nontransitory storage system and the system bus 1010, as is known by those skilled in the relevant art. The nontransitory storage systems 1018, 1022, and their associated storage devices 1020, 1026 provide nonvolatile storage of computer-readable instructions, data structures, program modules and other data for the central controller 1002. Those skilled in the relevant art will appreciate that other types of storage devices may be employed to store digital data accessible by a computer, such as magnetic cassettes, flash memory cards, RAMs, ROMs, smart cards, etc.

Program modules can be stored in the system memory 1008, such as an operating system 1030, one or more application programs 1032, other programs or modules 1034, drivers 1036 and program data 1038.

The application programs 1032 may include, for example, one or more machine executable instruction sets (i.e., order entry module 1032a) capable of receiving and processing food item orders, for example in any form of communication, including without limitation, voice orders, text orders, and digital data orders. The application programs 1032 may additionally include one or more machine executable instruction sets (i.e., routing module 1032b) capable of providing provide routing instructions (e.g., text, voice, and/or graphical routing instructions) to the output devices 1078 in some or all of the delivery vehicles 1072a, 1072b and/or providing positional information or coordinates (e.g., longitude and latitude coordinates) to autonomously operated delivery vehicles 1072. Such a routing machine executable instruction set (i.e., routing module 1032b) may also be executable by one or more controllers in an on-board processor-based routing module 1074a, 1074b installed in some or all of the delivery vehicles 1072a, 1072b. The application programs 1032 may further include one or more machine executable instructions sets (i.e., cooking module 1032c) capable of outputting cooking instructions to the cooking units, e.g., ovens 197 in a cargo compartment of each delivery vehicle 1072a, 1072b.

Such cooking instructions can be determined by the central controller 1002 using any number of inputs including at least, the food type in a particular cooking unit or oven 197 and the available cooking time before each respective food item 202 is delivered to a consumer destination location. Such a cooking module machine executable instruction set may be executed in whole or in part by one or more controllers in the cooking module 1076 installed in some or all of the delivery vehicles 1072. In at least some instances, the routing module 1074 and/or the cooking module 1076 may provide a backup controller in the event central controller 1002 becomes communicably decoupled from the delivery vehicle 1072. In another implementation, the routing module 1074 and/or the cooking module 1076 installed in each delivery vehicle may include nontransitory storage to store routing and delivery itinerary data and cooking data communicated to the respective module by the controller 1002. The application programs 1032 may, for example, be stored as one or more executable instructions.

The system memory 1008 may also include other programs/modules 1034, such as including logic for calibrating and/or otherwise training various aspects of the central controller 1002. The other programs/modules 1034 may additionally include various other logic for performing various other operations and/or tasks.

The system memory 1008 may also include any number of communications programs 1040 to permit the central controller 1002 to access and exchange data with other systems or components, such as with the routing modules 1074, cooking modules 1076, and/or output devices 1078 installed in each of the delivery vehicles 1072.

While shown in FIG. 10 as being stored in the system memory 1008, all or a portion of the operating system 1030, application programs 1032, other programs/modules 1034, drivers 1036, program data 1038 and communications programs 1040 can be stored on the persistent storage device 1020 of the one or more internal nontransitory storage systems 1018 or the removable persistent storage device 1026 of the one or more optional removable nontransitory storage systems 1022.

A user can enter commands and information into the central controller 1002 using one or more input/output (I/O) devices 1042. Such I/O devices 1042 may include any current or future developed input device capable of transforming a user action or a received input signal to a digital input. Example input devices include, but are not limited to, a touchscreen, a physical or virtual keyboard, a microphone, a pointing device, or the like. These and other input devices are connected to the processing unit 1006 through an interface 1046 such as a universal serial bus (“USB”) interface communicably coupled to the system bus 1010, although other interfaces such as a parallel port, a game port or a wireless interface or a serial port may be used. A display 1070 or similar output device is communicably coupled to the system bus 1010 via a video interface 1050, such as a video adapter or graphical processing unit (“GPU”).

In some embodiments, the central controller 1002 operates in an environment using one or more of the network interfaces 1056 to optionally communicably couple to one or more remote computers, servers, display devices 1078 and/or other devices via one or more communications channels, for example, one or more networks such as the network 118, 120. These logical connections may facilitate any known method of permitting computers to communicate, such as through one or more LANs and/or WANs. Such networking environments are well known in wired and wireless enterprise-wide computer networks, intranets, extranets, and the Internet.

Further, the database interface 1052, which is communicably coupled to the system bus 1010, may be used for establishing communications with a database stored on one or more computer-readable media 1060. For example, such a database 1060 may include a repository for storing information regarding food item cooking conditions as a function of time, etc.

### Description of Operation

The on-demand robotic food assembly line environment 100 includes, for example, one or more order front end server computer control systems 104, one or more order assembly control systems 106, one or more on-demand robotic food assembly lines 102 portions of which are communicably coupled to the at least one order assembly control system(s) 106 via a network 120, and one or more order dispatch and en route cooking control system 108 communicably coupled to the order front end server computer control system(s) 104 and/or to the order assembly control system(s) 106 via a network 120. In at least some implementations, a rack 199 can be used to transfer cooking units, e.g., ovens 197, containing prepared or partially prepared food items between the on-demand robotic food assembly lines 102 and a delivery vehicle 1072a, 1072b (FIG. 10, two shown, collectively 1072). Each delivery vehicle 1072 can have an on-board processor-based routing module 1074a, 1074b (FIG. 10, two shown, collectively 1074) and an on-board processor-based cooking module 1076a, 1076b (FIG. 10, two shown, collectively 1076), communicably coupled to each other and communicably coupled to the order dispatch and en route cooking control systems 108. Although illustrated or described as discrete components, some or all of the functions performed by the order front end server computer control system 104, order assembly control systems 106, order dispatch and en route cooking control systems 108, routing module 1074, and cooking module 1076 may be shared between or combined and performed by another system component. For example, the order assembly control system 106 may perform various order entry functions rather than a dedicated the order front end server computer control systems 104.

The order front end server computer control system(s) 104 can include one or more systems or devices used to coordinate the receipt or generation of food item orders. In at least some instances, the order front end server computer control system(s) 104 can receive food orders placed by consumers using any number or variety of sources. In some instances, the order front end server computer control system(s) 104 may include a telephonic interface to conventional or voice over Internet Protocol (VoIP) telephonic equipment. Such telephonic interfaces may be in the form of automated or semi-automated interfaces where the consumer enters data by entering a defined key sequence corresponding to a desired food product, destination address, delivery time, etc. Some telephonic interfaces may include an attendant operated interface where the consumer places a verbal order with the attendant who then enters data corresponding to a desired food product, destination address, delivery time, etc. into the order front end server computer control systems 104, for example using a touchscreen or keyboard entry device. In some instances, the order front end server computer control systems 104 may include a network interface, for example a network interface communicably coupled to the Internet, over which orders may be placed via smartphone 110b (FIG. 1), or via any type of computing device 110a, 100c (FIG. 1). In such instances, order information corresponding to a desired food item, destination address, delivery time, and the like may be provided by the consumer in a format requiring minimal or no reformatting by the order front end server computer control systems 104.

In various implementations, in addition to receiving consumer orders via telephone, smartphone 110b, or computer 110a, 110c, the order front end server computer control systems 104 can do more than simply aggregate received consumer food item orders. For example, the order front end server computer control systems 104 may include one or more machine learning or similar algorithms useful for predicting the demand for certain food items. For example, the order front end server computer control systems 104 may include one or more machine learning algorithms able to correlate or otherwise logically associate the ordering of a number of particular food items (e.g., pepperoni pizzas) in a constrained geographic area (e.g., a college campus) over the course of a defined temporal period (e.g., Friday evenings between 9:00 PM and 12:00 AM) or during one or more defined events (e.g., during a football or basketball game in which the college is represented). In such instances, the order front end server computer control systems 104 may autonomously generate orders for production of the particular food items in anticipation of orders that will be, but have not yet, been received.

In at least some instances, the order front end server computer control systems 104 can provide the consumer placing an order for a food item with an estimated delivery time for the item. In at least some instances, the estimated delivery time may be based on the time to produce the food item in the production module plus the estimated time to cook the food item in transit by the order dispatch and en route cooking control systems 108. Such estimated delivery times may take into account factors such as the complexity of preparation and the time required for the desired or defined cooking process associated with the ordered food item. Such estimated delivery times may also take into account factors such as road congestion, traffic, time of day, and other factors affecting the delivery of the food item by the order dispatch and en route cooking control systems 108. In other instances, the estimated delivery time may reflect the availability of the ordered food item on a delivery vehicle that has been pre-staged in a particular area.

The order assembly control system(s) 106 can schedule the production of food items by the on-demand robotic food assembly line 102 in accordance with the received or generated orders, estimated assembly and estimated transit time to destination using real time or expected transit conditions. The order assembly control system(s) 106 can generate and update a fulfillment queue to schedule the production based at least in part on the estimated assembly and estimated transit time to destination and the time that the order was received. Thus, order assembly control system(s) 106 may place some orders in the fulfillment queue in a different order than received, for example placing orders with relatively longer transit times ahead of orders that were received earlier but which have relatively shorter transit times. The order assembly control system(s) 106 can dynamically revise the fulfillment queue based on real time or estimated conditions and based on demand and/or timing of receipt of various orders.

In some instances, the order assembly control systems 106 may be collocated with or even incorporated into the on-demand robotic food assembly lines 102. Responsive to receipt of one or more outputs provided by the order assembly control systems 106, food items are prepared or assembled by the on-demand robotic food assembly line 102. In at least some instances, the on-demand robotic food assembly line 102 may autonomously perform the preparation or assembly of at least a portion of the uncooked food products at the direction of the order assembly control systems 106. For example, crust dough may be kneaded and formed, sauce deposited and spread and cheese and pepperoni placed on top of the sauce using one or more automated or semi-automated systems upon receipt or generation of food item order data indicative of a pepperoni pizza by the order assembly control systems 106. Each of the prepared or assembled food items provided by the on-demand robotic food assembly line 102 can be loaded or otherwise placed into one or more cooking units, e.g., ovens 197 (FIGS. 1 and 2). The cooking units can then be placed into a cooking rack 199 (FIG. 2) to transfer the prepared or assembled food items from the on-demand robotic food assembly line 102 to the delivery vehicle 1072 (FIG. 10).

In some instances, the order assembly control systems 106 may track information related to the contents of each oven 197 and/or speed rack 201. For example, the order assembly control systems 106 may track for each oven 197 and/or slot in the speed rack 201 the type of food item (e.g., par-baked shell, pepperoni pizza, etc.), the size of the food item, and/or the time that the food item was placed in the speed rack 201 or oven 197. In some instances, the order assembly control system 106 may set a time limit for keeping each food item within the speed rack 201 or oven 197. If the time limit expires for one of the food items, the order assembly control system 106 may alert a user to discard the food item. The order assembly control system 106 may require that the user provide an input to confirm that the identified food item has been discarded. Such input may include, for example, pressing a switch associated with the oven 197 containing the food item to be discarded or acknowledging a prompt on a computer screen. In some implementations, the order assembly control system 106 may include one or more sensors or imagers that may indicate that the user has removed the identified food item. Such sensors may include, for example, one or more imagers (e.g. cameras) that may be used to visually confirm that the oven 197 is empty and/or that the food item has been placed in a waste basket. Such sensors may include one or more sensors on the oven door that can detect when the door to the oven 197 has been opened. In some instances, the order assembly control system 106 may automatically discard food items for which the associated time limit has expired.

In some instances, the order assembly control systems 106 may be a portion of or may be communicably coupled to an inventory control or enterprise business system such that the inventory of food ingredients and other items is maintained at one or more defined levels within the on-demand robotic food assembly line(s) 102. In some instances, where the order assembly control system 106 and the on-demand robotic food assembly line(s) 102 are discrete entities, the network 120 (FIG. 1) communicably coupling the order assembly control systems 106 to the on-demand robotic food assembly line(s) 102 can be a wired network, a wireless network, or any combination thereof. The network 120 can include a Local Area Network (LAN), a Wide Area Network (WAN), a worldwide network, a private network, a corporate intranet, a worldwide public network such as the Internet, or any combination thereof. In at least some instances, all or a portion of the order front end server computer control system(s) 104 and/or order assembly control system(s) 106 can be located remote from the on-demand robotic food assembly line(s) 102, for example in a corporate server, or in a network connected or “cloud” based server.

In some instances, the order assembly control systems 106 may track the assembly and progress of each food item 202 that progresses through the on-demand robotic food assembly line(s) 102. Positioning information may be calculated, for example, by monitoring the speed of each of the conveyors 122a after the round of dough or flatten dough 202a is loaded at the beginning of the first or primary assembly conveyor 122a. One or more sensors or imagers (e.g., cameras) 142 may be positioned along the path of the conveyors 122, including the cooking conveyors 160a, 160b, and the by-pass conveyors 160c, to confirm that the positioning information is correct. In some implementations, an edible RFID tag or other edible device may be incorporated into each round of dough or flatten dough 202a to provide tracking capabilities and positioning information for each food item 202 traveling along the on-demand robotic food assembly line(s) 102. In some instances, the order assembly control systems 106 may label the packaging 176 with identifying information after the completed food item 202 has been loaded into the packaging 176. Such information may include human-readable symbols and/or machine-readable symbols (e.g., barcodes, QR codes, and/or RFID tags). Such labels may include other information, such as the time the food item 202 was placed in the oven 197, driver, destination, order number, and the cooking temperature information for the food item 202 included in the packaging 176. The order assembly control systems 106 may associate this uniquely identifying information for the packaging 176 may be associated with the specific rack or oven 197 into which the packaging 176 is loaded.

In some instances, the order assembly control systems 106 may track the use of par-baked pizza 202g through the on-demand robotic food assembly line(s) 102. As such, the order assembly control systems 106 may store information regarding the number and location of par-baked shells 202g stored within various racks 199. The order assembly control systems 106 may track the progress of the par-baked shells 202g through the various conveyors 122, including the cooking conveyors 160a, 160b and the by-pass conveyors 160c.

The cooking units, e.g., ovens 197 (FIGS. 1 and 2), containing the prepared, uncooked or partially cooked, food items can be placed in a rack 199 (FIG. 2), also denominated as a “cooking rack.” The rack 199 can include various components or systems to support the operation of the cooking units contained in the rack 199, for example a power distribution bus, a communications bus, and the like. Power and cooking condition instructions are supplied to the cooking units either individually or via the power distribution and communications buses in the rack 199.

Cooking conditions within each of the cooking units, e.g., ovens 197 (FIGS. 1 and 2), are controlled en route to the consumer destination such that the food in the cooking unit is cooked shortly prior to or upon arrival at the consumer destination. In at least some instances, the order dispatch and en route cooking control systems 108 can communicate via network 118 with the on-board processor-based cooking module 1076 (FIG. 10) to control some or all cooking conditions and cooking functions in each of the cooking units. In some instances, the order dispatch and en route cooking control systems 108 can also determine an optimal delivery itinerary, estimated delivery times, and available cooking times for each cooking unit. In other instances an on-board processor-based routing module 1074 (FIG. 10) communicably coupled to the order dispatch and en route cooking control system(s) 108 can provide some or all of the delivery routing instructions, including static or dynamic delivery itinerary preparation and time of arrival estimates that are used to determine the available cooking time and to control or otherwise adjust cooking conditions within the cooking units. In some instances, an on-board processor-based cooking module 1076 (FIG. 10) communicably coupled to the rack 199 or vehicle (not shown) can provide some or all of the adjustments to cooking conditions within the cooking units such that the food items in each of the respective cooking units are cooked shortly before arrival at the consumer destination. In at least some instances, the order dispatch and en route cooking control system(s) 108 (FIG. 1) may use data provided by the routing on-board processor-based cooking module 1076 (FIG. 10) to determine cooking conditions within some or all of the cooking units. In yet other instances, standalone loop controllers may be located within each cooking unit to control some or all functions including power delivery and/or cooking conditions in the respective cooking unit.

In some instances, the order dispatch and en route cooking control systems 108 may track information related to the contents of each oven 197 and/or speed rack 201 that has been loaded into a delivery vehicle 1072. For example, the order dispatch and en route cooking control systems 108 may track for each oven 197 and/or slot in the speed rack 201 the type of food item (e.g., par-baked shell, pepperoni pizza, etc.), the size of the food item, and/or the time that the food item was placed in the speed rack 201 or oven 197. In some instances, order dispatch and en route cooking control systems 108 may communicate with one or more other systems, such as the order assembly control system 106, to determine the overall time that a food item has been placed in the speed rack 201 or oven 197, including time before the speed rack 201 or oven 197 was loaded into the delivery vehicle 1072. The order dispatch and en route cooking control systems 108 may set a time limit for keeping each food item within the speed rack 201 or oven 197. If the time limit expires for one of the food items, the order dispatch and en route cooking control systems 108 may alert a user to discard the food item. The order dispatch and en route cooking control systems 108 may require that the user provide an input to confirm that the identified food item has been discarded. Such input may include, for example, pressing a switch associated with the oven 197 containing the food item to be discarded or acknowledging a prompt on a computer screen. In some implementations, the order dispatch and en route cooking control systems 108 may include one or more sensors or imagers that may indicate that the user has removed the identified food item. Such sensors may include, for example, one or more images (e.g. cameras) that may be used to visually confirm that the oven 197 is empty and/or that the food item has been placed in a waste basket. Such sensors may include sensors on the oven door that can detect when the door to the oven 197 has been opened. In some instances, the order dispatch and en route cooking control systems 108 may automatically discard food items for which the associated time limit has expired.

In at least some instances, the location of each cooking unit or rack 199 or delivery vehicle 1072 (FIG. 10) may be monitored using geolocation information. Such geolocation information may be determined through the use of time-of-flight triangulation performed by the order dispatch and en route cooking control systems 108 and/or on-board processor-based routing module 1074a, 1074b (FIG. 10). Such geolocation information may be determined using one or more global positioning technologies, for example the Global Positioning System (GPS) or similar. The order dispatch and en route cooking control systems 108, the on-board processor-based routing module 1074a, 1074b (FIG. 10), and/or the on-board processor-based cooking module 1076 (FIG. 10) may use the location information to statically or dynamically create and/or update delivery itinerary information and estimated time of arrival information for each consumer destination. The order dispatch and en route cooking control system(s) 108 and/or the on-board processor-based cooking module 1076 (FIG. 10) may use such information to control or otherwise adjust the cooking conditions in some or all of the cooking units, e.g., ovens 197. In at least some instances, all or a portion of the determined geolocation information associated with a consumer's food item(s) may be provided to the consumer, for example via a Website, computer program, or smartphone application. The order dispatch and en route cooking control systems 108 can generate a manifest or itinerary for each delivery vehicle 1072. The order dispatch and en route cooking control systems 108 can dynamically update the manifest or itinerary for each delivery vehicle 1072, for example based on real-time traffic conditions. Upon delivery, the driver or other operator may scan the machine-readable symbol attached to the package 176 to confirm delivery using the order dispatch and en route cooking control systems 108.

The approach described herein advantageously and significantly reduces the time required for delivery of prepared food items to consumer destinations by cooking or completing the cooking of food items within cooking units. For example, the cooking of food items can be completed using individually controllable cooking units, e.g., ovens 197, on a delivery vehicle 1072 (FIG. 10) instead of a more conventional stationary cooking unit such as a range or oven located in a “bricks and mortar” facility. By moving at least a portion of the cooking process to vehicle (not shown), the overall time required to prepare, cook, and deliver food items to a consumer location is reduced and the overall quality of the delivered food items is improved. Significantly, the time for delivery and quality of delivered food is improved over current systems in which food items are cooked in a central location and then loaded onto a delivery vehicle 1072 (FIG. 10) for delivery to the consumer location. Even more advantageously, by dynamically adjusting the delivery itinerary and controlling the cooking conditions within the cooking units to reflect the updated expected arrival times at the consumer locations, the impact of unanticipated traffic and congestion on the quality of the delivered food items is beneficially reduced or even eliminated.

As depicted and described, food items 202 (FIG. 2) are prepared by on-demand robotic food assembly line 102 (FIG. 2), using equipment that includes various conveyors and robots. The food items 202 are loaded into cooking units, e.g., ovens 197 (FIGS. 1 and 2), which can be placed in racks 199 (FIG. 2). The racks 199, each containing one or more individual cooking units, are loaded in delivery vehicles 1072 (FIG. 10). While in transit to each of a number of consumer delivery locations, the cooking conditions within each of the cooking units are adjusted to complete the cooking process shortly before delivery of the food items 202 to the consumer.

After the food item 202 is placed in the packaging 176, 190 (FIG. 2), the transport container is prepared for delivery to the consumer. Beneficially, the cooking and loading of the food item 202 into the package 176, 190 is performed autonomously, without human intervention. Thus, subject to local and state regulation, such automated cooking and delivery systems may subject the operator to fewer or less rigorous health inspections than other systems requiring human intervention. For instance, the delivery vehicle may not be required to have all of the same equipment as a standard food preparation area (e.g., adequate hand washing facility). Also for instance, delivery personnel may not be subject to the same regulations as food preparers (e.g., having training, passing testing, possessing a food workers' certificate or card). More beneficially, by cooking and packaging the food items 202 in the delivery vehicle 1072, a higher quality food product may be provided to the consumer.

Each of the cooking units, e.g., ovens 197 (FIG. 2) includes a housing disposed at least partially about an interior cavity formed by one or more surfaces. Food items are cooked under defined cooking conditions within the interior cavity. A hinged or otherwise displaceable door 198 (FIG. 2) is used to isolate the interior cavity from the external environment. In at least some instances, the door 198 may be mechanically or electro-mechanically held closed while the cooking process is underway. The cooking unit can include a heat source or heat element that is used to provide heat to the interior cavity. In addition to the heat source or heating element, additional elements such as convection fan(s), humidifiers, gas burners, or similar (not shown in Figure for clarity) may be installed in place of or along with the heat source or heat element in the cooking unit.

Each cooking unit can include one or more indicators or display panels that provide information about and/or the cook status of the food item in the respective cooking unit. In some instances, a plurality of cooking units can share one or more indicators or display panels that provide information about and/or the cook status of the food item in the respective cooking unit. In some instances the display panel may include a text display that provides information such as the type of food item 202 (FIG. 2) in the cooking unit; consumer name and location information associated with the food item in the cooking unit; the cook status of the food item 202 in the cooking unit (e.g., “DONE,” “COMPLETE,” “2 MIN REMAINING”); or combinations thereof. In other instances, the display panel may include one or more indicators that provide the cook status of the food item 202 in the cooking unit (e.g., GREEN=“DONE;” YELLOW=“<5 MIN REMAINING;” RED=“>5 MIN REMAINING”). The data provided to the display may be provided by an order dispatch and en route cooking control systems 108, routing module 1074, and cooking module 1076, or any combination thereof. In at least some instances, the display can include a controller capable of independently controlling the cooking conditions within its respective cooking unit. In such instances, information indicative of the cooking conditions for the cooking unit may be provided to the display in the form of any number of set points or other similar control parametric data by order dispatch and en route cooking control systems 108, routing module 1074, and cooking module 1076, or any combination thereof.

One or more power interfaces (not shown) may be disposed in, on, or about each of the cooking units. The power interface is used to provide at least a portion of the power to the cooking unit. Such power may be in the form of electrical power generated by the delivery vehicle 1072 (FIG. 10) or by a generator installed on the delivery vehicle 1072. Such power may be in the form of a combustible gas (e.g., hydrogen, propane, compressed natural gas, liquefied natural gas) supplied from a combustible gas reservoir carried by the delivery vehicle. In some instances, two or more power interfaces may be installed, for example one electrical power interface supplying power to the display and a convection fan and one combustible gas power interface supplying energy to the heating element may be included on a single cooking unit.

One or more power distribution devices can be located in each rack 199 (FIG. 2) such that the corresponding cooking unit power interface is physically and/or electrically coupled to the appropriate power distribution device when the cooking unit is placed in the rack. The power distribution devices can include an electrical bus for distributing electrical power to some or all of the cooking units inserted into the rack. The power distribution devices can include a gas distribution header or manifold for distributing a combustible gas to some or all of the cooking units inserted into the rack. In at least some instances, the power distribution devices may include one or more quick connect or similar devices to physically and/or electrically couple the power distribution devices to the appropriate power distribution system (e.g., electrical, combustible gas, or other) onboard the delivery vehicle 1072.

One or more communications interfaces (not shown) may be disposed in, on, or about each of the cooking units. The communications interface is used to bi-directionally communicate at least data indicative of the cooking conditions existent within the respective cooking unit. The communications interface can include a wireless communications interface, a wired communications interface, or any combination thereof. Some or all of the power to operate the communications interface can be provided by the power interface. In at least some instances, the communications interface can provide bidirectional wireless communication with the order dispatch and en route cooking control systems 108. In at least some instances, the communications interface can provide bidirectional wired or wireless communication with a vehicle mounted system such as the routing module 1074 and/or cooking module 1076 (FIG. 10). Instructions including data indicative of the cooking conditions within the cooking unit can be communicated to the display via the communications interfaces. In at least some implementations such instructions may include one or more cooking parameters (e.g., oven temperature=425° F., air flow=HIGH, humidity=65%, pressure=1 ATM) and/or one or more system parameters (e.g., set flame size=LOW) associated with completing or finishing the cooking of the food item in the respective cooking unit based on an estimated time of arrival at the consumer destination location. Such cooking parameters may be determined at least in part by the cooking module 1076 (FIG. 10) based on estimated time of arrival information provided by the routing module 1074 (FIG. 10).

One or more wired or wireless communications buses can be located in each rack 199 (FIG. 2) such that the corresponding cooking unit communications interface is communicably coupled to the communications bus when the cooking unit, e.g., 197 (FIGS. 1 and 2), is placed in the rack 199. In at least some instances, the communications buses may be wiredly or wirelessly communicably coupled to the order dispatch and en route cooking control systems 108, the routing module 1074, the cooking module 1076 (FIG. 10) or any combination thereof.

Each of the racks 199 can accommodate the insertion of any number of cooking units. The cooking conditions within each of the cooking units inserted into a common rack 199 can be individually adjusted to control the completion time of the particular food item within the cooking unit. Although the rack 199 may accommodate the insertion of multiple cooking units, the rack 199 need not be completely filled with cooking units during operation. In at least some implementations, each of the racks 199 may be equipped with any number of moving devices to facilitate the movement of the cooking rack 199. Such moving devices can take any form including rollers, casters, wheels, and the like.

In at least some instances, the routing module 1074 and/or an order dispatch and en route cooking control systems 108 (FIG. 1) can be bi-directionally communicably coupled to a display device 1078a, 1078b (two shown, collectively 1078) located in the delivery vehicle 1072. The display device 1078 can provide the driver of the delivery vehicle 1072 with routing information in the form of text directions, voice instructions, or a map. In addition, the display device 1078 can also provide the driver of the delivery vehicle 1072 with a manifest or delivery itinerary that lists a number of consumer delivery destinations and provides a local estimated time of arrival at each respective consumer delivery destination. The routing information and the manifest or delivery itinerary can be determined in whole or in part by the routing module 1074, the order dispatch and en route cooking control systems 108 (FIG. 1), or any combination thereof.

The order dispatch and en route cooking control systems 108 (FIG. 1) and/or the cooking module 1076 can establish, control, or adjust cooking conditions in each of the cooking units, e.g., ovens 197 (FIGS. 1 and 2), based at least in part on the available cooking time. Such cooking conditions may be determined by the an order dispatch and en route cooking control systems 108, the cooking module 1076, or some combination thereof, such that food items are advantageously delivered to the consumer destination location shortly after cooking has completed. In at least some instances real time updating, for example to reflect traffic conditions between the current location of the delivery vehicle 1072 and the delivery destination may cause the an order dispatch and en route cooking control systems 108 and/or routing module 1074 to autonomously dynamically update the manifest or delivery itinerary. New available cooking times for each delivery destination location can be determined by the an order dispatch and en route cooking control systems 108, routing module 1074, the cooking module 1076, or any combination thereof, based on the updated manifest or delivery itinerary. Cooking conditions in each of the cooking units, e.g., ovens 197, can be adjusted throughout the delivery process to reflect the newly estimated times of arrival using the dynamically updated manifest or delivery itinerary. The routing module 1074 provides the updated manifest or delivery itinerary and the recalculated available cooking times to the cooking module 1076. In at least some instances, data indicative of the location of the delivery vehicle 1072 and the estimated delivery time may be provided to the consumer via electronic mail (i.e., email) or SMS messaging, web portal access, or any other means of communication.

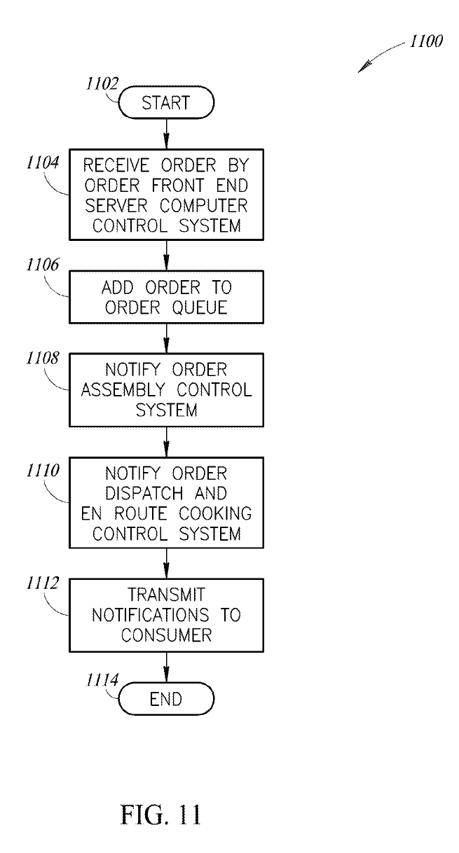

FIG. 11 shows a method 1100 of order processing, according to one illustrated implementation. The order processing method 1100 can, for example, be executed by one or more processor-based devices, for instance an order front end server computer control system 104 (FIG. 1).

The method 1100 starts at 1102, for example on powering up of an order front end server computer control system 104 (FIG. 1), or on invocation by a calling routine.

At 1104, a processor-based device, for example the order front end server computer control system 104, receives an order. The order typically specifies one or more items of food, delivery destination (e.g., address), time of order, optionally a delivery time, and a name associated with the order.

At 1106, the processor-based device, for example the order front end server computer control system 104, adds the order to an order queue, typically assigning each order a unique identifier (e.g., number), which uniquely identifies the order at least over some defined period of time (e.g., 24 hours). The order queue can be a list or queue of orders arranged in sequence according to the time of receipt of the order by the order front end server computer control system 104.

At 1108, the processor-based device, for example the order front end server computer control system 104, notifies the assembly control system 106 of the receipt of the order or the updating of the order queue.

At 1110, the processor-based device, for example the order front end server computer control system 104, notifies the dispatch and/or en route cooking method 1400 of the receipt of the order or the updating of the order queue.

Optionally at 1112, the processor-based device, for example the order front end server computer control system 104, notifies the customer of the pending order and/or timing of delivery and/or status of the order. The order front end server computer control system 104 can send updates to the customer from time-to-time, at least until the order is delivered.

The method 1100 terminates at 1114, for example until invoked again. Alternatively, the method 1100 may repeat continuously or repeatedly, or may execute as multiple instances of a multi-threaded process.

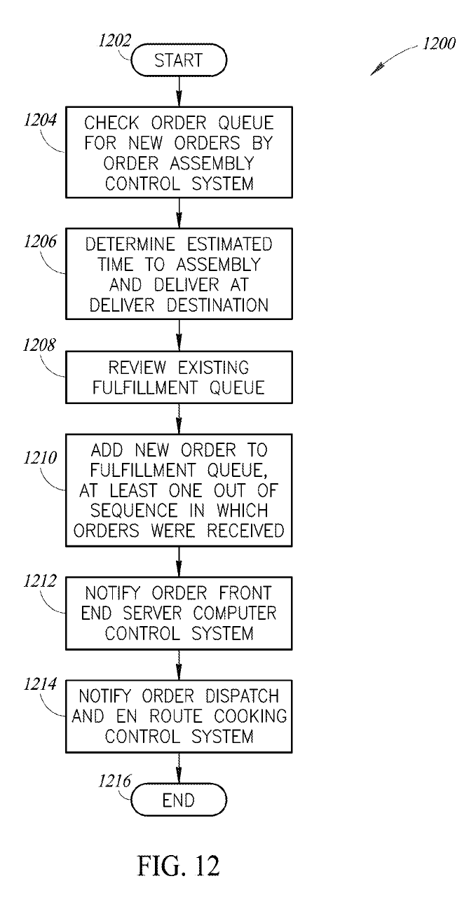

FIG. 12 shows a method 1200 of controlling on-demand robotic food assembly line 102, according to one illustrated implementation. The order processing method 1200 can, for example, be executed by one or more processor-based devices, for instance an order assembly control systems 106 (FIG. 1), or alternatively an order front end server computer control system 104 (FIG. 1).

The order processing method 1300 can, for example, interact with the method 1100 (FIG. 11).

The method 1200 starts at 1202, for example on powering up of an order assembly control systems 106 (FIG. 1), or powering up of an order front end server computer control system 104 (FIG. 1), or on invocation by a calling routine.

At 1204, a processor-based device, for example an order assembly control systems 106 (FIG. 1), or alternatively an order front end server computer control system 104 (FIG. 1), checks the order queue for new orders. Such can be performed periodically or in response to receipt of a notification of a new order or notification of an update to the order queue.

At 1206, a processor-based device, for example an order assembly control systems 106 (FIG. 1), or alternatively an order front end server computer control system 104 (FIG. 1), determines an estimated time to assemble and estimated time to deliver at delivery destination. The estimated time to assemble may be a fixed time, or may account for a current or anticipated level of demand for production. The estimated time to deliver at delivery destination can take into account an estimated or expected time to transport the order from a production facility to the delivery destination. Such can take into account anticipated or even real-time traffic information, including slowdowns, accidents and/or detours. Such can also take into account a manifest or itinerary associated with a delivery vehicle. For instance, if the delivery vehicle will need to make four deliveries before delivering the subject order, the transit and drop off time associated with those preceding four deliveries is taken into account.

Additionally or alternatively, a processor-based device, for example an order assembly control systems 106 (FIG. 1), or alternatively an order front end server computer control system 104 (FIG. 1), determines or evaluates one or more other conditions for placing a food item order in the fulfillment queue in a different order than received (i.e., order queue). For example, the processor-based device may expedite certain orders, for instance orders based on delivery locations which are geographically proximate delivery locations for other food item orders. Thus, the processor-based device may expedite certain food orders to group based on efficiency of delivery. In executing such, the processor-based device may take into account an ability to timely delivery all grouped or bundled orders. For example, if there is a commitment to deliver a first order within a first total time (i.e., delivery time guarantee) from order receipt, the processor-based device may determine whether a second order with delivery location that is geographically proximate a delivery locations of the first order will interfere with meeting the delivery time guarantee for the first order and while also meeting the delivery time guarantee for the second order. For instance, the second order might delay the departure of the delivery vehicle by a first estimated amount of time (i.e., first time delay). For instance, the second order might increase the transit time of the delivery vehicle by an estimated amount of time (i.e., second time delay). Such increase transit time can be the result of varying a route or manifest of the delivery vehicle and/or based on an increase in traffic due to the delay in departure and/or change in route or manifest. The processor-based device determines whether the delays (e.g., first and second time delays) would prevent or likely prevent the first order from being delivered within the delivery time guarantee and/or prevent or likely prevent the second order from being delivered within the delivery time guarantee. The processor-based device can perform a similar comparison for all orders to be delivered by a given delivery vehicle in a given sorte. Also for example, the processor-based device may, for instance expedite orders from highly valued customers, loyalty club members, replacement orders where there was a mis-delivery or mistake in an order, orders from customers willing to pay an expedited handling fee, or orders from celebrity customers or influential customers.

At 1208, a processor-based device, for example an order assembly control systems 106 (FIG. 1), or alternatively an order front end server computer control system 104 (FIG. 1), reviews an existing fulfillment queue. The fulfillment queue is a list or queue of food orders in a sequence in which the food orders will be assembled. The fulfillment queue will typically include various food orders in a sequence or order that is different from the sequence or order in which the food orders were received. The processor-based device dynamically updates the fulfillment queue to queue new orders, and to remove completed or fulfilled orders (e.g., assembled and placed in ovens, and/or dispatched). Consequently, at any given time the sequence or order of the fulfillment queue is likely different from the sequence or order of the order queue. In particular, the order assembly control systems 106 (FIG. 1) finds a location in the fulfillment queue to add a new order while maintaining a respective estimated delivery time of each order in the fulfillment queue within some acceptable bounds (e.g., 20 minutes).

At 1210, a processor-based device, for example an order assembly control systems 106 (FIG. 1), or alternatively an order front end server computer control system 104 (FIG. 1), adds the new order to the fulfillment queue, while maintaining a respective estimated delivery time of each order in the fulfillment queue within some acceptable bounds (e.g., 20 minutes).

At 1212, a processor-based device, for example an order assembly control systems 106 (FIG. 1), or alternatively an order front end server computer control system 104 (FIG. 1), notifies the order front end server computer control system(s) 104 of the update to the fulfillment queue.

At 1214, a processor-based device, for example an order assembly control systems 106 (FIG. 1), or alternatively an order front end server computer control system 104 (FIG. 1), notifies the order dispatch and en route cooking control system(s) 108 of the update to the fulfillment queue.

The method 1200 terminates at 1216, for example until invoked again. Alternatively, the method 1200 may repeat continuously or repeatedly, or may execute as multiple instances of a multi-threaded process.

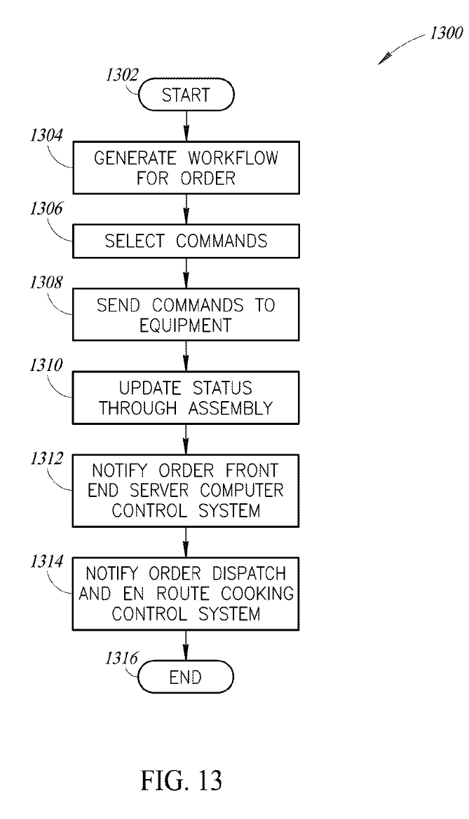

FIG. 13 shows a method 1300 of controlling on-demand robotic food assembly line 102, according to one illustrated implementation. The on-demand robotic food assembly line controlling method 1300 can, for example, be executed by one or more processor-based devices, for instance an order assembly control systems 106 (FIG. 1). The order processing method 1300 can, for example, be employed with the method 1200 (FIG. 12). The order processing method 1300 can, for example, interact with the method 1100 (FIG. 11).

The method 1300 starts at 1302, for example on powering up of an order assembly control systems 106 (FIG. 1), or powering up of an order front end server computer control system 104 (FIG. 1), or on invocation by a calling routine.

At 1304, a processor-based device, for example an order assembly control systems 106 (FIG. 1), generates a workflow for each order in the fulfillment queue. The order assembly control systems 106 (FIG. 1) can take the highest ranked order in the fulfillment queue, one food order at a time.

Alternatively, order assembly control systems 106 (FIG. 1) can processor multiple orders in parallel, particularly where there is more than one on-demand robotic food assembly lines 102 (FIG. 1). The workflow specifies a series of operations or acts required to produce the desired or ordered food item. For example, a workflow may specify, in sequence: application of a particular sauce and/or volume of sauce, application of a particular cheese or cheeses and/or volume of cheese (e.g., double cheese), application of none, one or more toppings and/or volume of toppings (e.g., double sausage), an amount of cook time (e.g., par-bake) or speed through an oven, an amount of charring, application of fresh toppings, number of slices, etc.

At 1306, a processor-based device, for example an order assembly control systems 106 (FIG. 1), generates or selects commands based on the workflow. Typically, all or most operations or acts will be repetitive, hence defined sets of commands corresponding to respective ones of the operations or acts will be stored in non-transitory storage media, for example in a library of commands. The order assembly control systems 106 (FIG. 1) selects the appropriate commands from the library, or if necessary generates commands for operations or acts for which the commands do not yet exist. The commands may be machine-executable commands, executable by the various pieces of equipment (e.g., sauce dispensers, robots, ovens, conveyors) of the one on-demand robotic food assembly lines 102 (FIG. 1).

At 1308, a processor-based device, for example an order assembly control systems 106 (FIG. 1) sends the commands to the pieces of equipment of the one on-demand robotic food assembly lines 102 (FIG. 1). The commands can be sent either directly to the pieces of equipment by order assembly control systems 106 (FIG. 1), or indirectly. Commands may, for example, be stored in registers of one or more PLCs, processors, or other logic circuitry and are executable by one or more PLCs, processors, or other logic circuitry. The commands specify the movement and timing of various actions, e.g., dispensing sauce, retrieving and dispensing cheeses, retrieving and dispensing toppings, transferring between conveyors, retrieving and placing packaging, retrieving loaded packing and loading into ovens, etc. Commands can include a command to take an action, a command that specifies the action to be taken (e.g., drive signal to various motors, solenoids or other actuators), and/or in some instance a command that specifies that no action is to be taken. In some instances, there may be one or more motor controllers intermediate the PLCs and the electric motors, solenoids or other actuators. Commands can, for example, include commands to load a pizza from a primary assembly line to one of two or more cooking conveyors based, for example, on whether one of the cooking conveyors is ready to accept a new item. Commands can, for example, include commands to hold a pizza on a transfer conveyor until a downstream piece of equipment is available for loading.

The commands may, for example, be executed out of the registers in sequence upon detection of a trigger or receipt of a trigger signal. Notably, the food items may be sequenced down an assembly line in a given order, and the commands in the fulfillment queue or registers can be in the same order as the food items. In fact, such may even be inherent for pizzas which may all start with identical rounds of dough and which are only assembled into the desired customized order based on sequential execution of the commands. All or some of the pieces of equipment may be associated with one or more sensors, typically positioned slightly upstream of the respective piece of equipment relative to a direction of movement of the assembly line. The sensors can take a variety of forms, for instance a simple “electric eye” where a light (e.g., infrared) source emits a beam of light across the assembly line and a detector (e.g., photodiode) detects a break in the light as indicating the passage of a food item. The detector generates a triggers signal in response, which is relayed to the associated piece of equipment which, in response, executes the next command in the queue or register. In some instances, more sophisticated sensors can be employed, for instance digital cameras or laser scanners, which cannot only detect a presence or absence of a food item, but can provide information about a shape, consistency, size or other dimensions of a food item. For instance, a digital camera can capture an image of a flatten piece of dough with a deposit of sauce. A processor-based system can employ various machine-vision techniques to characterize the size and shape of the flatten dough and/or to characterize the size and shape of the sauce. As described elsewhere herein, a processor-based device can use such information to determine a pattern or path for guiding a robot or portion thereof to spread the sauce as desired across the flatten dough. Similar techniques can be used to image and spread cheese and/or other toppings.

At 1310, a processor-based device, for example an order assembly control systems 106 (FIG. 1) updates a status of the food order as the food order is assembled. This can occur, for example, as the food order passes each workstation of the one on-demand robotic food assembly lines 102 (FIG. 1).

At 1312, a processor-based device, for example an order assembly control systems 106 (FIG. 1) provides notification of the updated status of the food order to the order front end server computer control system(s) 104. Such can, for example, occur periodically or from time-to-time as the food order is assembled. This can occur, for example, as the food order passes each workstation of the one on-demand robotic food assembly lines 102 (FIG. 1).

At 1314, a processor-based device, for example an order assembly control systems 106 (FIG. 1) provides notification of the updated status of the food order to the order dispatch and en route cooking control system(s) 108. Such can, for example, occur periodically or from time-to-time as the food order is assembled. This can occur, for example, as the food order passes each workstation of the one on-demand robotic food assembly lines 102 (FIG. 1).

The method 1300 terminates at 1316, for example until invoked again. Alternatively, the method 1300 may repeat continuously or repeatedly, or may execute as multiple instances of a multi-threaded process.

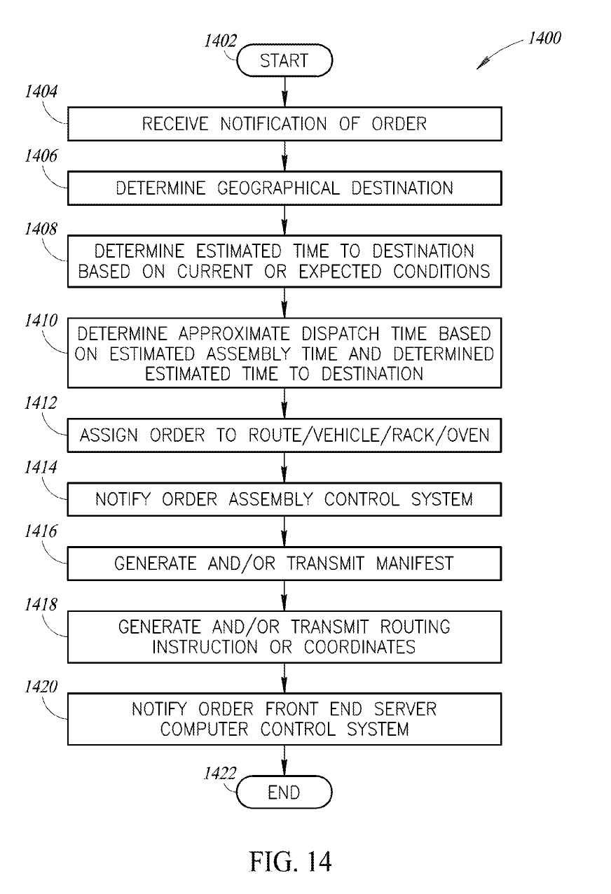

FIG. 14 shows a method 1400 of controlling dispatch and/or en route cooking of ordered food items, according to one illustrated implementation. The dispatch and/or en route cooking method 1400 can, for example, be executed by one or more processor-based devices, for instance an order dispatch and en route cooking control systems 108 (FIG. 1) and/or on-board processor-based routing module 1074 (FIG. 10), and the on-board processor-based cooking module 1076 (FIG. 10). The dispatch and/or en route cooking method 1400 can, for example, interact with the method 1100 (FIG. 11). The dispatch and/or en route cooking method 1400 can, for example, be employed with the method 1200 (FIG. 12) and/or the method 1300 (FIG. 13).

The method 1400 starts at 1402, for example on powering up of order dispatch and en route cooking control systems 108 (FIG. 1), or on invocation by a calling routine.

At 1404, a processor-based device, for example an order dispatch and en route cooking control systems 108 (FIG. 1), receives notification of a new order or an update to the order queue.

At 1406, a processor-based device, for example an order dispatch and en route cooking control systems 108 (FIG. 1), determines a geographical destination to which the new order will be delivered. The order dispatch and en route cooking control systems 108 (FIG. 1) may, for example, determine a longitude and latitude of the delivery destination or some other coordinates, for instance based on street address.

At 1408, a processor-based device, for example an order dispatch and en route cooking control systems 108 (FIG. 1), determines an estimated transit time to the determined delivery destination. The order dispatch and en route cooking control systems 108 may, for example, determine the estimated transit time based on current or expected conditions, for instance real-time traffic conditions.

At 1410, a processor-based device, for example an order dispatch and en route cooking control systems 108 (FIG. 1), determines an approximate dispatch time for the order. The order dispatch and en route cooking control systems 108 (FIG. 1) may, for example, determine the approximate dispatch time based on the estimated assembly time and the determined estimated transit time to the delivery destination. Such may, for example, account for a manifest or itinerary of a delivery vehicle that will deliver the particular order.

At 1412, a processor-based device, for example an order dispatch and en route cooking control systems 108 (FIG. 1), assigns the order to one or more of: a route, a delivery vehicle, a rack, and/or an oven. Various routes may be defined, and reflected in a manifest or itinerary. A delivery vehicle may be assigned to a route or a manifest or itinerary may be assigned to a delivery vehicle. The manifest or itinerary can specify a sequence of delivery destinations and the food items or orders to be delivered at each delivery destination. The manifest or itinerary can specify a route to be followed in completing the sequence of delivery destinations. Various food items or orders can be assigned to respective cooking units, e.g., ovens 197, and/or assigned to a rack 199, which is in turn assigned to a delivery vehicle.

At 1414, a processor-based device, for example an order dispatch and en route cooking control systems 108 (FIG. 1), provides a notification of the assignment to the order assembly control system 106. This allows the order assembly control system 106 to provide instructions or commands to correctly load the food item into the correct cooking unit, rack and/or delivery vehicle. Alternatively, the order dispatch and en route cooking control systems 108 can provide loading instructions or commands directly, for example providing commands to one or more loading robot(s). Again, instructions can be selected from a library of instructions, of generated if needed.

At 1416, a processor-based device, for example an order dispatch and en route cooking control system(s) 108 (FIG. 1), generates and/or transmits a manifest. For example, the order dispatch and en route cooking control system 108 may generate a manifest for a set of food items or orders. The order dispatch and en route cooking control system 108 may transmit the manifest to a delivery vehicle or to a processor-based device (e.g., smartphone, tablet, navigation system, head unit, laptop or netbook computer) operated by a delivery driver assigned to the delivery vehicle. The manifest specifies a sequence or order of delivery destinations for the food items or food orders on the manifest, as well as specifying which food items or food orders are to be delivered at which of the delivery destinations. The manifest may, optionally, include a specification of a route to travel in transiting the various delivery destinations. The manifest may, optionally, include an indication of transit travel times and or delivery times for each of segment or leg of the route. The manifest may, optionally, include identifying information, for example identifying the consumer or customer, the street address, telephone number, geographical coordinates, and/or notes or remarks regarding the delivery destination (e.g., behind main residence, upstairs) and/or customer.

At 1418, a processor-based device, for example an order dispatch and en route cooking control systems 108 (FIG. 1), generates and/or transmits routing instructions or coordinates. The routing instructions can include textual, numerical and/or graphical descriptions of the route or routes to and between delivery destinations. The geographical coordinates may be useable to find routing instructions via a routing application run on a smartphone or tablet computer. Alternatively, the geographical coordinates may be used directly by an autonomous vehicle.

At 1420, a processor-based device, for example an order dispatch and en route cooking control systems 108 (FIG. 1), provides notification to an order front end server computer control system 104 (FIG. 1). Such allows the order front end server computer control system 104 to provide accurate up-to-date information about each order. The updated information may be available for access by a consumer or customer, for instance via a Web browser. Additionally or alternatively, updated information may be pushed to the consumer or customer via electronic notification (e.g., electronic mail messages, text or SMS messages).

The method 1400 terminates at 1422, for example until invoked again. Alternatively, the method 1400 may repeat continuously or repeatedly, or may execute as multiple instances of a multi-threaded process.

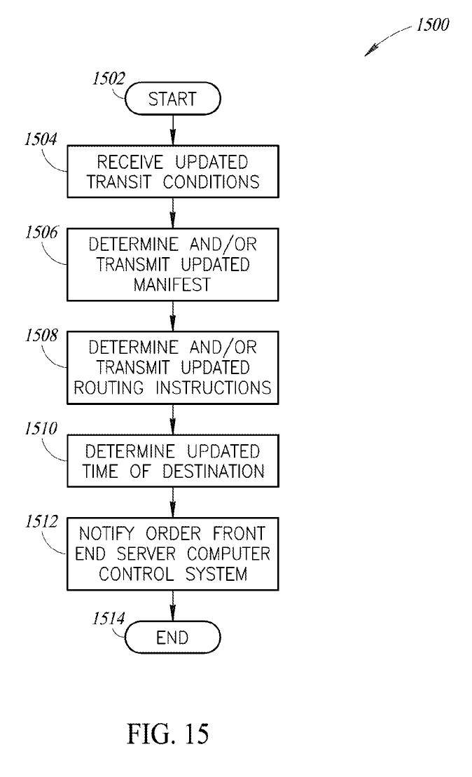

FIG. 15 shows a method 1500 of controlling dispatch and/or en route cooking of ordered food items, according to one illustrated implementation. The dispatch and/or en route cooking method 1500 can, for example, be executed by one or more processor-based devices, for instance an order dispatch and en route cooking control systems 108 (FIG. 1) and/or on-board processor-based routing module 1074 (FIG. 10), and the on-board processor-based cooking module 1076 (FIG. 10). The dispatch and/or en route cooking method 1500 can, for example, be executed as part of execution of the method 1400 (FIG. 15). The dispatch and/or en route cooking method 1500 can, for example, interact with the method 1100 (FIG. 11). The dispatch and/or en route cooking method 1500 can, for example, be employed with the method 1200 (FIG. 12) and/or the method 1300 (FIG. 13).

The method 1500 starts at 1502, for example on powering up of order dispatch and en route cooking control systems 108 (FIG. 1), or on invocation by a calling routine.

At 1504, a processor-based device, for example an order dispatch and en route cooking control systems 108 (FIG. 1), retrieves and/or receives updated transit or traffic conditions. Updated transit or traffic conditions can be received from one or more of various commercially available sources, for instance via electronic inquiries. Updated transit or traffic conditions can be received in real-time or almost real-time.

At 1506, a processor-based device, for example an order dispatch and en route cooking control systems 108 (FIG. 1), determines and/or transmits updated manifest.

At 1508, a processor-based device, for example an order dispatch and en route cooking control systems 108 (FIG. 1), determines and/or transmits updated routing instructions. In at least some instances, the routing instructions and manifest or delivery itinerary may be dynamically updated or adjusted during the delivery process to reflect the latest traffic, road conditions, road closures, etc. Such traffic, road condition, and road closure information may be obtained via one or more of: a commercial source of traffic information, crowd-sourced traffic information, or some combination thereof. By dynamically updating traffic information, the order dispatch and en route cooking control systems 108 and/or routing modules 1074 in each of the delivery vehicles 1072 can provide up-to-the-minute routing instructions and delivery itineraries. By dynamically updating traffic information, the order dispatch and en route cooking control systems 108 and/or cooking modules 1076 in each of the delivery vehicles 1072 can dynamically adjust the cooking conditions within each of the cooking units carried by each delivery vehicle 1072 to reflect the available cooking time for each of the respective cooking units.

At 1510, a processor-based device, for example an order dispatch and en route cooking control systems 108 (FIG. 1), determines updated time to destination. For example, the order dispatch and en route cooking control system 108 may generate an updated manifest for a set of food items or orders. The order dispatch and en route cooking control system 108 may transmit the updated manifest to a delivery vehicle or to a processor-based device (e.g., smartphone, tablet, navigation system, head unit, laptop or netbook computer) operated by a delivery driver assigned to the delivery vehicle. The updated manifest specifies an updated sequence or order of delivery destinations for the food items or food orders on the updated manifest, as compared to a previous version or instance of the manifest, as well as specifying which food items or food orders are to be delivered at which of the delivery destinations. The updated manifest may, optionally, include a specification of a route to travel in transiting the various delivery destinations. The updated manifest may, optionally, include an indication of transit travel times and or delivery times for each of segment or leg of the route. The updated manifest may, optionally, include identifying information, for example identifying the consumer or customer, the street address, telephone number, geographical coordinates, and/or notes or remarks regarding the delivery destination (e.g., behind main residence, upstairs) and/or customer.

At 1512, a processor-based device, for example an order dispatch and en route cooking control systems 108 (FIG. 1), provides notification of the updated manifest to the order front end server computer control system. Such allows the order front end server computer control system 104 to provide accurate up-to-date information about each order. The updated information may be available for access by a consumer or customer, for instance via a Web browser. Additionally or alternatively, updated information may be pushed to the consumer or customer via electronic notification (e.g., electronic mail messages, text or SMS messages).

The method 1500 terminates at 1514, for example until invoked again. Alternatively, the method 1500 may repeat continuously or repeatedly, or may execute as multiple instances of a multi-threaded process.

Various embodiments of the devices and/or processes via the use of block diagrams, schematics, and examples have been set forth herein. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information, can be stored on any computer readable medium for use by or in connection with any computer and/or processor related system or method. In the context of this document, a memory is a computer readable medium that is an electronic, magnetic, optical, or other another physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information. In the context of this specification, a “computer readable medium” can be any means that can store, communicate, propagate, or transport the program associated with logic and/or information for use by or in connection with the instruction execution system, apparatus, and/or device. The computer readable medium can be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium, could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

In addition, those skilled in the art will appreciate that certain mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. U.S. Pat. No. 9,292,889; U.S. patent application Ser. No. 62/311,787; U.S. patent application Ser. No. 29/558,872; U.S. patent application Ser. No. 29/558,873; U.S. patent application Ser. No. 29/558,874; U.S. patent application Ser. No. 15/465,228, filed on Mar. 17, 2017, U.S. provisional patent application Ser. No. 62/311,787, filed on Mar. 22, 2106; and U.S. provisional patent application No. 62/394,063, titled “CUTTER WITH RADIALLY DISPOSED BLADES,” filed on Sep. 13, 2016, and U.S. provisional patent application No. 62/320,282, filed on Apr. 8, 2016, are each incorporated herein by reference, in their entirety.

From the foregoing it will be appreciated that, although specific embodiments have been described herein for purposes of illustration, various modifications may be made without deviating from the spirit and scope of the teachings. Accordingly, the claims are not limited by the disclosed embodiments.

1. An on-demand robotic food preparation assembly line, comprising:
a first plurality of robots, each of the robots of the first plurality of robots having at least one respective appendage that is selectively moveable and a tool physically coupled to the respective appendage;
at least a first conveyor that extends past the robots of the first plurality of robots, and which is operable to convey a plurality of food items being assembled past the robots; and
a control system that receives a plurality of individual orders for food items, generates control signals based on the respective orders for food items, and causes the tools of the respective appendages of the robots to assemble the respective food item as the conveyor conveys the respective food item along at least a portion of the robotic food preparation assembly line, wherein at least a first one of the food items includes a first set of ingredients and a second one of the food items, immediately successively following the first one of the food items along the conveyor, includes a second set of ingredients, the second set of ingredients different from the first set of ingredients.

2. The on-demand robotic food preparation assembly line of claim 1 wherein at least a third one of the food items, immediately successively following the second one of the food items along the conveyor, includes a third set of ingredients, the third set of ingredients different from the first set of ingredients and different from the second set of ingredients.

3. The on-demand robotic food preparation assembly line of claim 1, further comprising:
at least a first sauce dispenser including a first reservoir to hold a first sauce and operable to dispense a first quantity of the first sauce on ones of flat pieces of dough on the conveyor, and wherein the respective tool of the first one of the first plurality of robots has a rounded portion and is operable to spread the first quantity of sauce on the ones of the flat pieces of dough.

4. The on-demand robotic food preparation assembly line of claim 3, further comprising:
at least a second sauce dispenser including a second reservoir to hold a second sauce and operable to dispense a first quantity of the second sauce on selected ones of flat pieces of dough on the conveyor, and wherein the respective tool of the first one of the first plurality of robots is operable to spread the second quantity of sauce on the selected ones of the flat pieces of dough.

5. The on-demand robotic food preparation assembly line of claim 3 wherein the appendage of the first one of the first plurality of robots is operable to move in a spiral while the respective tool of the first one of the first plurality of robots is operable to rotate to spread the first quantity of sauce on the ones of the flat pieces of dough.

6. The on-demand robotic food preparation assembly line of claim 3 wherein a second one of the plurality of robots includes a dispensing container, the dispensing container having a bottom face, the dispensing container coupled to the one respective appendage, and wherein the tool is physically coupled to the bottom face.

7. The on-demand robotic food preparation assembly line of claim 6, wherein the tool includes at least one of the following: a grater, a nozzle, a rotating blade, and a linear slicer.

8. The on-demand robotic food preparation assembly line of claim 6 wherein the dispensing container further includes a plunger, the plunger having a face that is parallel to the bottom face of the dispensing container, the plunger movable in a direction towards the bottom face.

9. The on-demand robotic food preparation assembly line of claim 1, further comprising:
a dispenser carousel that contains multiple dispensing containers, the dispenser carousel located above the at least one conveyor so that at least one of the multiple dispensing containers is centered above the at least one conveyer, wherein the dispenser carousel is rotatable around an axis of rotation such that a first one of the multiple dispensing containers is centered above the at least one conveyer at a first time and a second one of the multiple dispensing containers is centered above the at least one conveyer at a second time.

10. The on-demand robotic food preparation assembly line of claim 3 wherein a second one of the first plurality of robots is operable to retrieve a quantity of cheese from a first receptacle and deposit the quantity of cheese on the ones of the flat pieces of dough on the conveyor.

11. The on-demand robotic food preparation assembly line of claim 10 wherein a third one of the first plurality of robots is operable to retrieve a quantity of a first topping from a second receptacle and deposit the quantity of the first topping on selected ones of the flat pieces of dough on the conveyor.

12. The on-demand robotic food preparation assembly line of claim 11 wherein a fourth one of the first plurality of robots is operable to retrieve a quantity of a second topping from a third receptacle and deposit the quantity of the second topping on selected ones of the flat pieces of dough on the conveyor.

13. The on-demand robotic food preparation assembly line of claim 10 wherein a third one of the first plurality of robots is operable to retrieve a quantity of a first topping from a second receptacle and deposit the quantity of the first topping on selected ones of the flat pieces of dough on the conveyor and is further operable to retrieve a quantity of a second topping from a third receptacle and deposit the quantity of the second topping on selected ones of the flat pieces of dough on the conveyor.

14. The on-demand robotic food preparation assembly line of claim 1, further comprising:
an oven downstream of the first plurality of robots, the oven operable to at least partially cook the food items.

15. The on-demand robotic food preparation assembly line of claim 14, further comprising:
at least one robot positioned downstream of the oven, and operable to retrieve a fresh topping from a fresh topping receptacle and dispense the fresh topping on selected ones of the at least partially cooked food items.

16. The on-demand robotic food preparation assembly line of claim 1 wherein the at least one conveyor includes:
a food grade conveyor belt that operates at a first speed;
at least one oven conveyor rack that transits the food items through the oven at a second speed, the second speed slower than the first speed; and
a first transfer conveyor that transfers food items from the food grade conveyor belt that moves at the first speed to the at least one oven conveyor rack that moves at the second speed.

17. The on-demand robotic food preparation assembly line of claim 16 wherein the at least one conveyor includes:
a second transfer conveyor that transfers at least partially cooked food items to respective ones of a plurality of bottom portions of packaging.

18. (canceled)

19. The on-demand robotic food preparation assembly line of claim 1 wherein the control system receives orders for food items electronically generated directly by customers.

20. The on-demand robotic food preparation assembly line of claim 1 wherein the control system includes a server computer front end to communicatively coupled to receive orders for food items electronically generated directly by customers, and a back end computer that assembles the received orders for food items in an order fulfillment queue, where at least some of the received orders for food items are arranged in the order fulfillment queue out of sequence with respect to an order in which the orders for food items were received.

21. The on-demand robotic food preparation assembly line of claim 20 wherein the back end computer assembles the received orders for food items in the order fulfillment queue based at least in part on an estimated time to a respective delivery destination for each of the received orders for food items.

22. A method of operation of an on-demand robotic food preparation assembly line, the method comprising:
receiving, by a control system, a plurality of individual orders for food items;
generating, by the control system, control signals based on the respective orders for food items, and
conveying, by a conveyor, a plurality of instances of the food items along at least a portion of the robotic food preparation assembly line; and
causing, by the control system, a respective tool of a respective appendage of each of a plurality of robots to assemble the instances of the food items based at least in part on the control signals, where at least a first instance the food items includes a first set of ingredients and a second instance of the food items, immediately successively following the first instance of the food items along the conveyor, includes a second set of ingredients, the second set of ingredients different from the first set of ingredients.

23. The method of operation of an on-demand robotic food preparation assembly line of claim 22 where at least a third instance of the food items, immediately successively following the second instance of the food items along the conveyor, includes a third set of ingredients, the third set of ingredients different from the first set of ingredients and different from the second set of ingredients.

24.-33. (canceled)

34. An on-demand food preparation assembly line, comprising:
a first set of assembly stations, each station at which a portion of a food item is assembled;
at least one food grade conveyor belt that transits past the assembly stations of the first plurality of assembly stations at a first speed;
at least one oven;
at least one oven conveyor rack that conveys food items through the at least one oven at a second speed, the second speed slower than the first speed;
a first transfer conveyor that transfers food items from the food grade conveyor belt that moves at the first speed to the at least one oven conveyor rack that moves at the second speed.

35.-43. (canceled)

44. A method of operation of an on-demand robotic food preparation assembly line, comprising:
transiting at least one food grade conveyor belt past a first set of assembly stations at a first speed, each assembly station at which a portion of a customized food item is assembled;
conveying, via at least one oven conveyor rack, at least partially assembled customized food items through at least one oven at a second speed, the second speed slower than the first speed;
transferring, by a first robotic transfer conveyor, the at least partially assembled customized food items from the food grade conveyor belt that moves at the first speed to the at least one oven conveyor rack that moves at the second speed, without changing the first or the second speeds.

45. The method of operation of an on-demand robotic food preparation assembly line of claim 44 wherein transferring the at least partially assembled customized food items from the food grade conveyor belt to the at least one oven conveyor rack includes transferring one instance of the at least partially assembled customized food items to a first oven conveyor rack that transits a first oven and transferring another instance of the at least partially assembled customized food items to a second oven conveyor rack that transits a second oven, the second oven in parallel with the first oven along the on-demand robotic food preparation assembly line.

46.-50. (canceled)

51. A piece of equipment for use in an on-demand food preparation assembly line, the on-demand food preparation assembly line including at least one food grade conveyor belt that transits at a first speed, a number of ovens, and at number of oven conveyor racks that conveys food items through the ovens at a second speed, the second speed slower than the first speed, the piece of equipment comprising:
a robot, the robot having at least one appendage that is selectively moveable with respect to an end of the food grade conveyor belt and a respective end of each of the oven conveyor racks; and
a transfer conveyor rack positioned at least proximate an end of the appendage of the robot for movement therewith; and
at least one motor drivingly coupled to the transfer conveyor rack and selectively operable to move the transfer conveyor rack in at least a first direction with respect to the end of the appendage.

52.-56. (canceled)

57. A method of operating a piece of equipment for use in an on-demand food preparation assembly line, the on-demand food preparation assembly line including at least one food grade conveyor belt that transits at a first speed, a number of ovens, and at number of oven conveyor racks that conveys food items through the ovens at a second speed, the second speed slower than the first speed, the method comprising:
selectively moving at least one appendage of a robot to position a transfer conveyor rack carried by the appendage of the robot proximate an end of the food grade conveyor belt and a respective end of a first one of the oven conveyor racks;
driving the transfer conveyor rack to transfer a first instance of a food item to the first one of the oven conveyor racks;
selectively moving the at least one appendage of the robot to position the transfer conveyor rack carried by the appendage of the robot proximate the end of the food grade conveyor belt and a respective end of a second one of the oven conveyor racks; and
driving the transfer conveyor rack to transfer a second instance of a food item to the second one of the oven conveyor racks.

58. (canceled)

59. (canceled)

60. A food preparation robotic system, comprising:
a number of arms;
an end of arm tool having a contact portion with a round shape that performs redistribution of a component on a portion of a food item without cutting the food item and without adding any material to the food item;
at least one motor drivingly coupled to selectively move the end of arm tool in an at least two-dimensional pattern;
at least one sensor that senses a position of the at least one component of the food item; and
at least one controller, the at least one controller communicatively coupled to receive information from the at least one sensor, the at least one controller which determines a pattern of movement based at least on part on the received information, the at least one controller communicatively coupled to supply control signals to drive the end of arm tool in the determined pattern of movement.

61. (canceled)

62. (canceled)

63. The food preparation robotic system of claim 60 wherein the at least one controller determines a spiral pattern of movement based at least on part on the received information.

64.-70. (canceled)

71. The food preparation robotic system of claim 60 wherein at least one sensor senses at least one of a position, a shape or an orientation of at least a deposit of a sauce on a flat piece of dough, at least one of a position a flat piece of dough on a food grade conveyor belt, a shape of the piece of flat dough or an orientation of the piece of flat dough, and the at least one controller determines a pattern of movement based at least on part on at least one of the position, the shape or the orientation of at least a deposit of a sauce on a flat piece of dough and based at least in part on at least one of the position a flat piece of dough on a food grade conveyor belt, the shape or the orientation of the piece of flat dough.

72. (canceled)

73. A method of operation of a food preparation robotic system,
the method comprising:
sensing, by at least one sensor, at least one of a position, a shape or an orientation of at least one component of a food item; and
receiving information, by a controller, from the at least one sensor;
determining, by the controller, a pattern of movement of an end of arm tool based at least on part on the received information;
supplying, via the controller, control signals to drive the end of arm tool in the determined pattern of movement, where the end of arm tool has a contact portion with a round shape that performs redistribution of a component on a portion of a food item without cutting the food item and without adding any material to the food item.

74.-82. (canceled)

83. An end of arm tool for use with a food preparation robotic system having a number of arms, the end of arm tool comprising:
a body having a contact portion with a round shape that performs redistribution of a viscous liquid component on a portion of a food item without cutting the food item and without adding any material to the food item, at least the contact portion of the end of arm tool is one of a food grade polymer or a stainless steel, and at least one fastener that selectively detachably couples the end of arm tool to the number of arms of the food preparation robotic system.

84.-90. (canceled)
